(19) United States
(12) Patent Application Publication
(10) Pub. No.: US 2014/0168100 A1
(43) Pub. Date: Jun. 19, 2014

(54) VIDEO-GAME CONTROLLER ASSEMBLIES DESIGNED FOR PROGRESSIVE CONTROL OF ACTIONABLE-OBJECTS DISPLAYED ON TOUCHSCREENS: EXPANDING THE METHOD AND BREADTH OF TOUCH-INPUT DELIVERY

(71) Applicant: Chris Argiro, Toronto (CA)

(72) Inventor: Chris Argiro, Toronto (CA)

(21) Appl. No.: 13/720,855

(22) Filed: Dec. 19, 2012

(51) Int. Cl. G06F 3/041

(52) U.S. Cl. CPC G06F 3/0416
USPC 345/173

(57) ABSTRACT

An innovative collection of both wired (e.g. a wired attachment interface for physical mapping) and wireless (e.g. a system of attachmentless actuation ushered by virtual or software-based mapping) specialty-input controllers for touchscreen devices are introduced by the inventor in emphasizing a continued theme of touchscreen controller innovation under common ownership. Remote-controller assemblies for touchscreens provide for the capture, translation and/or transmission (both directly, in a conductive channel, and indirectly) of the control input of a user—user motions, thematically—for correlative virtual actuation and/or capacitive-based discharge actuation at a coordinate touchscreen soft input for purposes of manipulating an actionable agent.

This application is a continuation-in-part of U.S. Ser. No. 13/249,194, filed Sep. 29, 2011, which claims the benefit of U.S. Provisional application No. 61/499,172—filed on Jun. 20, 2011—which are incorporated by reference herein, in their entirety, for all purposes. Furthermore, this application is a natural extension to the inventor's prior, kindred submissions and claims full benefits of provisional applications 61/282,692, 61/344,158 and 61/702,721, filed Sep. 18, 2012 with The USPTO; patent Ser. No. 13/005,315 with The USPTO and International applications PCT/IB2011/051049 and WO/2011/114276 with The WIPO; all applications are to be incorporated by reference herein, in their entirety, for all purposes.

### BACKGROUND

The present invention is in the technical field of touchscreen electronics. More particularly, the present invention targets the video-game industry with progressive video-game controllers; with an emphasis on touchscreen-based electronics. Since video-game consoles and their more immersive, comprehensive and sophisticated footprint traditionally provide users with the best overall gaming experience when compared to other gaming platforms, such as pocket-gaming on mobile devices, a need exists for improved technology that serves to narrow the “gaming-experience gap.” An integral focus of this application is a broad attempt at narrowing this touchscreen-induced gap: a gap borne by the traditionally inherent divergence between such gaming platforms. The present invention seeks to engage and empower the user. To heighten the gaming experience borne on touchscreen devices and to make control of a touchscreen interface more intuitive, natural and compelling.

### SUMMARY

Embodiments herein are directed to systems, devices and methods for improving the control functionality of soft buttons displayed on congruous touchscreens; when used in both stationary and portable devices. In addition, embodiments herein are, amongst other directives, directed to systems, devices and methods for expanding the method and breadth of touch-input delivery through assistive-controller technologies for touchscreens. Touch-input delivery systems, seeking engagement beyond the control input of a finger, as a case in point, are described. Motion-activated controllers, some engaged by the innate capacitance of a user as they are concurrently clutched and gestured and others by an associated mapping system affording a tethered modal input of virtual actuation, are additionally demonstrated. Motion-activated controllers, relying on technologies detecting and relaying a motion input, are described with and without collaboration of an intermediary-transceiver device, according to embodiments.

The present invention in spirit and scope, as demonstrated by an articulation of embodiments, further serves to embolden the user experience by, amongst other means, demanding a greater degree of physical activity and participatory involvement from touchscreen users during the course of game play. This approach stands in marked contrast to the traditional “sofa-spud” approach or “stationary” (not itinerant) game play that is typically associated with touchscreen gaming. Specialty controller inputs that are traditionally associated with stand-alone, video-game consoles—such as a dance mat, guitar, musical keyboard and drum hardware, driving or racing wheels, hockey sticks, golf clubs, baseball bats, bowling balls and DJ turntables and mix stations (representing a mere sampling in the spirit and scope of this discourse; such listing disclosure is not suggestive of controller and/or interface limitation) are purposefully transitioned to the touchscreen environment by the inventor and discoursed in the embodying matter herein.

In embodying matter herein, a touchscreen device may “act” as a “video-game console” of sorts, in the sense that controllers are interfaced with the touchscreen device for remote operating scenarios and that the touchscreen device may broadcast a game's audio and visual output to a TV set through use of specially designed Component AV Cables and the like; this combinatorial “linkage” totality contributing to this “acting” parallel.

In the description that follows, the term “portable device” encompasses portable media players, personal digital assistants, laptop computers, tablets, branded i-devices, multimedia and Internet-enabled smart phones and smart-devices of all faces, amongst others similarly situated. In the description that follows, the term “stationary device” encompasses a device that is generally operated in a fixed location. A stationary device may be movable or transportable, but is generally not operated while in transit.

In the description that follows, the terms “soft button” can encompass a graphical representation of a D-pad (directional pad) or gamepad, a physical button, a switch, a pointer, an alphanumeric key, a data-entry key, a player or any other input-seeking graphical representation on a touchscreen; within a gaming-environment, primarily, that may be engaged by a user through touch, either remotely, proximally or directly, in order to enter a command, indicate a selection, input data or engage or control an actionable object located on the touchscreen. An implementation of touch engagement is geared for the context in which the embodiment is intended, without suggestion of limitation. The term “soft” used as an adjective generally indicates that something is software-implemented. So a “soft input” could be a soft button or another kind of software-implemented input, but not a physical input such as a depressable button.

In the description that follows, the term “attachment” may generally refer to a device or assembly that is placed in contact with the soft-buttons on a touchscreen for purposes of engaging control of an actionable object or series of objects, such as those that may be present in a gaming environment, although this environment is not suggestive of limitation. An attachment may be adapted for both wired and wireless expressions. A serviceable mapping system further allows for a system of virtual attachment with the shared purpose of manipulating an actionable object.

In the description that follows, the term “remote operation” refers to both a physical and/or gesture-based controller assembly, interface or device that is intended to be operated remotely from the touchscreen.

A “specialty controller” is generally defined in the industry as any non-standard controller. Standard controllers are generally considered to include directional inputs, such as directional pads and joysticks, as well as depressable buttons, in a conventional form factor. Examples of specialty controllers include racing wheel controllers, dance pads, guitar, piano, drum, microphone, and other musical instrument controllers, golf club controllers, hockey stick controllers, tennis racket controllers, baseball bat controllers, DJ station controllers, etc.

A new touchscreen specialty controller apparatus includes a specialty controller input device having one or more inputs and configured to communicate remotely with a touchscreen user device. Each of the one or more inputs is tethered to a corresponding touchscreen user device input, such that actuation of one of the one or more inputs is consistently translated to actuation of a corresponding touchscreen user device input to control an actionable object displayed on the touchscreen user device. The specialty controller input device may communicate with the touchscreen user device through an actuating agent, and the actuating agent may translate the actuation of the one or more inputs into actuation of corresponding touchscreen user device inputs. The actuating agent may be a physical device such as an intermediary transceiver or a direct conduit from the input device to the touchscreen user device display, such as a wired assembly, or may be software-based, such as an app or other code installed on the touchscreen user device for direct communication between the input device and touchscreen user device.

A new touchscreen controller system includes a remote motion-sensing input device, an intermediary device comprising a processor, and one or more output ends connected to the intermediary device for affixing to a touch-screen device. The motion-sensing input device communicates input to the intermediary device and the intermediary device determines a touchscreen gesture corresponding to the communicated input and transmits a signal to the output ends causing the determined touchscreen gesture to be applied at the output ends.

The intermediary device may include a receiver for wirelessly receiving data from the motion-sensing input device, an internal capacitive source, and a capacitive manager for applying capacitance from the internal capacitive source to the output ends. Conductive members may connect the motion-sensing input device and the intermediary device and connect the intermediary device to the output ends. The motion-sensing input device may comprise traditional electronics such as an accelerometer and gyroscope and/or include divining input from atypical means such as a plurality of surface holes and internal ultrasonic anemometers for sensing the direction and speed of motion of the motion-sensing input device for touchscreens. The motion-sensing input device may include one or more processors for processing data from sensors in the motion-sensing input device and determining corresponding input gesture information for communication to an intermediary device and/or directly to a touchscreen user device by virtue of a serviceable mapping system. Furthermore, the speed of a gesture may be translated into a power level by the one or more processor in the motion-sensing input device, which may be output at the output ends of a physical interface for intended actuation and/or by a mapping complement such that a corresponding power level on a power bar displayed on the touchscreen is engaged. The motion-sensing input device may also include one or more buttons, and the touchscreen gesture may be determined based on buttons pressed and motion sensed.

The system may also include a base station for securing a touchscreen device, and the base station may be configured to hold the touchscreen device in an upright position to ensure uninterrupted connection to the output ends and for easy viewing, to charge the touchscreen device, and to output the display of the touchscreen device to a connector for transmission to a separate display device. The system may also include an A/V output for connecting a touchscreen device to a separate display device and outputting the touchscreen device's display to the separate display device. The motion-sensing input device may also include a plurality of surface holes and a plurality of acoustical sensors distributed beneath the holes for sensing the direction and speed of motion of the motion-sensing input device. The motion-sensing input device may also include a plurality of surface holes and a plurality of pivoting internal wind flaps configured to be engaged by wind from the surface holes, where the wind flaps are biased towards a central resting position and their deviation from this central position indicates the direction and speed of motion of the motion-sensing input device. The motion-sensing input device may also include one or more suspended, movable magnets biased towards a central resting position and a plurality of sensors around the magnets that are triggered by an incidence of magnetic influence by the magnets, for determining the direction and speed of motion of the motion-sensing input device.

The output ends of an actuating interface may include a thin film membrane having properties of an actuating catalyst or agent present, where the film experiences a catalyst reaction upon broadcast collision of a serviceable projection, causing a capacitive instance, without suggestion of limitation, to be transferred to an attached touchscreen. The motion-sensing input controller may include a mat that is equipped with a plurality of sensors capable of determining a motion input and a microcontroller unit with wireless interface that bridges divined motion input of a physical controller with a soft-input interface. The motion-sensing input controller may further include a mat having a plurality of distributed independent sensing modules of a conductive material that detect capacitive objects in contact with the modules, and the modules may permit determination of the location, as well as direction and speed of motion, of a capacitive object on the mat. The motion-sensing input device may be in the shape of a shoe for wearing by a user, and include means for tracking movement of the motion-sensing input device from a position of rest as well as the time elapsed and distance traveled in between a series of contact of the motion-sensing input device with a surface. The motion-sensing input device may include motion-capture balls configured to be worn by a user and video cameras configured for detecting the motion of a user wearing the motion capture balls for potentially added precision metrics in a controller environment.

The motion-sensing input device may be in the shape of a guitar controller and include conductive strings and conductive, horizontally-divided frets, and the strings and frets may conduct the capacitance of a user touching them, thereby indicating which strings and frets are being touched by a user or may include a wireless interface reliant on mapping. The output ends may include an internal capacitive source and receive commands wirelessly from the intermediate device. The motion-sensing input device may include a racing-wheel assembly and/or conductive pedal having a scroll bar contacting a surface plate that includes a plurality of isolated actuating elements, where the scroll bar is configured to slide along the surface plate as the pedal is depressed, moving from one actuating element to the next on the surface plate and conducting a user's capacitance thereto, thereby indicating the position, speed and direction of movement of the pedal or may include a racing-wheel assembly with wireless interface reliant on virtual-mapping “attachment” with a compatible touchscreen device and gaming title. The motion-sensing input device may include a stick or club having a conductive grip and bottom surface, such that motion of the stick or club across the surface of a mat including a plurality of conductive sensing modules conducts a user's capacitance to the sensing modules, allowing the motion of the stick or club across the surface of the mat to be determined and/or may comprise a motion-input controller with sensors such as accelerometer and positional for wireless disposition reliant on mapping. The motion-sensing input device may include a ball element having a soft conductive surface and an internal capacitance source supplying capacitance continuously to the surface, such that motion of the ball across the surface of a mat comprising a plurality of conductive sensing modules conducts ball surface capacitance to the sensing modules, allowing the motion of the ball across the surface of the mat to be determined and/or a serviceable motion-controller input offering that divines sport-themed motions for corresponding virtual actuation of an actionable object on a touchscreen by virtue of a mapping interface. The motion-sensing input device may include a turntable element matrix having a plurality of autonomous sensing elements, where the autonomous sensing elements sense a capacitive source in contact with them, tracking user motions on the surface of the turntable element matrix. There may be a rotatable, capacitance-friendly thin-film membrane over the turntable element matrix configured to rotate in accordance with a user's motions for ease of movement while conveying capacitance from the user to the turntable element matrix below. Conversely, a specialty DJ-controller system may operate in a manner not reliant on the capacitive input of a user in a wireless expression.

A new system includes a remote motion-sensing input device, one or more output ends configured for connection to a touchscreen and application of capacitance to the touchscreen, and conductive connectors connecting the input device and output ends. The remote motion-sensing input device includes a conductive outer surface and a mechanical selection mechanism, the mechanical selection mechanism completes a conductive path between the conductive outer surface and a conductive connector and attached output end based on a movement of the remote motion-sensing input device. The motion-sensing input device may include a conductive outer surface, one or more internal variable components, and a plurality of internal controller nodes around the variable components, where the variable components move when the motion-sensing input device is accelerated, forcing the variable components to contact one or more of the controller nodes and forming a conductive path between the conductive outer surface and the contacted controller nodes.

The internal variable components may include ball bearings in guided channels. The remote motion-sensing input device may include a rotatable portion and rotatable actuating element conductively connected to the conductive surface, the rotatable actuating element may rotate around a ring of isolated conductive elements, configured such that a user's capacitance is conducted from the conductive surface to one of the isolated conductive elements at any given time based on the rotational position of the rotatable portion, where each isolated conductive element is connected to a separate conductive connector and output end.

A new system includes a plurality of beam-casting elements, a user input device comprising a light sensor, a timer, and a machine input interface. The machine input interface is configured to receive commands from a gaming device for activation of the timer and beam-casting elements, the beam-casting elements project a light beam to indicate the location of an object and the timer indicates the time until impact of the object, and detection of the light beam by the light sensor at timer expiration indicates intersection of the object and the user input device. The user input device may include further light sensors, and the light sensor detecting the light beam at timer expiration may affect a determined result of the intersection. The beam-casting elements may be movable. The user input device may include one or more buttons or motion-sensing devices, where a determined result of the intersection is affected by a button pressed by a user or motion made by a user.

The inventor seeks to introduce a paradigm shift in operational control and functionality for touchscreens by virtue of the described methods and assemblies (and their spirited breadth and scope) of communicable specialty-input controllers adapted for touchscreen environments. The application serves an eclectic mix of both wired (e.g. a wired attachment interface for physical mapping) and wireless (e.g. a system of attachmentless actuation ushered by virtual mapping) touchscreen controllers in an effort to build on the inventor's previous discourse and to further highlight a continued theme of touchscreen-controller innovation. The inventor seeks to revolutionize the face of touchscreen gaming by first seeking to revolutionize the face of touchscreen controllers, and in so doing, tries to quash many of the perceived touchscreen limitations highlighted by a growing chorus of users by not only facing these limitations head on, but in attempting to think outside the “screen” and attempting to solve these issues to a level of controller empowerment.

### BRIEF DESCRIPTION OF THE DRAWINGS

Images expressed in this application are for embodiment-based illustrative purposes only and are not suggestive of limitation, as products released to the market may differ widely, from those illustrated, while still remaining faithful to the spirit and scope of this discourse. Images are not necessarily to scale and do not suggest fixed construction and/or component composition.

According to embodiments:

FIG. 1 is a perspective view of a motion-input or gesture-sensing controller (control dynamics effected by motion-gesture input) with a modal plurality and a wirelessly-tethered or wirelessly-linked intermediary-transceiver device; in congruence with the input dynamics of a touchscreen application.

FIG. 1A depicts one such mode designed to measure “wind bursts” precipitated from a user gesture.

FIG. 1B depicts a traditional motion-controller input assembly serviceably paired with a touchscreen user device for the virtual manipulation of an actionable object.

FIG. 2 is a top view of an intermediary-transceiver device connecting a dance-mat interface and related dance-step controller mat—and potential exercise-mat variant—with a touchscreen device, as constructed in congruence to the input dynamics of a touchscreen application.

FIG. 2A illustrates a wireless dance and dance-step specialty-controller mat variant.

FIG. 3 is a top view of a guitar interface and guitar-based controller, congruent to the input dynamics of a touchscreen application.

FIG. 3A represents a guitar-based specialty-controller environment of wholly wireless disposition and a serviceable mapping interface.

FIG. 4 is a dichotomous view of a musical-keyboard interface and keyboard-based controller and a drum-set controller (both controllers acting as a controller input) with an intermediary-transceiver device component, congruent to the input dynamics of a touchscreen application.

FIG. 5 is a top view of a racing-wheel interface and racing-wheel controller, congruent to the input dynamics of a touchscreen application. FIG. 5A represents the scroll-bar apparatus of a gas-pedal controller that is associated with pedial depression, in congruence with the input dynamics of a touchscreen application.

FIG. 5B illustrates a wireless racing-wheel controller and coalescent audio/visual assembly transitionally designed for operational and integral use in a race-themed environment for touchscreen devices.

FIG. 6A is a perspective view of a conductive, hockey-stick controller prop; capable of effecting a requisite conductive path, through the capacitive-clutch input of a user, when combined with mat-based gesturing. A plurality of controller mats, congruent to the input dynamics of a touchscreen application, are shown in accessory.

FIG. 6B is a detailed view of potential attachment (or connectivity) means of a pedial-input and prop-gesture controller interface, as described in FIG. 6A.

FIG. 6C illustrates a “power-bar” or “power-meter” system of custom actuation that may be introduced to a touchscreen-controller environment; empowering layered disposition.

FIG. 7 is a perspective view of a conductive, golf-club prop; capable of effecting a requisite conductive path, through the capacitive-clutch input of a user, when combined with mat-based gesturing. Respective orientation and gesture-input determinant mats, congruent to the input dynamics of a touchscreen application, are shown in accessory. FIG. 7A is a perspective view of a golf-club controller prop that contains an asymmetrical surface at the head's underside that, depending on club angle, traverses across a plurality of densely-arranged, autonomous sensing elements in a variable manner, subject to calculation.

FIG. 8 is a perspective view of a baseball-bat and baseball-glove controller prop designed to interact with a beam-casting tower and an intermediary-transceiver device with controller interface, congruent to the input dynamics of a touchscreen application.

FIG. 9 is a perspective view of a bowling-ball controller prop designed to interact with a motion and directional-determinant mat input and, in a constituent link comprising a requisite conductive path, an intermediary-transceiver device effecting an input gesture, or series of gestures, to a touchscreen device, congruent to the input dynamics of a touchscreen application.

FIG. 10 is a perspective view of a DJ-station input controller and intermediary-transceiver device with interface and, at its inset, a manner prescribed for faithfully translating an omnidirectional hand or finger motion (a form of “path shaping” in the directional chronology of a gesture) across the surface of an element plurality, in accordance with the input dynamics of a touchscreen application.

FIG. 10A illustrates a hybrid DJ specialty-controller input system for touchscreen devices, in accordance with a wireless embodiment.

FIG. 11 is a perspective view of an intermediary-transceiver device, leveraging an innate-capacitive source and capacitive manager to faithfully (in respect to a controller input or series of input) engage—through a network of wired appendages attached to a touchscreen—an actionable object or object plurality rendered on the touchscreen of a portable or stationary device. Designed for remote input in congruence to the input dynamics of a touchscreen application.

FIG. 12 is an illustration of a touchscreen-suspension device equipped with comfort grips and a tactile controller interface designed for remote operability.

FIG. 13 is an offspring illustration to FIG. 12 and a figure which depicts an alternate touchscreen-suspension device that supplies a user-mounted support apparatus.

FIG. 14 illustrates a tactile interface having a capacitance-transmitting button member or member plurality; communicably placed on the non-glass borders of a touchscreen user device.

FIG. 15 illustrates a mouse-type input system that uses an associated camera to track, for example, a user's fingers and integrative gestures (assuming and influencing the position of “mouse” pointer).

FIG. 16 illustrates a wireless input controller and dynamic pairing application that can be integrated with or without use of an intermediary-transceiver device and any associated congruous attachment or attachment plurality.

FIGS. 17 and 17A illustrate a plurality of light-gun or akin-based specialty-input controllers mobilized for control of an actionable object on a receptive touchscreen user device.

FIG. 17A shows a touchscreen user device oriented such that its broadcast image thereon is reflected by a relay mirror strategically positioned for both receipt and subsequent reflection of said broadcast image to an acrylic-mirror counterpart concluding a reflection chain, where the resulting reflected image is the same as the original broadcast image and not reversed. Below the acrylic mirror is a receiving device comprising a grid of photodiodes which detect infrared light (passing through the acrylic mirror) projected from a light gun. Thus, a user may view and shoot light beams at the acrylic mirror (rather than the touchscreen itself) with the same coordinate precision for purposes of manipulating an actionable object.

FIG. 18 illustrates a dock-connector system for the primary purpose of powering the determinant components of a small intermediary-transceiver device with camera. A capacitive-discharge overlay operates in collaboration with the small intermediary-transceiver device to strategically deploy (based on camera-tracked input gestures) a capacitive charge to a targeted domain on the touchscreen for related actuation.

### DETAILED DESCRIPTION

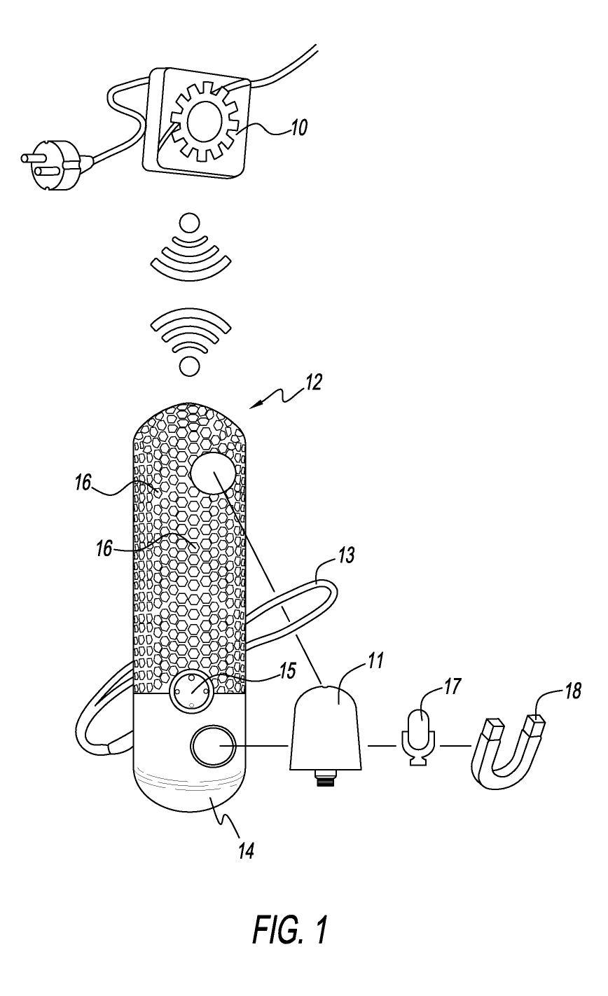

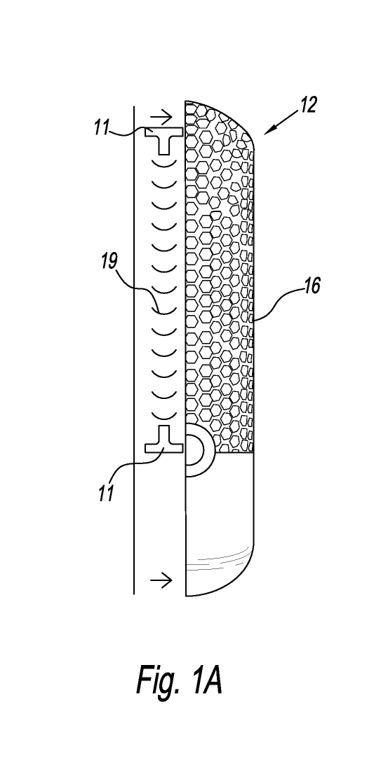

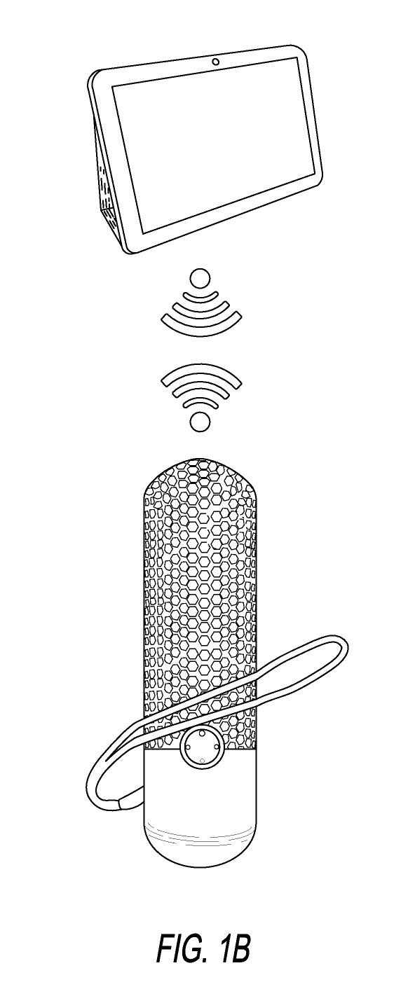

Referring now to the present invention in more detail, according to an embodiment, in FIG. 1 a motion-input or gesture-sensing controller under a modal plurality and an electronically-tethered or linked intermediary-transceiver device is shown.

Common motion detectors include passive-infrared (PIR), active-ultrasonic and microwave-based detection systems, and while traditional passive infrared (PIR) technologies in concert with accelerometers, for instance, are within the scope of the claimed invention regarding touchscreen-controller environments, alternate implementations designed to register the product of motion with a touchscreen device are presented in FIG. 1.

The inventor acknowledges that existing motion-input (and, where desired, non-motion based or traditional) controllers on the market may be made compatible and/or operational under the present invention via “plug-and-play” reconciliation with a specially-designed intermediary-transceiver device 10. The intermediary-transceiver device 10 is equipped with a comprehensive inter-connectivity and interoperability interface designed to recognize a number of foreign and/or competing controllers and their respective controller inputs and faithfully translate recorded controller gestures (a controller input) to corresponding actuation of a touchscreen (an output, of sorts, to a touchscreen input) via an innate capacitive source and capacitive manager. Gaming software may be adapted to facilitate this purpose. An implementation that focuses on measuring an incidence of wind and/or wind speed created from the “thrust” or “motioning” activity of a controller gesture, is one such deviceful implementation of a motion-input or gesture-sensing controller 12.

Ultrasonic wind sensors (ultrasonic anemometers), such as ultrasonic transducers 11, used to measure apparent wind speed and direction can be purposefully built into a motion-input or gesture-sensing controller device 12 to attain that objective, although the present invention is not limited to the use of anemometer sensors. Rather any and all sensors (and sensor combinations) serviceable to the objectives of the claimed invention in adapting controllers for use with a touchscreen device can be utilized; including optical encoders, interrupters, photo-reflective, proximity and hall-effect switches, laser interferometers, triangulation, magnetostrictive, cable-extension transducers, linear variable differential transformers (LVDTs) and tachometers, as appreciated by those skilled in the art, in the spirit and scope of this discourse.

The motion-input or gesture-sensing controller device 12 is constructed to dimensions which facilitate grip comfort, grip security (with an inclusion of straps 13 to complement said design) and extended operational use (for instance, the device is lightweight and not awkward or bulky). The motion-input or gesture-sensing controller device 12 contains a graspable bottom end 14—with optional rubberized finger grooves on the underside and an accessible button controller 15 at its face, a fluent body and top end containing an engulfing plurality of perforated or panoptic holes 16 (each acting as a wind channel 16). The set of holes circumvolving all sides of the control structure and are preferably positioned away from the graspable bottom end 14 to reduce potential incidence of hand blockage of any member of the wind-channel or channel plurality 16 upon a user gripping the motion-input or gesture-sensing controller device 12. The plurality of panoptic holes 16 are paired with variant-to-task monitoring sensors in the constructed interior; strategically placed to, under the accompanying example, ascertain “wind bursts” produced by a plurality of directional inclinations or gestures. Such circumvolved design patterns provide the potential ability to sense the “motioning input” of a full-range of user gestures; which are subjected to translational interpretation for respective touchscreen actuation.

The motion-input or gesture-sensing controller device 12 can be dissected into two halves. For purposes of discourse, they are labelled the front half and the reverse half. Each half is sealed off from the other in order to help prevent incidental “wind bleed” from opposing ends “bleeding” through and conflicting intentioned gestures and/or directives, thus helping render more accurate directional readings from a motion-input or gesture-sensing controller device 12. The sealing may, for example, be accomplished by physical shielding—such as with a vacuum lock or any serviceable seal that prevents potentially turbulent air flow, air flow resulting from a motion in one direction, from entering sensors designed to “sniff” a contrary direction—and/or by incorporating an electronic dampener.

The ergonomic and/or fluent body of the controller contains a plurality of ultrasonic transducers 11 that are positioned strategically within the device (see FIG. 1A). The ultrasonic transducers 11 may operate in pairs (sending and receiving) and an occurrence of a potential plurality of pairs may be positioned, without being suggestive of limitation, as such: one in proximity to the top end and one in proximity to the bottom end, of each of the two sealed halves of the motion-input or gesture-sensing controller device 12 for deft monitoring of the panoptic holes 16, as they are subjected to wind bursts.

A set of transducer nodes (with each node potentially assuming the appearance of an antennae) can also be positioned—without suggesting limitation—across the depth (face-to-back) of the controller innards (not illustrated), in each of the halves, to account for respective ranges of motion seeking measurement outside of the top-to-bottom transducer-pair disposition, as an example. The ultrasonic transducers 11, engaging a sniffing path travelled by an ultrasonic pulse 19, are designed to monitor any incidence of wind input through the panoptic holes or wind channels 16 for related motion determination and, by leveraging a linked processor or processor plurality, to begin the “upstream” processing or engagement of an actuating path faithful to an input gesture via an intermediary-transceiver device 10.

A microprocessor in the motion-input or gesture-sensing controller device 12 or device series, and/or an associated software script (for example, running from the motion-input or gesture-sensing controller device 12 and/or intermediary-transceiver device 10), can be enlisted in the task of calculating the presence of wind, if any, from any controller movement or gesture by the user and, upon recorded incidence, can assist to faithfully relay directives to the intermediary-transceiver device 10—for correlative soft-button actuation via a touchscreen interface—as a touchscreen application is being rendered. An internal thermometer may be present to account for changes in air temperature which affects speeds, although such specificity may not be requisite to the control dynamics of a given application. Such controller technologies are highly migratory and can readily be adapted into controller or prop variants such as, but not limited to, a tennis or ping-pong racquet, hockey stick and fishing-pole controller; alone or in technological combination. A native motion-input or gesture-sensing controller device 12 may be designed for accessorizing by adjunct snap-on components, preferably light-weight in nature, such as a racquet or croquet-mallet head, for an added parallel.

According to a controller scenario embodiment similar to FIG. 1A, one ultrasonic transducer 11, aligning itself with a metal plate, on the opposing end of a sniffing path across a plurality of wind channels, may inject an ultrasonic pulse (sender) into the air and see the pulse reflected by the strategically-placed metal plate at the bottom of the “injecting” channel, before it is readily carried by the wind, if present, to a proximal listening transducer (receiver). When no reading of wind is recorded, the ultrasonic pulse is interpreted by the listening transducer at the speed of sound. The time it takes for the pulse to traverse between the originating node (sender) to the receiving node (receiver) is precisely measured. When wind is blowing in the direction of the projection, the pulse will arrive faster than when there is no incidence of wind. When wind is blowing (a directional measure) in a direction contrary to the projection, the pulse will arrive slower than when there is no wind incidence. With no wind, again, the ultrasonic pulse will travel at the speed of sound. The pair of transducers can alternate between sender and receiver.

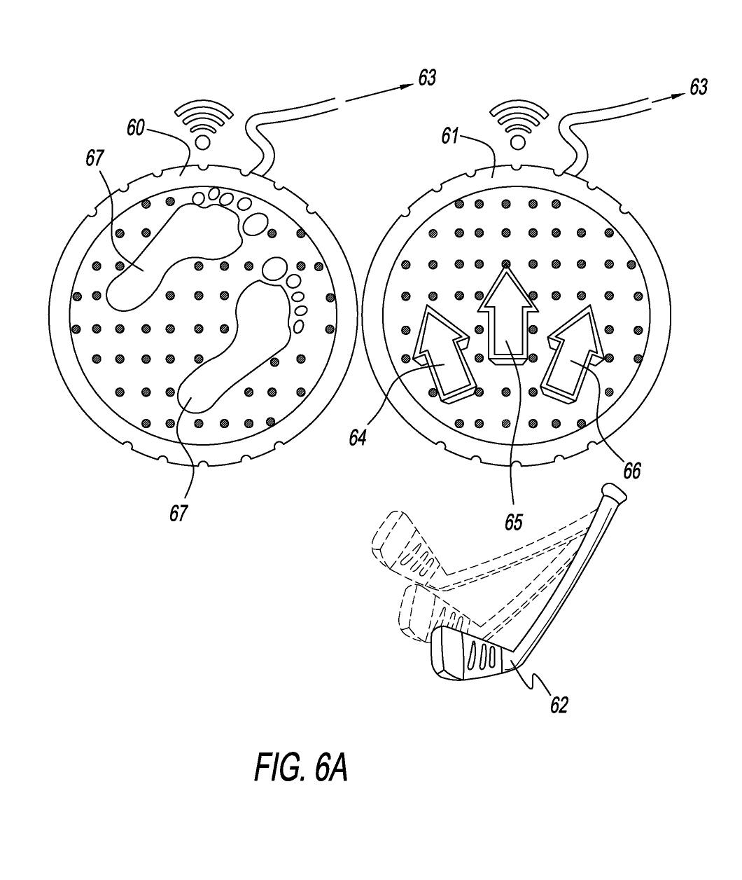

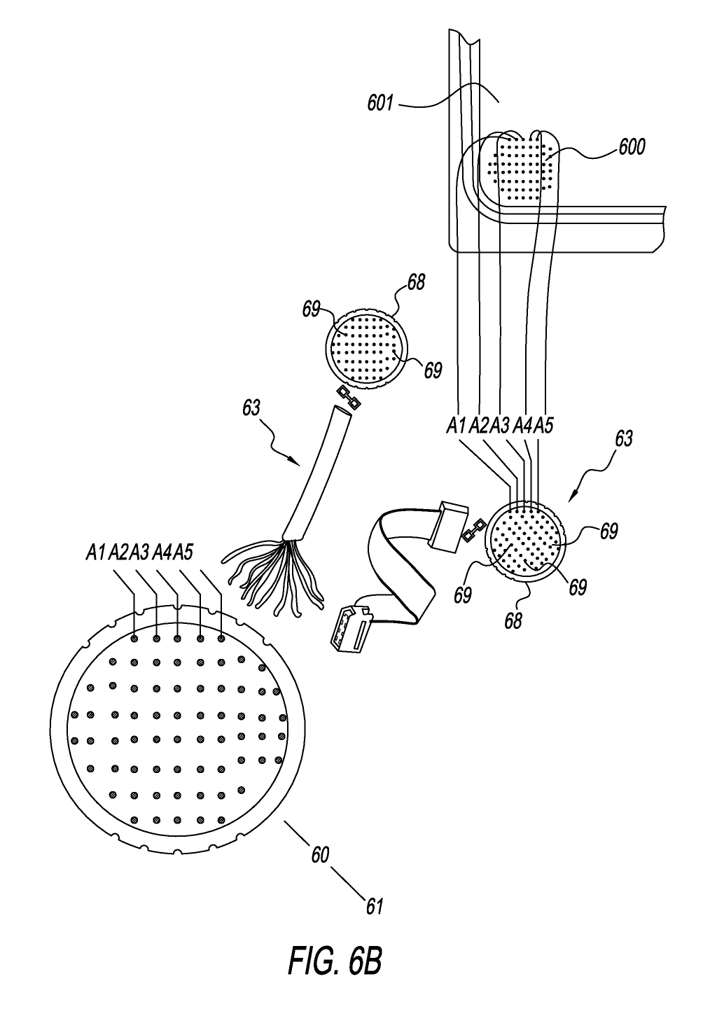

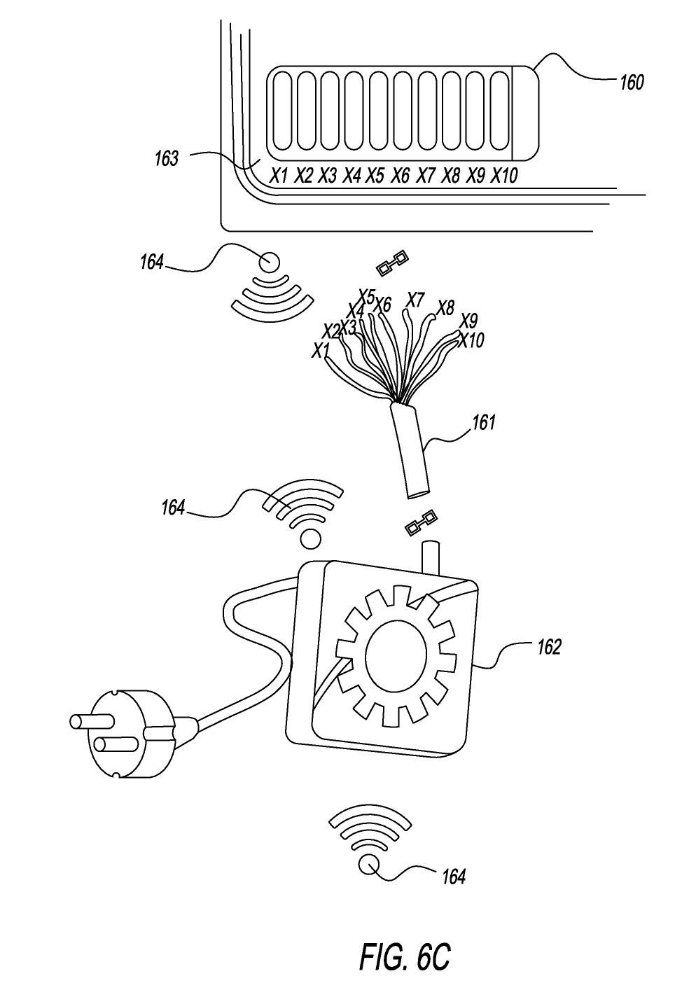

Video-game applications or titles may be specially programmed to integrate motion-input or gesture-sensing controller devices 12, providing for a translation of gestures into controller commands. A “forward-motion” gesture, for example, may logically be paired to an “up” button—or gestures may take on a completely novel soft-button input mechanism for more intricate touchscreen-controller rendering by a gesture input. In illustration, the velocity of wind input—indicating the “power” or “intensity” of a thrust—stemming from a gesture can be precisely measured and coordinated to a respective tier in a tier-based, soft-button controller system (not illustrated here, a focus of discussion in FIG. 6C). In a tier-based, soft-button controller system, which accounts for the power/intensity of a motion, the intermediary-transceiver device 10 and/or motion-input or gesture-sensing controller devices 12 may translate, through a series of calculations, the velocity of a gesture, amongst other gesture metrics, and see an intermediary-transceiver device 10 actuating a corresponding tier of a soft-button “power bar” or “power meter” based on the rendered calculations.

When an aggressive gesture is registered, for example, the intermediary-transceiver device 10, containing an actuating interface with a plurality of conductive elements; with each individual element being individually assigned (until each tier is account for) to a corresponding tier of a tier-based, soft-button controller system, actuates a high-level power tier in response to said aggressive gesture. The intermediary-transceiver device 10 faithfully engages an output interface accordant to the registered input dynamics. Exactly which level of tier is actuated can be dependent on a rendered output of calculation metrics, in contrast with a set of predetermined tier ranges, each tier hemmed to the range of metrics afforded to it. Said another way, which level tier is actuated can be dependent on a calculation of the measured strength of a gesture input on a rating scale (such as between 1-100), as it contrasts with a set of predetermined tier ranges; matching each tier to a corresponding range on the scale (for example, tier 9 might correspond to a rating of 81-90, tier 10 to a rating of 91-100, etceteras).

Further in breadth, complementary input dynamics may be attuned by incorporating technologies, such as an innate-depth and proximity sensor, into the controller; which can be similarly interfaced, in independent layers of actuation, if so desired, via a layered soft-button assembly mimicking the “power-meter” system. In this way, the innate-depth sensor, can, as a case in point, detect motion degree to and from a stationary-bearing point, such as the torso, floor and/or touchscreen. This system may provide for the intensity of motion in each direction to be captured and output separately. A plurality of layered soft-button assemblies may be used in concert, if warranted.

With a motion-input or gesture-sensing controller device 12 containing a supplementary button controller 15—for instance, a D-pad (directional pad), gamepad or any other physical input button—similar “tier-based” control methods can be established based on diverse input metrics, such as, but not limited to, the triggering of a button or buttons in rapid succession and/or touching and “dragging forward”, via a concurrent forward thrusting or sweeping motion of the motion-input or gesture-sensing controller device 12 (the drag length potentially representing different tier sets for purposes of this discussion) while an actuated soft-button or button plurality remain(s) concurrently depressed, suggesting the premise of controller-input synergies by example. Game-specific, controller-input synergies may be learned. Gesture “shortcuts” may also be incorporated. Please note that touchscreen-specific motion-related gestures, controlled remotely from a input device, will be discussed in greater detail in the forthcoming discourse of a plurality of related figures.

A base station may be used to accept and securely station and/or mount a touchscreen device at a physical position of rest, for instance, in a manner not unlike the way a device is docked for charging (which may, parenthetically, be a design impetus during the course of game play—or periods of inactivity—to apply and/or maintain a charge) or in which a console system accepts and stations a game cartridge. The base station may, for that matter, assume, or borrow from, the appearance of a traditional-gaming “console”. The base station can further accommodate the use of a AV cable output or akin medium, thus allowing any screen output of a touchscreen device to be viewed remotely on an independent television screen. “Plug-and-play” and/or “attach-and-play” connectivity amongst a user device, controller input and touchscreen output can be bolstered through assistive-design and component supplementation, such as, but not limited to, assistive cabling (facilitating touchscreen device connectivity amongst a broad base of compatible and/or peer components). The premise of stationing a user device is ideally situated for remote-operating scenarios.

The use of a screen-attachment interface, the premise of which is discussed at great length in the kindred applications incorporated by reference herein and noted on page one of this application, makes remote-operating scenarios possible. In simple terms, without an intermediary-transceiver device 10 being employed in a conductive path, according to an embodiment, the interface provides and manages a plenary conductive (capacitive) path between a controller input and its respective controller output (which, in essence, outputs capacitance to a touchscreen input).

Beyond ultrasonic wind sensors (ultrasonic anemometers) used in the process of registering and translating a controller's motion to the touchscreen of a portable or stationary device, alternative means serviceable to this discourse are presented, although such exemplary language is not intended to be limiting in nature. Acoustical sensors 17, such as with the context of an acoustically-sensitive microphone 17 plurality monitoring acoustical patterns innate to the controller, represent further possibility, in the spirit and scope of this discourse, according to an embodiment. Acoustically-sensitive microphones 17 are a form of transducer, in that upon detecting air-pressure patterns, these patterns are then interpreted and translated into electric-current patterns or electrical impulses. Said another way, a microphone converts sound waves (acoustical energy), existing as patterns of air pressure, into electrical impulses and then usually back to sound waves (acoustical energy) through an earpiece or speaker; which act as a secondary transducer. Different types of microphones convert energy differently, but the common thread amongst them is the diaphragm—a thin piece of material that serves to vibrate when struck by sound waves.

In the context of using acoustical energy as a measurement and conveyance tool of a controller input, a secondary transducer, such as an earpiece or speaker often associated in a microphone-based audio chain, may not be necessary, although such language does not, for instance, limit the inclusion of speakers in a controller-body design, where desired. The pattern of electrical current or a current plurality; sourced through a microphone or microphone plurality (at the strategic exit of a wind channel or channel plurality, for example) and then parsed by an innate processor in relation to an acoustical template, is the focus of this exemplary discourse, this according to an embodiment.

A controller is fitted with a plurality of acoustically-sensitive microphones 17—with appropriate noise filter technology that filters out ambient noise to help improve acoustical-measurement (and therefore, controller) accuracy—that are positioned and distributed, strategically, in a directionally-encompassing manner, beneath a plurality of panoptic holes 16 or wind channels 16 to monitor “wind bursts” resulting from each directional inclination or gesture of the motion-input or gesture-sensing controller device 12. Panoptic distribution of the acoustically-sensitive microphones 17 or microphone sensors provide the ability to sense a full range of motions or gestures via the measurement of generated acoustical impulses, based on an input gesture or gesture plurality, in the spirit and scope of this discourse.

As a user motions a gesture with a specially-designed motion-input or gesture-sensing controller device 12 (acoustical-impulse variant), an incidence of wind is fed into active wind channels 16 for measurement. Under certain operating scenarios, a motion or gesture may create a faint-pitched “whistling sound” from a wind injection, comparable to when wind is blown atop the mouth of a water bottle with an individual's lips placed at its edge. Wind channels 16 can be designed to manipulate or direct “wind bursts” in this manner for increased acoustical sensitivity, although such language is not intended as being limitative in nature and is merely exemplary. The wind channels 16, for example, may be constructed with basal spouts at a measured angle of variation to the acoustically-sensitive microphones 17 or microphone sensors to enhance responsiveness and sensitivity in the readings.

“Wind bursts” picked up by an acoustically-sensitive microphone 17, microphone sensor or related plurality, may be processed by an innate controller microprocessor (for direction guage, velocity, duration, etcetera) and then relayed to an intermediary-transceiver device 10 for related actuation upon the touchscreen of a portable or stationary device. Wind patterns sensed at the “top face” of the controller, exempli gratia, may be recognized, under a controller scenario, as originating from the forward-thrusting motion of a controller. Both an innate processor to the motion-input or gesture-sensing controller device 12 and intermediary-transceiver device 10 are communicatively engaged in order to faithfully translate a gesture input or input plurality into addressed actuation in mutual accordance with a soft-button or soft-button plurality. The motion-input or gesture-sensing controller device 12 may also wirelessly communicate directly with an equipped touchscreen device, in a native, attachment-less state and can also be equipped to impart the tactile experience of haptic feedback.

Ambient noise(s) such as those occurring from a vocal environment, a game's rendering, background music, et cetera, can be purposefully distinguished from acoustical impulses generated from motion gestures or “wind bursts” by, for instance, judging them against a thematic template, in the spirit and scope of this discourse. Ambient noise(s), can thus be rendered inconsequential and dismissed from motion calculations. Ambient noises typically elicit fundamentally different acoustical patterns than registered wind patterns resulting from an “injection” or “burst” of wind (when an incidence of wind is coursing through a plurality of panoptic holes 16 or wind channels 16), as measured by an embedded plurality of acoustically-sensitive microphones 17 or microphone sensors, the modal focus of acoustical measurement in this exemplary discourse.

In a related impartation (not illustrated), a motion-input or gesture-sensing controller device 12 variant involves implementation of oscillating “wind flaps”, innate to the controller, which can measure an incidence of wind input from a controller gesture, this according to an embodiment. The oscillating wind flaps are engaged by wind generated through a plurality of perforated wind channels or panoptic holes, activated by “thrusting” motions. The panoptic holes comprise a substantial region of the controller shell, beginning above the controller's grip. With the potential to oscillate from a pivot structure, the wind flaps are designed to actuate a set of proximal sensors, by pivot, through a range of controller motions and represents further potential of remotely initiating an actuating path, in the spirit and scope of this discourse. A forward-motion gesture, for instance, will see air forced through the front-end of the wind channel (at the face of the controller) from said gesture and cause the respective wind flap to oscillate in a downward position actuating a (front) node sensor, respectively. A wind flap is inclined to return to centre at a position of rest and is designed to help “ferret out” false readings, such as an incidental gesture. As a case in point, only certain ranges and motion durations may be registered by the proximal sensors and their electronic counterparts or, in another effort, by employing gesture-confirmation measures requiring a user to, for instance, simultaneously depress an “on” button during a gesture motion (or requiring a voice-activated command and/or confirmation prior to, or concurrent with, the gesture) in order for an actuating path to be initialized, although other measures could be adopted in the spirit and scope of this discourse. The integration of voice commands into a controller environment should not interfere with acoustically-sensitive controllers.

A tethered (electronically to the motion-controller device on one end and physically to the touchscreen through a network of actuating appendages on the opposite end), intermediary-transceiver device faithfully translates any recorded gesture input that is broadcast wirelessly from the motion-controller device into correlative touchscreen actuation of soft-buttons via an innate capacitive source and manager and its network of actuating appendages (or appendage in a singular design). A forward-motion gesture, for example, may reciprocate control and actuation of a “forward” or “up” soft-button, generally, although soft-button controllers and gesture metrics can be customized fittingly to any gaming environment, where desired. An intermediary-transceiver device can be designed for both two-way and/or single-line communication with an input controller.

According to another embodiment of a motion-input or gesture-sensing controller device 12 (this variant is not illustrated), magnetic principles are utilized to register motions. Inside the motion-input or gesture-sensing controller device 12 (magnetic variant) lies a suspended magnet 18 or magnet plurality that can be transposed from a position of rest (at centre) by the influence of a controller gesture. As a magnet is influenced by a controller gesture, it may, for example, be forced towards, in a directionally-proportional and understood manner, the shell of the motion-input or gesture-sensing controller device 12. A transposable magnet 18 is free to pivot about its centre in any direction and each path engaged in a directional pivot is designed for detection by a member or member plurality of strategic sensors set in place. For each of the sensors to be triggered, it will require an incidence of magnetic influence by the transposable magnets 18 or magnet plurality during a motion gesture, similar to the manner a cycle computer operates. Tracking the engagement of sensors allow gesture metrics to be ascertained. The duration of magnetic influence before a magnet is transposed back to a position of rest can be precisely measured, exempli gratia, to help quantify the velocity of a thrust. The motion-input or gesture-sensing controller device 12 variant may contain a processor capable of culling sensor duplication of a defined gesture, for example, as the transposable magnet 18 may cross the sensor originally and then return past the sensor to a position of rest after a gesture is concluded. Sensors can alternatively be designed with a forward-trajectory limit such that a transposable magnet's 18 path, regardless of the force of a gesture, does not breach this trajectory limit.

An additional method for culling sensor duplication is a controller design that includes a panoptic arrangement of dual sensors strategically positioned to account for all degrees of motion. As a magnet crosses the sensor closest to its position of rest, a gesture initiation is registered and then confirmed when the continued path of the transposable magnet 18 crosses the secondary sensor closest to the controller shell. Reverse order initiation of the sensors by a transposable magnet 18 (that is, from the secondary sensor closest to the controller shell to the sensor located closest to the transposable magnet's 18 position of rest) is readily deduced as a reflex measure (a return of the transposable magnet 18 to its position of rest) to the initial gesture itself. Modest gestures resulting in the breach of only the initial sensor before returning to a position of rest can also be processed accordingly for weaker gradients or, depending on the setting, be ruled as unintentional or inconsequential. A manner of manipulating the path of the magnet 18, if so desired, can be to magnetize the controller shell with the same polarity to that of the transposable magnet 18; such that, as the transposable magnet approaches the magnetized controller shell, the transposable magnet 18 is naturally repelled towards a position of rest. The force of repulsion is controlled to ensure that it does not thwart the intended functionality of the controller. Furthermore, strengths of the magnetic properties of all magnetic components can be varied to help tweak and optimize intended results. Rare-earth magnets may also be introduced to an operating scenario, where desired.

In one embodiment, a motion-input or gesture-sensing controller device 12 is lined with a metallic shell that serves to extend a conductive path—for user-supplied capacitance—throughout the shell-lined body of the controller, although this manifestation is not illustrated. The motion-input or gesture-sensing controller device 12 with metallic shell contains a plurality of dynamic actuating paths; paths which leverage a variable or ambulatory component to conclude a conductive path. Whereas a capacitive “switch” begins when a user first grips a motion-input or gesture-sensing controller device 12 with metallic shell, the “switch” completes when an ambulatory component engages an impelling agent, such as a controller node, thus transmitting an actuating path upon said engagement. Said another way, registration of a user gesture begins first with the user grasping a motion-input or gesture-sensing controller device 12 with metallic shell—beginning the conductive path or circuit—and completes when a variable component comes into strategic contact and/or proximity with any of the plurality of strategically positioned controller nodes. Each node can be triggered by a correlative gesture motion and the trigger event acts as a conductive counterpart for the completion of a conductive path. Using built-in electronics to register motion gestures, directives are then relayed (wirelessly, in the preferred manner) to an intermediary-transceiver device 10 for related touchscreen actuation.

A variable-dependent or dynamic-actuating path may be comprised of a liquid-filled tubing, such as, but not limited to, internal arches, that see a conductive liquid alter positioning within the arches (and hence, they may activate a respective controller node with positional contact goaded by a gesture) depending on the gesture. Once the actuating path is registered, this effectively completes the “gesture-circuit”, originating from the user clutching the metallic shell or skin (conductive-controller shell) and then concluding when the conductive liquid contacts either the adjoined metallic-controller node (a “sensor”) alone or in conductive combination with the metallic shell, concurrent with the act of gripping. Contact with the sensor to complete the “circuit” may occur directly, by the free-moving liquid in a housed component or by employing a wire or conductive bridge from the sensor node and/or metallic shell; depending on the design construction of the embodiment. The conductive bridge is prone to ambulatory engagement.

Upon completion of a conductive path in this controller scenario, an intermediary-transceiver device 10 is then enlisted which converts a pending actuation or actuation plurality into an actuation reality on a touchscreen. The conductive liquid can be comprised of varying viscosities that affect its transposable flow; thus offering the ability to vary controller characteristics in different gaming environments. The conductive liquid may also be prone to user manipulation in order to alter its properties of viscosity. The ambulatory component in this themed embodiment is exemplary in nature and is not suggestive of limitation.

Any material component in contact with the transposable liquid is designed to be non-corrosive in nature. Actuating paths between a controller input and controller output are dynamic, accounting for a wide range of gestures, and may additionally require the user to first press a button during a gesture motion for initializing purposes. In this way, the controller is not always “on” and sensing gestures at all times when the conductive controller “shell” or “skin” is grasped. Controllers may be marked to assist a user with proper grip orientation, such as the controller top being labelled “top”. Where an additional button-controller interface (such as a directional pad and/or game pad) exists at the controller face for foremost access, this can facilitate such orientation by design without such helpful markings.

Actuating paths can, of course, widely differ from the preceding examples and all actuating paths (not just those cited in exemplary discourse) serviceable to the present invention, in spirit and scope, are included as embodying manner herein. The potential for variants, combinations, equivalents and “kindred” controller scion, as appreciated and understood by those skilled in the art, to the embodying matter exists and all variants, combinations, equivalents and “kindred” controller scion are understood to be inclusive of this application's embodying matter herein.

FIG. 1B depicts a traditional motion-controller input assembly serviceably paired with a touchscreen user device for the soft-based manipulation of an actionable object. According to the present invention, a touchscreen interface may be provided for control operability of a soft-input from a hand-held motion controller of wireless disposition. Motion controllers, for example those leveraging use of accelerometers and optical sensor to track motion in (and/or relative to) a 3-D space, may be integrated to a touchscreen controller environment by virtue of a serviceable positional-sensor apparatus and accordant mapping system or software complement, in accordance with an embodiment. Whereas the accelerometer tracks speed of motion in three directions, the optical sensor determines directional inclination the controller is pointing and results in fluid control of the game by gesturing and pointing the controller. FIG. 1B depicts the transitioning of such a controller environment to touchscreens.

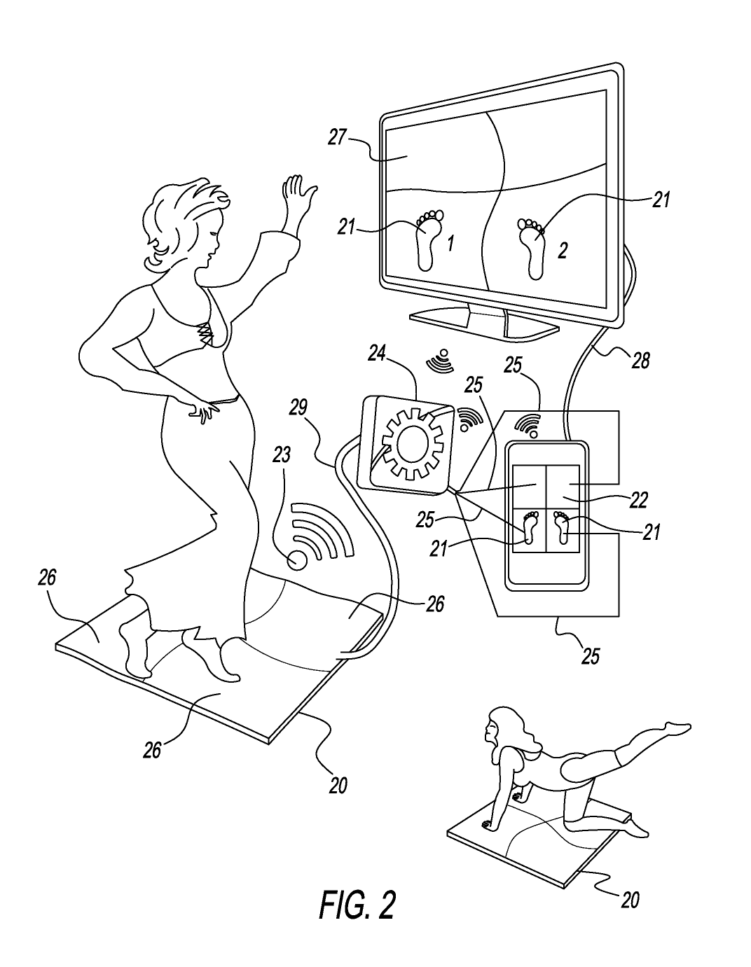

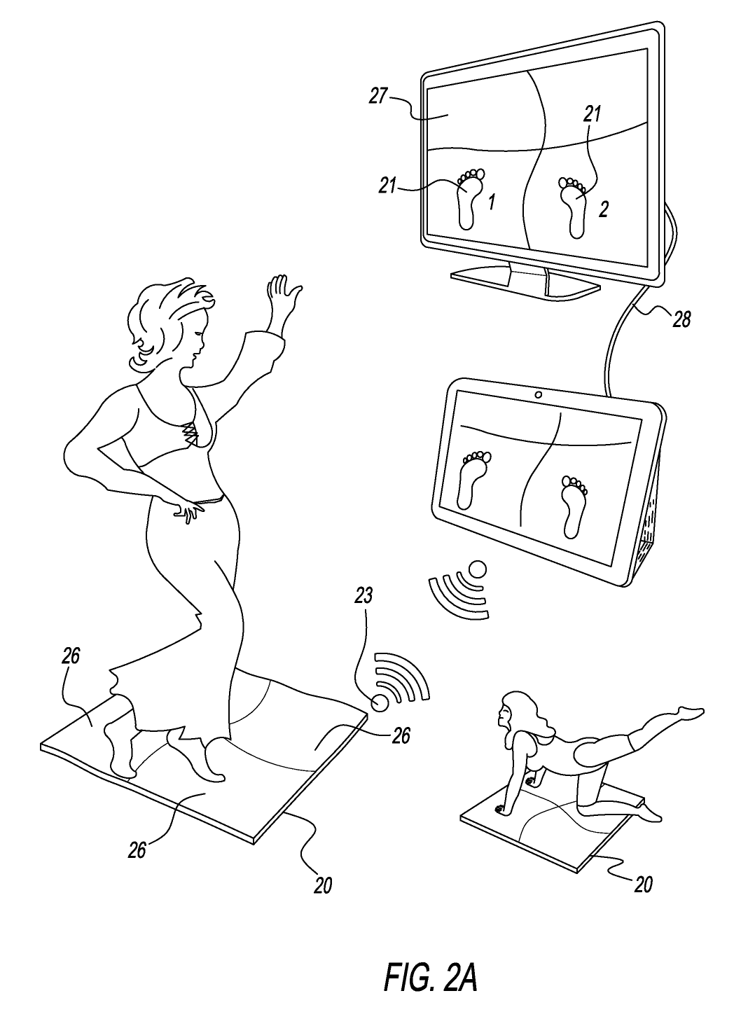

Referring now to the present invention in more detail, FIG. 2 is a top view of an intermediary-transceiver device with a ramifying dance-mat interface and a respective dance-step controller mat (an input device)—and potential exercise-mat variant—in accordance with the input dynamics of a touchscreen application, this according to an embodiment. A touchscreen and application's rendering is also shown, and in the case of the application's rendering, in duplicate on a big-screen television, as an illustrative aid for pedial input.

In an attempt to free the user from the constraints of traditional touchscreen actuation in its native, attachment-less state and raise the level of user involvement, a body-activated dance and exercise mat variant 20 is introduced to the application. The body-activated dance and exercise mat variant 20 is comprised of a plurality of independent sensing modules 26 designed (although design may vary, in the spirit and scope of this discourse) to readily sense the control input of a user. From the perspective of a wired embodiment 29, each independent sensing module 26 comprises a conductive material designed to “network” or “relay” user-supplied capacitance from a control input to an attachable remote touchscreen interface 25, through the correlative integration with a wired (or conductive) network securely housed in the underside of the body-activated dance and exercise mat variant 20.

At the underside, each sensing module 26 sees its conductive path, initially triggered by body capacitance when a user places, for instance, his or her foot or feet on the sensing module 26 (a form of conductive isolate), extended, through said wired implementation or a conductive “tether”, to a remote actuating appendage of the touchscreen interface 25. A physical “tether” can be interchangeably imposed by an electronic “tether”, of course, under a wireless disposition; which is discussed shortly.

The touchscreen interface 25 represents the final “link” along a conductive path of an input gesture (or conductive path plurality for a matrix in a plenary view) and serves to actuate the correlative soft-button (or button plurality for a series of input gestures) to a controller input. Under this method, each independent sensing module 26 is individually insulated from any competing sensing modules 26 in order to prevent “conductive bleed” and errant controller behaviour.

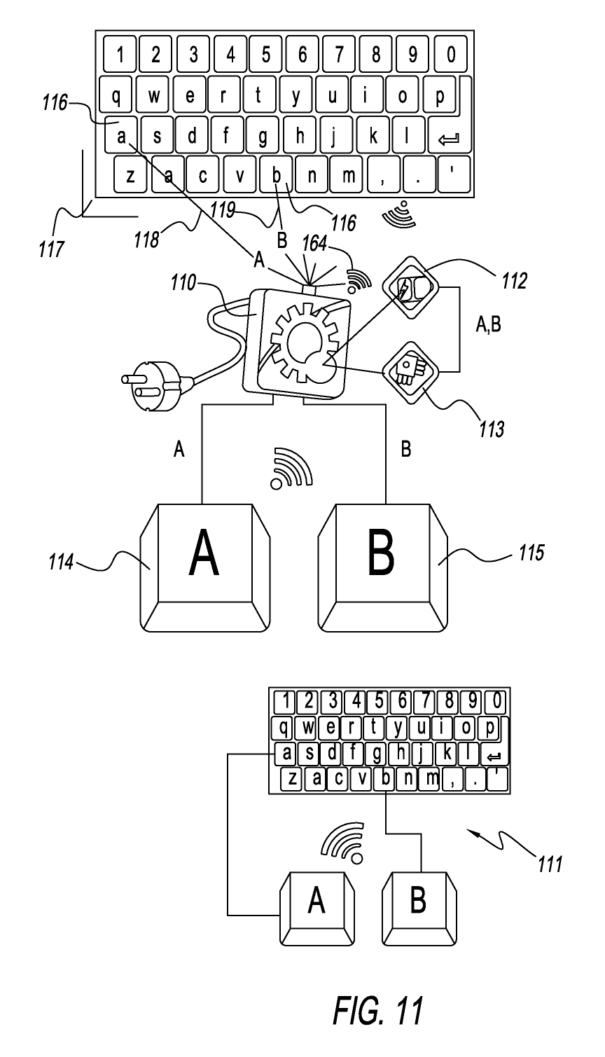

The body-activated dance and exercise mat variant 20 need not rely on the relaying of user-supplied capacitance to the touchscreen of a portable or stationary device 22 in a wireless 23 controller scenario, since an intermediary-transceiver device 24 may be present. The intermediary-transceiver device 24 contains an innate, that is, independently manufactured (hardware sourced, not supplied by user) capacitive source and a capacitive manager. The intermediary-transceiver device 24 faithfully translates any recorded controller-input gesture into correlative output touchscreen actuation, by drawing upon said innate-capacitive source and manager, while leveraging the intermediary-transceiver device's 24 network of actuating appendages (or appendage in the singular) comprising the touchscreen interface 25. An intermediary-transceiver device 24 is discussed in FIG. 11 of the present invention and at length in a plurality of kindred applications noted on page one of this application (which are incorporated by reference herein).

To engage control of an actionable object 21 on the touchscreen of a portable or stationary device 22, the user selects a matching position to the touchscreen (or position plurality in a series) on the sensing module(s) 26 of the body-activated dance and exercise mat variant 20 with his or her foot or feet, thus, breaking tradition from the typical control-input protocol of using a stylus or user's fingers as a control input. Where a wired and/or wireless incarnation of a body-activated dance and exercise mat variant 20 is not capacitance governed by design, a plurality of distribution sensors (such as, but not limited to, weight sensors, pedometers, etcetera) may be incorporated into the controller mat to source input directives by any means serviceable to this application, in the spirit and scope of this discourse.

Upon sensing the control input of a user's foot (or feet in a plurality), the body-activated dance and exercise mat variant 20 instantly relays these directives—either wired 29 or wirelessly 23—to an intermediary-transceiver device 24 for related soft-button actuation via a touchscreen interface 25. The touchscreen interface 25 serves to complete a conductive path, where a conductive path originates from a body-activated dance and exercise mat variant 20 controller input (a registration of pedial capacitance) and completes with the actuation of a correlative soft-button counterpart at the face of an attached physical output, marking the end of a conductive path. The innate-capacitive source and manager enable breadth of remote operation and a profound platform for gaming delivery.

The touchscreen interface 25 may be comprised of any material facilitating a conductive path in the spirit and scope of this discourse, such as, but not limited to, electronic ribbon, shielded flexible wire, insulated cabling and/or flexible (thin-film) printed-circuit board (PCB) construction with a pliant copper layer providing for correlative inter-connectivity amongst requisite conductive paths. Expanding on the latter approach to construction, although not illustrated, the input and output ends of the thin-film, printed-circuit board (PCB) are suitably melded for controller assimilation (or intermediary-transceiver device 24 assimilation depending on the embodiment) and attachment to a touchscreen of a portable or stationary device 22, respectively. Suction and static properties may be employed to the task for the latter. Small, adhesive (removable adhesive backing), liquid-filled nubs, comprising a conductive liquid or gel in the insular, for instance, may also be used for attachment purposes interposing both surfaces of the flexible PCB and the touchscreen of a portable or stationary device 22—while remaining faithful to a conductive path—amongst any of the varying methods serviceable to this application. For non-capacitive touchscreens, a servomechanism, such as an actuator, can be employed to electro-mechanically press an actionable object directly on a touchscreen.

The body-activated dance and exercise mat variant 20 may physically mirror the layout of a touchscreen's soft-button controller configuration to simplify user actuation. Designed to be gamer friendly, the body-activated dance and exercise mat variant 20 may further see lighting of its insular, sensing modules 26 and/or provide for a colour-coded design (matching a touchscreen output or rendering) in an effort to assist the user with visual orientation and correct-actuation sequencing; through an interactive awareness with the touchscreen of a portable or stationary device 22. To facilitate this process, a touchscreen's output can be broadcast to an independent television screen 27 via Component AV Cables 28, DVI, HDMI or any similar touchscreen-output methodology, either wired or wirelessly.

Dimensions of the body-activated dance and exercise mat variant 20 can be tailored to reflect traditional dance and exercise mats. User-defined input sequences and timing of said sequences, for example, including the duration of square (isolate) actuation, are easily processed by the CPU of the intermediary-transceiver device 24 and/or processor innate to the body-activated dance and exercise mat variant 20, in accordance with any respective itinerary of gaming metrics. Since the present invention may utilize a touchscreen interface 25 with a direct connection (wholly wired) between the touchscreen of a portable or stationary device 22 and the body-activated dance and exercise mat variant 20 or may rely on a wireless broadcasting agent (wireless network) using an intermediary-transceiver device 24 or direct pairing between a portable or stationary device 22, the present invention can empower users with choice between a wired and wireless implementation. In a wholly-wired embodiment not requiring an intermediary-transceiver device 24, as this paragraph suggests above, the controller may essentially be powered by the innate capacitance of a user, thus making it an environmentally-friendly or “green” controller. In alternative embodiments, the CPU need not be physically located within the intermediary-transceiver device 24 and instead can, for example, be located at a remote location and accessed by wireless (or wired) network communication.

In yet another embodiment (not under illustration), a specially-designed, controller-shoe device may also be transitioned, either with the interdependent aid of another device such as a controller mat or autonomously, to a dancing and exercise-driven environment (such as with aerobics) for touchscreens. The controller-shoe device may be equipped with a GPS tracking system, digital compass, electronic pedometer and/or other germane electronics, such as an assembly providing the ability to track traversed and/or positional distances of the controller-shoe device from a position of rest—by interacting with either a body-activated dance and exercise mat variant (in a complementary environment) or floor (in an autonomous environment)—where desired. Along with the ability to track such distances, this system may further yield the ability to discern the duration of aerial transposition (how long the controller-shoe device remains in the air prior to touching back down on the floor or, in complement, the body-activated dance and exercise mat variant) and distances traversed between a succession of a controller-shoe device “touching down”, both helping, for instance, determine an exercise gait in its interaction with an application's gaming metrics.

Furthermore, directional walking and running and related “kick” gestures; such as with certain ball sports, can be tracked by a controller-shoe input device in any serviceable manner and incorporated into a touchscreen-based gaming environment, in the spirit and scope of this discourse. Deriving from a potential motion determinant in FIG. 1, a controller-shoe device may also contain a streamlined plurality of convexed wind-sensors; spatially incorporated to the exterior of the controller shoe or boot (strategically placed to provide the ability to measure all directional gestures; while maintaining foot comfort by preserving an unencumbered interior) and/or any other serviceable tracking-related integrants to task.

Motion-capture systems, the technological process at the heart of much of today's computer animation, may also be adapted to a controller environment of the present invention, this according to an embodiment. By placing reflective balls on the exterior of the controller-shoe device, a plurality of 2-Dimensional cameras can readily pick up the reflective balls motion through measured reflection, which can then be transformed by computer software into 3-Dimensional animation and/or incorporated into a gaming environment by computer-generated integration, superimposition (akin to the way a blue screen works in the film industry) and/or any other serviceable manner to this discourse. Such motion-capture systems, are, of course, not limited to a controller-shoe device environment and can be leveraged to full body embodiments by having a user wear, for instance, a spandex suit with a plurality of reflective balls positioned at the joints, while surrounded by a plurality of 2-Dimensional cameras for tracking purposes. This system provides, amongst other features, the ability to track full-body motion and incorporate a captured gesture or gesture plurality into a gaming and controller environment. Under this controller scenario, gamers may be required to perform simple T-pose and range of motion practices for start-stop and potential-calibration purposes.

FIG. 2A illustrates a wireless dance and dance-step specialty-controller mat variant.

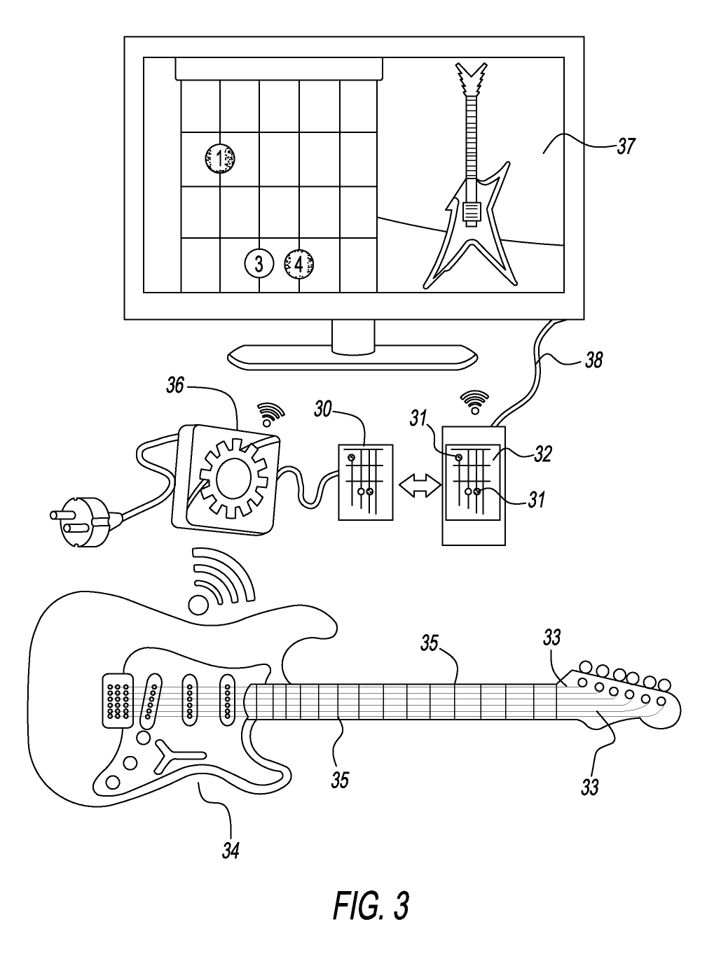

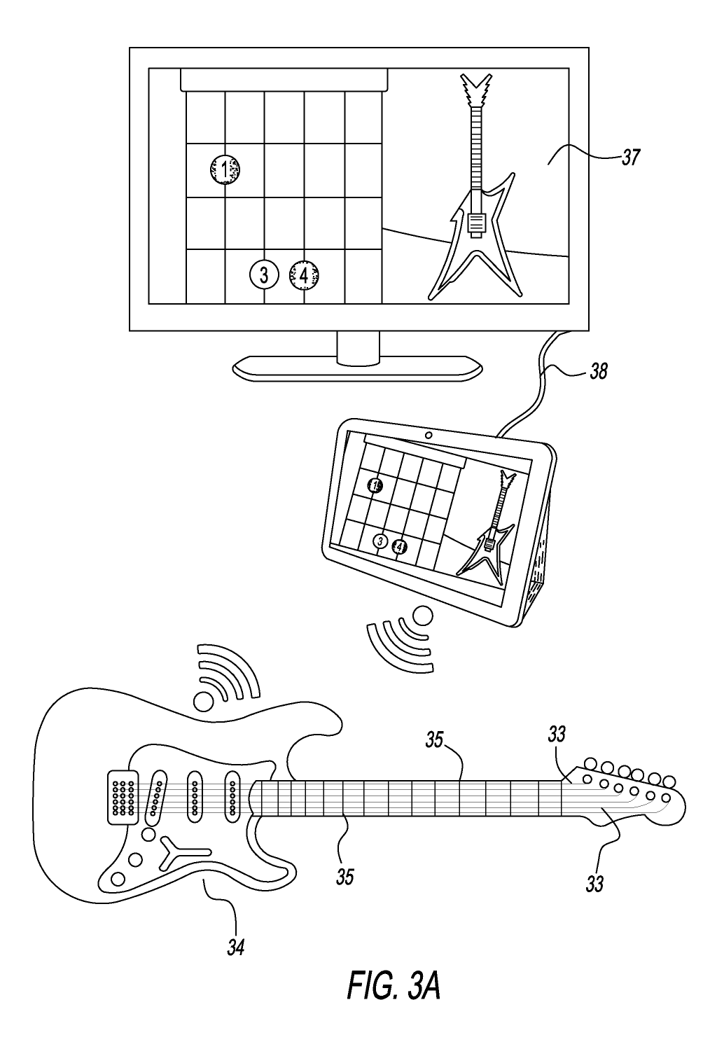

Referring now to the present invention in more detail, according to an embodiment, FIG. 3 is a top view of a guitar interface (outputs capacitance to a touchscreen) and guitar-based, input-controller prop (serves to input capacitance), in accordance with the input dynamics of a touchscreen application. The guitar interface 30 is designed to interact with a rendering of actionable, guitar-based soft buttons 31 displayed on the touchscreen of a portable or stationary device 32. The plurality of guitar strings 33 of a guitar-based, input controller prop 34 run in parallel—with uniformly prescribed spacing—across a plurality of frets 35 situated along the base of the neck of the guitar-based, input controller prop 34. The plurality of frets 35 assume a very salient purpose of comprising the orientation, anchoring and trigger points for a remotely “tethered” guitar interface 30 that is purposefully designed for correlative actuation of an actionable, guitar-based soft button 31 based on the mapped string and fret input (stated in the singular, without the added complexity of explaining mapping in chords).

The guitar-based, input controller prop 34 operates, without suggestion of limitation, on the principle of transferring the innate finger capacitance of a user to a correlative metallic fret by both touching and concurrently depressing a targeted guitar string 33 until positional contact or engagement with a targeted fret occurs. In order to distinctly map the plurality of guitar strings 33 with the plurality of frets 35 and operate under the premise of capacitance transfer to engage and trigger a fret coordinate (x,y) for orientation and remote actuation purposes of the mirrored coordinate (x,y) on a touchscreen, each fret is horizontally divided (not distinguished in the illustration) into a plurality to autonomously accommodate a plurality of guitar strings 33 and a plurality of frets 35 in the task of orientation mapping. As a fret is divided into conductive parts to distinguish a string input, each part of the divided frets, in the totality, is insulated from those adjacent to it in order to prevent conductive bleed. Upon the transfer of user-supplied capacitance to a singular guitar string 33 and then onto its respective, singular fret 35 of the divided plurality upon contactual alignment between the two, it “triggers” a coordinate [divided singular fret(x), string(y)] “switch” that will then faithfully relay the engaged coordinate input to the appropriate guitar-based soft button 31, wirelessly, via an intermediary-transceiver device 36 equipped with a guitar interface 30. The guitar interface 30 of an intermediary-transceiver device 36 comprises a plurality of wired appendages, with their ends serving as actuation nodes upon touchscreen attachment. The intermediary-transceiver device 36 tracks a user input, including a sequence of chords, faithfully. The guitar-based, input controller prop 34 is wirelessly equipped and contains a processor that adeptly tracks and communicates input directives—for the varying fret placement of a user's fingers that may be required during the course of instrument or game play—with the intermediary-transceiver device 36 for targeted actuation. The guitar-based, input controller prop 34 may draw from an internal-power source such as a rechargeable battery (and comes equipped with a recharging interface), rechargeable-battery cartridge or battery pack. An external-power source may also be implemented by design.

The guitar strings 33 are comprised of a conductive material, such as a metallic wire, to simulate the look and feel of a real guitar and to serve as a conductive (capacitance) path input mechanism. Material components not involved in actuating an actionable object can be comprised of various materials and are not required to be conductive in nature. Construction preferences will dictate such selection. While plastics, fibreglass, wood and even metal components outside of an actuating or conductive path, for instance, may be used throughout to simulate prop realism, such component realism is not requisite. Faithfully administering a conductive path initially registered at a “string input” to an “appendage output” in order to actuate a corresponding guitar-based soft button 31, is requisite. Applicable software, such as popular note-streaming video games (that stream musical “notes” down a screen in an assembly-line-like fashion) governing the touchscreen of the portable or stationary device 32, can be designed to work harmoniously with the guitar-based, input controller prop 34. The screen output of a touchscreen of a portable or stationary device 32 can be broadcast to an independent television screen 37 via Component AV Cables 38, DVI, DVI-HDCP, HDMI or similar touchscreen-output methodologies, either wired or wirelessly.

FIG. 3A represents a guitar-based specialty-controller environment of wholly wireless disposition and a serviceable mapping interface.

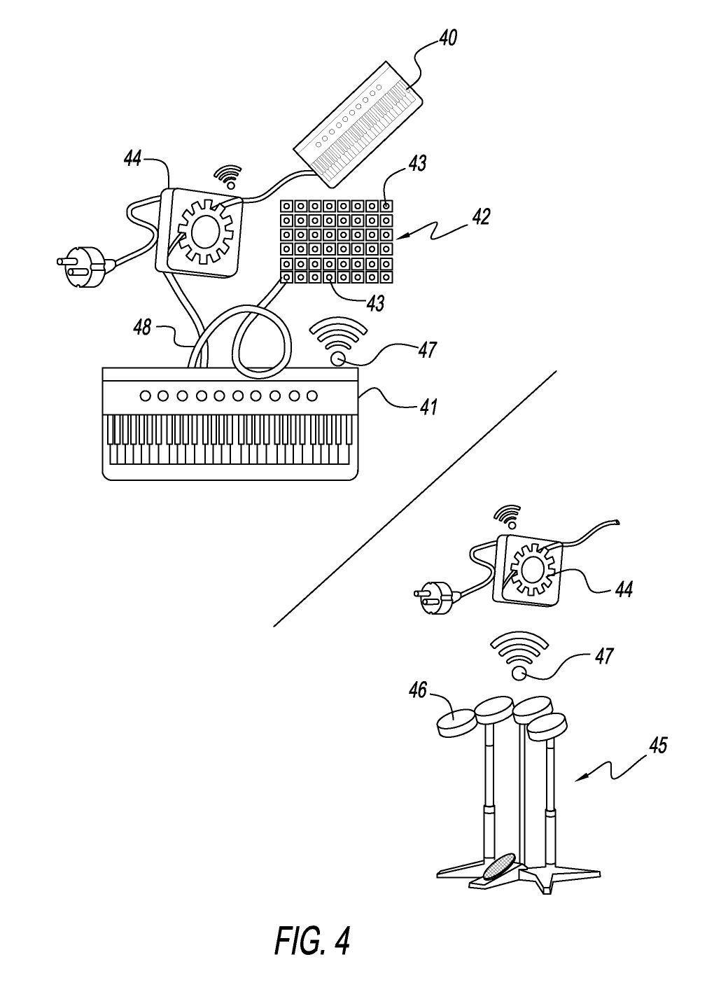

Referring now to the present invention in more detail, when viewed from top-to-bottom, FIG. 4 is a dichotomous view of a musical-keyboard interface (output end) and keyboard-based controller (input end) and drum-set controller (input end) paired with an intermediary-transceiver device, in accordance with the input dynamics of a touchscreen application, this according to an embodiment.

Both the musical-keyboard interface 40, illustrated, and the drum-set interface (not illustrated) serve as an output or actuating mode component (serving as a medium of touchscreen actuation, an “output” mode to a soft-button or soft-button plurality seeking capacitive input) and both the keyboard-based controller 41 and drum-set controller 45 (each understood as serving as a controller or modal input) are designed to faithfully interact with a set of correlative soft-buttons displayed on a touchscreen of a portable or stationary device.

Each key on the keyboard-based controller 41 (input) is insulated from each other to prevent key “bleed” between neighbouring keys and is comprised of an actuating or conductive material that serves to transfer finger capacitance upon key touch—the control input of a finger—to a correlative conductive isolate 43 of a ramifying matrix interface 42; for correlative actuation of a targeted soft button. Capacitance transfer is routed via a wholly-wired tether 48 network extending from the keyboard-based controller 41, in a wired embodiment and via a correlative musical-keyboard interface 40 appendage of the intermediary-transceiver device 44 in a wireless 47 embodiment. The conductive path between each key on the keyboard-based controller 41 and its respective soft-button counterpart, in a wholly wired tether to the screen input, may be maintained by a single—such as with the use of a flexible metallic wire bridging a conductive path in its entirety—or series of conductive medium(s).

Under an operating scenario leveraging a series or plurality of conductive mediums comprising a conductive path, the material composition of which may be different between medium components comprising a collective link (representing the entirety of a conductive path), care is warranted to ensure a conductive path is faithfully preserved in the spirit and scope of this discourse. Said another way, despite the possibility of medium divergence, any medium combinations or elemental compositions constituting a conductive path are designed to ensure a conductive path remains present throughout. Although an intermediary-transceiver device 44 may constitute a component of the conductive path in the spirit and scope of this discourse, it is not essential, as a “wholly wired” controller scenario suggests.

Referring again to the matrix interface 42, leveraging a further degree of familiar terminology to previously filed applications incorporated by reference herein, the matrix interface 42 represents the “exit” point of a correlative conductive path to a point of correlative actuation. Purposefully designed, the matrix interface 42 acts to couple a controller input and a remote, correlative soft-button (seeking input) displayed on a touchscreen. An “exit” point, the point on the matrix interface 42 which acts as a capacitive output to a soft-button input, transmits a reciprocal incidence of input capacitance; capacitance channeled along a conductive path to an “exit” or actuating conclusion, in the spirit and scope of this discourse. Whereas an input gesture X, actuates a remotely displayed soft-button X. The matrix interface 42 is comprised of a plurality of independent conductive isolates 43 or nodules 43 that correspond to a plurality of controller inputs. A matrix interface 42 may be constructed for both a static and toggle environment. The toggle premise is discussed at length in an incorporated plurality of kindred applications and will not be elaborated upon in this embodiment.

Each conductive isolate 43 or output nodule may extend beyond the border of a soft-button (not illustrated) in order to increase the tactile surface area of an input base and/or improve comfort and functional design, while still preserving an actuation path (as described in kindred applications incorporated by reference herein). In building on this premise, by displacing the need for the direct touch input of a finger on a touchscreen, soft-button systems can employ a minimalistic design, thus affording the potential to drastically reduce the touchscreen space occupied by a soft-button controller or physical controller attachment. This, to the great benefit of a game's available or renderable space and where a plurality of attachments are concurrently in place on a touchscreen; especially in pocket-sized operating scenarios. In this light, in leveraging a minimalistic design, a soft-button keyboard in its entirety, for instance, could potentially be fit on the touchscreen at once (and a fully integrated tactile QWERTY keyboard—an integrated input controller—potentially attachable in the space below the touchscreen, if sufficient to task) without the need for a toggle. The premise of minimalistic design only being limited by the ability to isolate soft-buttons from each other and to design an attachable matrix interface 42 where each physical conductive isolate 43 or output nodule is sufficiently isolated from a neighbouring counterpart (via an insulating barrier or gate) to prevent capacitive bleed, and by the respective integration ability between the interface and isolates, in the spirit and scope of this discourse.

As game designs and user devices evolve, technologies such as, but not limited to, NFC (near-field communication) may allow for a transitionary-controller environment where a conductive isolate may be designed to both send (relay) and receive a transmission (a premise for two-way conductive paths) and thus, potentially act as a conduit to more than just traditional capacitance transfer. A conductive isolate may be equipped with a tiny processor, potentially being powered by the light emitted by the touchscreen itself (although this is exemplary and not suggestive of limitation) and possess the ability to process a transmission internally. A conductive isolate may, in an expanded reiteration, possess the ability to receive commands laden with directives either wired or wirelessly or convey information received from the touchscreen device to an intermediary-transceiver or associated input device, citing an example of two-way communicative abilities, according to an embodiment. Future gaming titles may incorporate this two-way communicative ability into a gaming and controller environment.

The keyboard-based controller 41 may be designed to simulate the physical look and tactile feel of an actual musical keyboard, although product design and/or material composition can vary widely between production models (while faithfully retaining the requisite actuating or conductive paths in the spirit and scope of this discourse). This illustration, or any other illustration of this application for the matter at hand, is not suggestive of limitation in its depiction and is not necessarily depicted to scale.

Drums as a modal input 45, may also be incorporated as accessory equipment to the keyboard-based controller 41 unit. In such a controller scenario, a capacitance input is readily registered by touching an independent drum face 46 comprised of a capacitance-friendly material capable of streaming a conductive path in the spirit and scope of this discourse. Each drum face 46 assumes the behaviour of an individual conductive isolate that mobilizes an actuating path in either a wired (with, for instance, each drum face 46—a capacitive input—physically tethered to a correlative output appendage of a drum-based interface, not shown) or wireless 47 environment (through adoption of an intermediary-transceiver device 44).

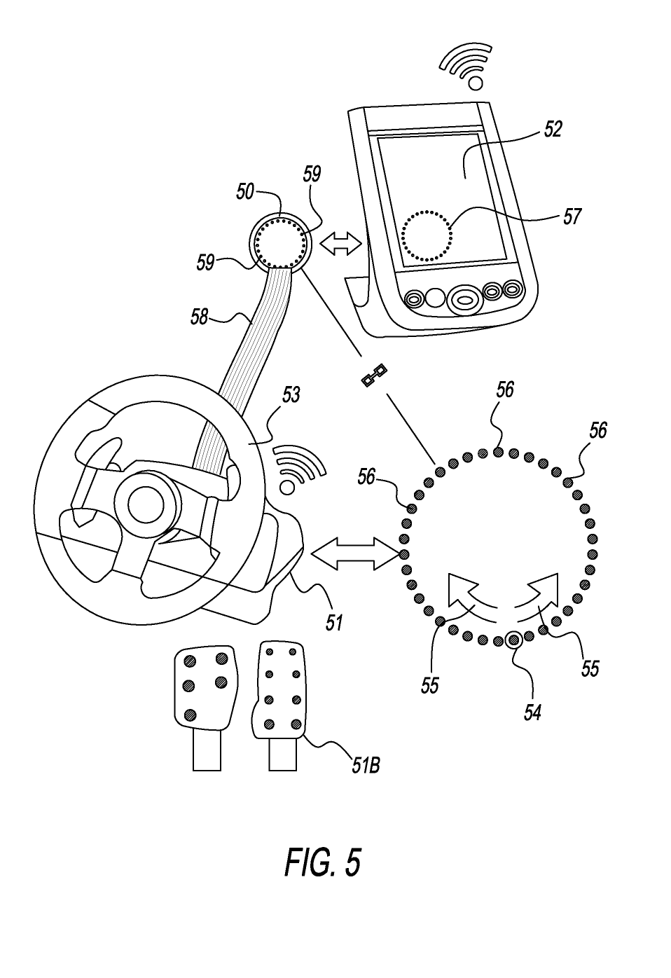

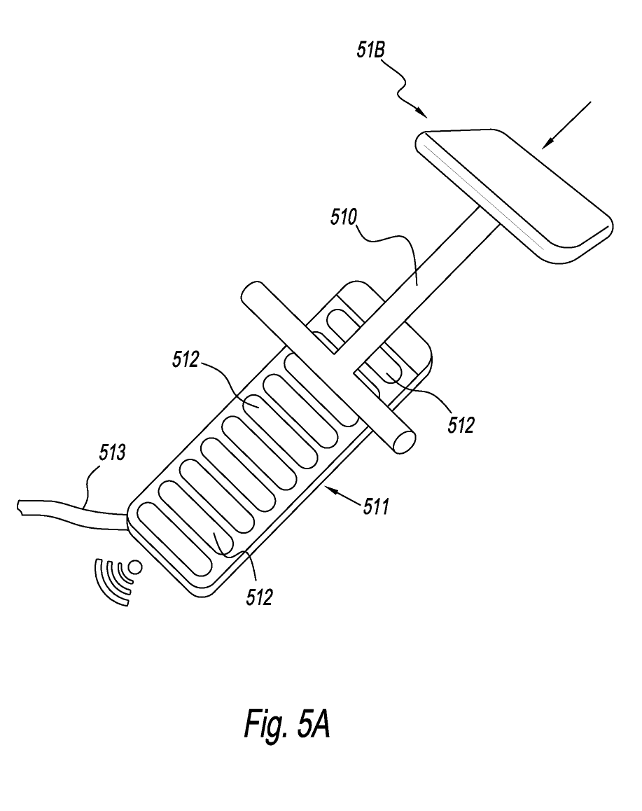

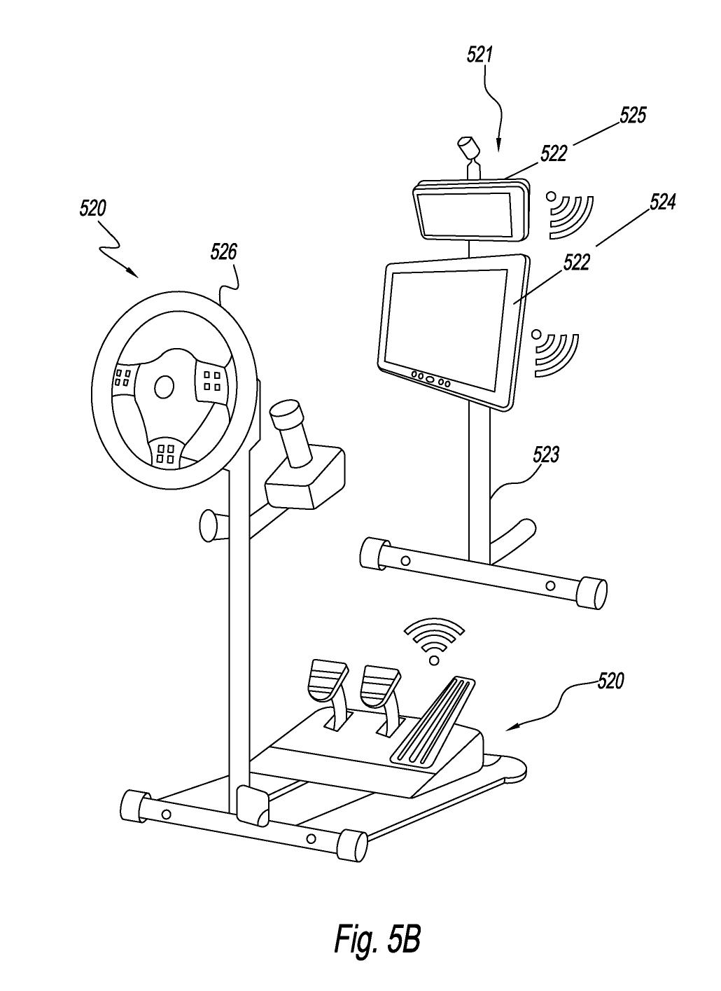

Referring now to the present invention in more detail, FIG. 5 is a top view of an attachable racing-wheel interface (a capacitance output) and racing-wheel controller (a capacitance input), in accordance with the input dynamics of a touchscreen application, this according to an embodiment. The racing-wheel interface 50, is a ramified physical “output” device serving to actuate a correlative soft-button “input”, or input plurality, in accordance with an original controller input gesture or gesture plurality (a capacitive input) occurring at the base of the tether (opposite the racing-wheel interface 50).

Simply stated, a “capacitance input” and “capacitance output” may serve as the beginning and end of a conductive path, respectively, with language serviceable to this discourse. Bridging a “capacitance input” and “capacitance output” together for correlative capacitive discharge to a soft-button target is integral to the present invention. The racing-wheel controller 51 and racing-wheel interface 50 (a capacitive input and capacitive output, respectively), together serve as a linked implement for “streaming” directives (controller input gestures governed by capacitance in this embodiment) to the touchscreen of the portable or stationary device 52, for related actuation.

In a wired environment such as this, a conductive “tether” between an input and output end may be comprised of any actuating or conductive medium, such as, but not limited to, flexible metallic wire, electronic ribbon 58 and/or flexible PCB, including combinatorial assembly, faithful to its premise in the spirit and scope of this discourse.

In a liberating-design stroke against traditional control-functionality limitations, an improved racing-wheel controller design for use with the capacitive touchscreen of a portable or stationary device 52 is introduced. A steering-wheel component 53—acting as a controller (capacitive) input; inciting and comprising a fruitive conductive path—is constructed of a conductive material, such as, but not limited to, a hollow, thin metal alloy or specially-treated conductive foam or plastic, and/or a filler-composition material hybrid, that maintains a serviceable conductive path. The steering-wheel component 53 maintains a conductive path with a rotatable actuating element 54 that faithfully tracks the steering-wheel movement 55 in its entirety, as it tracks across and engages a ring of conductive elements 56 in its path. The ring of conductive elements 56 is located on the underside of the racing-wheel controller 51 hardware. Each member of the ring of conductive elements 56 is individually (reciprocally, autonomously) insulated and tethered, through a wired network located in the electronic ribbon 58, to the inner actuating ring 59 of the racing-wheel interface 50. A soft-button “ring” controller 57 displayed on the touchscreen of a portable or stationary device 52, seeks correlative attachment from the inner actuating ring 59 of the racing-wheel interface 50 for intended actuation, in the spirit and scope of this discourse.

To engage control of an actionable object, the racing-wheel controller 51 sees the actuation process begin with directional contact (steering-wheel movement 55 by the user) of the steering-wheel component 53, thus engaging the rotatable actuating element 54; which then relays capacitance directives “upstream” in the conductive path to the inner actuating ring 59. As a left-turn gesture is initiated by the steering-wheel component 53, for instance, the rotatable actuating element 54 follows a counter-clockwise directional path against a plurality of the ring of conductive elements 56 providing the ability to track the counter-clockwise motion (all motions in the spirit and scope of this discourse) faithfully. The contactual path of the rotatable actuating element 54 against members of the ring of conductive elements 56 expresses motion when processed (and reproduced) collectively in a series. In virtue of the autonomous design—the system of linked “book ends”, that is, the manufactured “tether” from a remote controller input (racing-wheel controller 51) to an inner actuating ring 59 (serving as a touchscreen output or capacitive output)—provides the ability to transmit fluid directional gestures, remotely, to a touchscreen upon proper attachment.

Borrowing from the process of transmitting directional gestures remotely to a touchscreen, in virtue of the autonomous design of the plurality of actuating elements, in the spirit and scope of this discourse, gas-pedal and braking-hardware variants may also be readily adopted to a capacitive touchscreen. The gas-pedal controller 51B, borrowing in expression from the “plying” of an automotive model when depressed, is designed to simulate typical pedal motion for more profound gamine delivery.

Referring to FIG. 5A, in implementing a gas-pedal controller 51B in a touchscreen environment, according to an embodiment, the depression of the pedal directly causes an attached bar, referred to as the scroll bar 510, at the pedal's underside to scroll—the degree of the scroll being reflective of the degree of pedal depression. Therefore, the greater the pedal depression, the greater the degree of scroll that will occur. The scroll bar 510 sits contactually on a surface pad 511, a type of pedial conductor or “conductive mat” in the series, with the surface pad 511 comprising a plurality of actuating elements 512. The scroll bar 510 is capable of traversing the allocated plurality of actuating elements 512 and relaying the scroll-bar 510 motion to a touchscreen interface (the gas-pedal controller interface 513) and ultimately on to a respective soft-button plurality (not illustrated) through the relay and conclusion of a capacitive charge. As expressed above, for greater lucidity, the greater the path distance of the scroll bar 510 across the plurality of actuating elements 512, the greater the speed measurement that is transmitted to a touchscreen's soft-button controller counterpart, in the spirit and scope of this discourse.

Such input gestures (scroll-bar 510 directives, such as a velocity-input metric) can be correlatively relayed to the touchscreen of a portable or stationary device under a conductive “tethering” introduced by the gas-pedal controller interface 513. In leveraging a “tether”, correlative actuation is realized upon the faithful distribution of a capacitive input, via an appendage, to the respective tier of a “power-bar” soft-button controller system being utilized in this exemplary discourse (refer also to FIG. 1 and FIG. 6C for related references). Thus, in building again on the example above as to how a variable degree of acceleration is transmitted to the touchscreen: the further the pedal is pressed, the greater the distance that is traversed by the scroll-bar 510 and, subsequently, the higher the soft-button tier on the “power-bar” that is actuated (to account for the greater speed measurement), respectively. The “power-bar” soft-button system comprises a plurality of tiers; a diverse mapping of tiers to account for the potential diversity in positional scroll-bar 510 directives (pedal-gesture inputs) transmitted, in the spirit and scope of this discourse.

A foot-activated, gas-pedal controller 51B and similarly constructed brake-controller (the latter is not illustrated), along with any associated conductive paths in a wholly-wired embodiment, are comprised of a conductive material faithful to an actuating path. Depending on the thickness and material of the socks worn by a user, pedial capacitance transfer may not be engaged accordingly and a user may therefore be required to wear specially-designed thin socks and footwear (such as a “controller skin”) that are capacitance friendly, or play barefoot for gaming systems requiring user-supplied pedial capacitance. Removing pedial or foot pressure from a gas-pedal controller (or a brake-controller offspring) causes the controller to return to a position of rest and any active speed transmission to be “dialed down” accordingly.

FIG. 5B illustrates a wireless racing-wheel controller 520 and coalescent audio/visual assembly 521 designed for use in a race-themed environment for touchscreen user devices 524, 525, this according to an embodiment. The coalescent audio/visual assembly 521 of a racing-wheel controller 520 system comprises a vertical and centrally-mounted suspension arm 523 with mounting assembly designed to securely suspend a plurality of touchscreen user devices such as a tablet 524 and concomitant mobile device 525 (such as a smaller or pocket-sized mobile device without suggesting limitation in the assembly of touchscreen user devices) in a manner such that the visual-display component of a tablet device 524—of course, having the larger screen versus its mobile smartphone brethren 525—is mounted proximally to a user's natural field-of-view (the tablet device 524 placed according to a vantage that acts, in some positional degree, to “mimic” a driver's “windshield” view) during engagement of the racing-wheel controller 520. In an area just above the clearance of the top of the tablet device 524, as the drawing suggests, the suspension arm 523 is further extended to provide suspension and support for a smaller mobile device 525, such as a smartphone, in manner that “mimics” the involvement of a “physical” rear-view mirror in a game environment.

Each of the racing-wheel controller 520, tablet 524 and smartphone device 525 can be wirelessly equipped to interchangeably transmit and receive integrative directives, in association with each other, in a harmony of controller input and virtual rendering. Whereas both touchscreen user devices 524, 525 are equipped for wireless engagement, it is important to underscore that each touchscreen user device 524, 525 may concurrently receive unique broadcast directives from the racing-wheel controller 520 and/or complementary touchscreen user device 524, 525 during the course of game-play. For events such as, to cite but one example, when a tire is blown out and the shredded rubber is ejected onto a race circuit and rolls out of view from the rear, the potential for independent, concurrent and synchronized use of a plurality of display devices in concinnity may serve to resoundingly heighten the gaming experience. In this way, as the centrally-mounted tablet 524 provides rendering in real-time of a forward-looking orientation, the supported smaller smart device 525 provides for a “rear-view” orientation, with perspective (and rendering producing that perspective) more akin to a real-world environment. Thus, without suggestion of limitation, any corresponding touchscreen-related software geared towards a race-themed environment may be programmed to articulate two distinct views in an evolving manner as set forth in the present example: the front view or tablet view 524 (the road ahead) and the rear view or smartphone view 525 (showing cars fast approaching from behind, for instance).

Given the tablet device 524 may act as the master device—e.g. the device primarily controlling the race-themed app or application, at least according to an embodiment—it may thus be wirelessly linked and responsible for transmitting primary directives (for instance, integral game-based dynamics) to the smaller smart device 525, in matters such as transmitting content for digital rendering on the “rear-view mirror's” delineatory views associated with the smaller mobile (second) device 525. A smaller mobile device 525 may also have the identical gaming software (e.g. a race-themed app) concurrently synched and operational for more thematic independence, although such an arrangement is not intended to be suggestive of limitation. As a user swivels the smaller mobile device 525 (attempting to reposition the rear-view mirror), leveraging the gyroscope sensor, for instance, the smaller mobile device 525 communicatively alerts the positional change to the primary tablet 524 device by wireless exchange, leading the primary tablet 524 device to transmit an adjustment or update to the field of view on the “rear-yew” mirror, accordingly. Said adjustment in the field of view is permitted to occur in real-time by virtue of instantly updated directives sent to and from the smaller mobile device 525 for related processing (hardware and software based).

The wirelessly equipped racing-wheel controller 520 may comprise a processor and micro-controller system that, amongst other capabilities, is capable of tracking directional racing-wheel motion for immediate communicable relay to the primary user device, or tablet 524, the smaller mobile device 525, where applicable, or both concurrently under certain operating conditions, this according to an embodiment. This results in the potential for direct, real-time integration into rendered game-play. The racing-wheel controller 520 may be powered by a voltage source or a current source. The racing-wheel controller 520 in this exemplary discourse does not rely on the influence of user-supplied capacitance traditionally associated with a touchscreen controller input (that is, a user-supplied capacitive input is not integral to the operability of a racing-wheel controller 520 input accordingly), however, in alternative embodiments, a racing-wheel controller 520 input may be reliant on the capacitive input of a user.

The racing wheel 526 of the racing-wheel controller 520 may be designed, for instance, to be fluently integrated, accounting for a full-range of motion entitlement, to a traditional soft-button input system of a touchscreen according to a prescribed-mapping infrastructure (representing the pairing or actionable correlation between a positional deployment of a physical controller input on the specialty-wheel controller and a corresponding soft-button input) or calibration previously advanced or the game being played on the touchscreen-user device may offer users extended functionality beyond what a native touchscreen-input system offers (certain, advanced features only available to users that select a physical-controller system, such as this, as a modal input in lieu of a traditional soft-button interface; users may be presented with controller options prior to game commencement). Said another way, according to this exemplary discourse, this option may yield a degree of advanced directional input to a user that may not otherwise be possible and/or inclined under the exclusive use of a traditional soft-controller or soft-input interface governed by the control input of a finger. Such controller designs as this specialty controller, for example, may change the way a developer programs a game for controllability, introducing a paradigm shift in thinking beyond the simple, yet traditional control-input-of-a-finger status of operability and may serve to both broaden the reach of a gaming audience and the software repository of gaming titles available to end users.

For possible attachment interjection in an associated controller environment, the reader may refer to FIGS. 5 and 5A and the related teachings of an attachable capacitive-discharge assembly and/or an intermediary-transceiver device with attachable capacitive-discharge assembly, the assembly of which may be introduced in divergent operating scenarios to this controller embodiment. The capacitive-discharge assembly/overlay may, for example, stem from the racing-wheel controller 520 through a ramifying interface; operating under the ascendency of an internal capacitive-management and distribution system (and/or by a capacitive charge supplied by a user) in accordance with an ancillary controller environment (not the subject of illustration in FIG. 5B).

Referring now to the present invention in more detail, FIG. 6A is a perspective view of a hockey-stick controller prop, plurality of controller mats and the base (faithful to the correlative-attachment principles of previous discourse, although not shown in full) of a ramifying pedial-input and prop-gesture controller interface, in accordance with the input dynamics of a touchscreen application, this according to an embodiment. Such interfaces comprise a network of connecting appendages designed to transmit a capacitive charge to a touchscreen. Designed to immerse users into a highly-interactive experience, this embodiment involves the use of both an engaging orientation and pedial-input determinant controller mat 60 and an engaging orientation and prop-gesture input determinant controller mat 61. A hockey-stick controller prop 62 is a type of “activity controller” or a controller input that is reliant on the associative activity of its users.

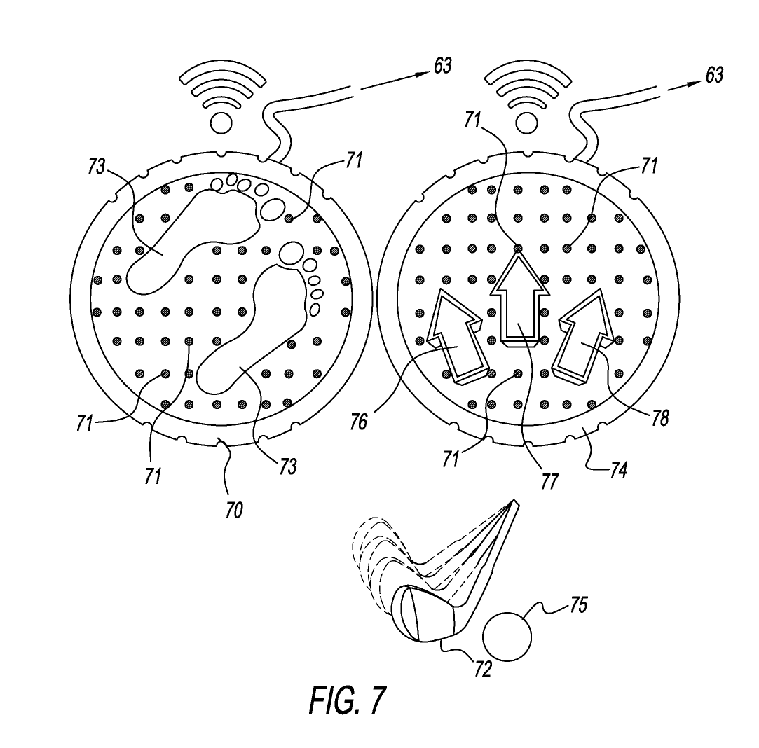

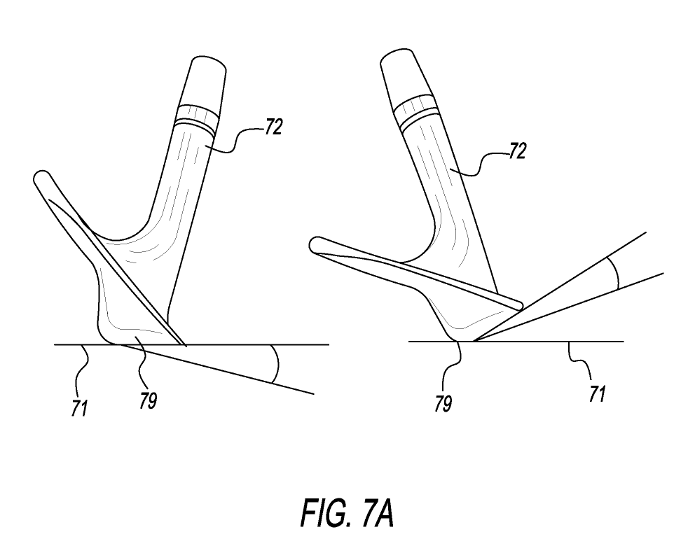

The engaging orientation and pedial-input determinant controller mat 60 contains a plurality of densely-arranged, autonomous sensing elements—insulated from competing sensing elements—designed to cooperatively monitor the positioning, orientation and/or activity of a user's feet 67 upon patterns of capacitive actuation of the sensing elements. The more dense the pattern of autonomous sensing elements, the more precise the orientation and activity can be determined. Similarly, the engaging orientation and prop-gesture input determinant controller mat 61 also contains a plurality of densely-arranged, autonomous sensing elements—insulated from competing sensing elements—designed to cooperatively monitor the positioning, orientation and/or directional propensity (64, 65, 66), amongst other discernments, of a hockey-stick controller prop 62 upon patterns of capacitive actuation of the sensing elements. A hockey-stick controller prop 62 serves to extend the capacitive path or user-supplied capacitance of a hand input (initiated by user clutching) to a controller mat or mat plurality for related capacitive actuation of the sensing elements. See FIG. 7 for related operation methodologies and discussion depth.

The present embodiment offers broad controller-input potential, beyond, exempli gratia, a potential for cadence and/or step articulation of walking and running gestures. Mindful of this, motions simulating skating gestures, amongst a broad swath of possibilities, can be deftly registered by the plurality of densely-arranged, autonomous sensing elements comprising the orientation and pedial-input determinant controller mat 60. As the user's feet “glide” over the plurality of densely-arranged, autonomous sensing elements in a manner characterized by skating gestures, a pattern of pedial capacitance can be discerned and, according to a wired embodiment, faithfully transmitted across a network of conductive appendages for related touchscreen actuation with appendage attachment. In a forward-motion, for example, a plurality of densely-arranged, autonomous sensing elements is subjected to pedial manipulation occurring in the spirit of an upwardly-swiping motion. Directional actuation is reproduced on a touchscreen soft-button assembly, as per the bearing of an input registration. In wireless implementations, a controller mat may be designed for operation on a revolving mechanism, similar to operation of a tread mill, as another method of measuring such metrics as a walking and/or running gait; in a more physically-demanding environment.

Calculations as to how fast the hockey-stick controller prop 62 travels across a plurality of densely-arranged, autonomous sensing elements on a determinant-controller mat—and its respective path and contactual angulation (at the blade underside) against this plurality—can yield both speed and stick-angle placement (aiding to discern shot selection, direction) measurements, amongst other potential metrics, and be suitably incorporated into a gaming environment.

Borrowing from the discourse of FIG. 1, a hockey-stick controller prop 62 may work beyond simple capacitance transfer to a controller mat (as a means of controller input or the process of controlling an actionable object) and instead (or in addendum) borrow from the controller metrics of a motion-input or gesture-sensing controller device; where the controller itself may act independently to sense and relay a motion input or motion-input plurality to a remote device. Each incarnation described may comprise a built-in gamepad controller for added versatility—providing, for example, the ability to control actionable objects on a touchscreen not affected by a hockey mat or gesture-sensing controller device. Amongst a much broader list of capabilities, a gamepad controller may be used to enter a user name, select a team and/or divine shot selection.

Orientation measures can also be calculated using such equipment as an “orientation belt” equipped with GPS navigation capabilities in reference to an orientation point Similar adaptation can, of course, be made to any wearable controller (refer to FIGS. 2,8 for related discourse) designed to act as controllers themselves. Orientation can also be registered using weight-sensing technologies in a controller mat and voice-activation, such as a user saying “forward”, “pass” or “slap shot to goal”, amongst other means.

Referring now to the present invention in more detail, FIG. 6B is a detailed view of the attachment (or connectivity) apparatus for a pedial-input and prop-gesture controller interface, first alluded to in FIG. 6A, this according to an embodiment. The pedial-input and prop-gesture controller mat interfaces 63 serve to correlatively link a plurality of densely-arranged, autonomous sensing elements—acting as conductive elements of a controller input on both the orientation and pedial-input determinant controller mat 60 and orientation and prop-gesture input determinant controller mat 61—with a reciprocal mapping of a plurality of autonomous soft-buttons 600 on the touchscreen of a portable or stationary device 601, for intended actuation. The pedial-input and prop-gesture controller mat interfaces 63 contain a customized matrix—harmonizing an input and output dynamic through correlative transmission of a capacitive charge to a touchscreen—such as an attachable matrix “disc” 68.

For correlative actuation in a wired embodiment, each autonomous member of the plurality of densely-arranged, autonomous sensing elements comprising both the orientation and pedial-input determinant controller mat 60 and orientation and prop-gesture input determinant controller mat 61 has its conductive path extended remotely via an unobtrusive wiring scheme such as a controller-mat interface 63 with an attachable matrix “disc” 68. The attachable matrix “disc” 68 sees respective attachment to a soft-button assembly 600 on the touchscreen of a portable or stationary device 601. Without suggestion of limitation, the controller-mat interface 63 with an attachable matrix “disc” 68 may be comprised of a flexible, printed-circuit board (that may be similar in appearance to that of the e-ink, “paper phones”) with attachable conductive nodes, a channeled wire plurality and/or by melding a matrix “disc” 68 with an electronic ribbon extension, in any serviceable manner, to reduce potential wire clutter. Regardless of a matrix-“disc's” 68 assembly, it may be attachable to a touchscreen in any manner serviceable to this application, such as, but not limited to, suction, static and/or removable adhesive backing.

The attachable matrix “disc” 68 sees the conductive path of each respective conductive isolate 69 on the attachable matrix “disc” 68 “channeled down” or extended to a correlative controller input—via an integrated wiring scheme stemming from an “electronic ribbon” or similarly-based conduit, which routes each conductive isolate 69 in the attachable matrix “disc” 68. Under this embodiment, a conductive path can be extended from each respective conductive isolate 69 on an attachable matrix “disc” 68 to both an orientation and pedial-input determinant controller mat 60 and/or an orientation and prop-gesture input determinant controller mat 61; as an example.

Positional highlights A1, A2, A3, A4, A5 and so forth notated on an orientation and pedial-input determinant controller mat 60 and/or an orientation and prop-gesture input determinant controller mat 61 and positional highlights A1, A2, A3, A4, A5 and so forth notated on each conductive isolate 69 of an attachable matrix “disc” 68 (only the rightmost matrix “disc” 68 contains actual positional labelling) are brought into accord via an unobtrusive wiring scheme. Wired inter-connectivity channeled through a conduit is an efficient method of extending a capacitive-based conductive path, in the spirit and scope of this discourse. The fundamentals of a capacitive-based conductive path are further discussed in a plurality of kindred applications under common ownership of the inventor (whom also acts as the primary author in each) noted on page one of this application and are incorporated by reference, in their entirety, herein. Such language is not intended as being limitative in nature and any manner appropriate to effecting and/or extending a conductive path, in the spirit and scope of this discourse, is serviceable to this application.

In a wireless variant, according to an embodiment, an integrated and unobtrusive wiring scheme may act as attachable appendages from an intermediary-transceiver device (see related discussions in FIG. 11) in the management of a plurality of conductive paths for correlative capacitive discharge. The intermediary-transceiver device may also contain a slot (or slot plurality) that, for instance, readily accepts flexible “electronic ribbon” (or related connective assemblies) for “routing” or “distribution” of a capacitive stream for correlative actuation of an autonomous soft-button or soft-button plurality.

An identical mapping of a plurality of autonomous soft-buttons on the touchscreen of a portable or stationary device to a plurality of densely-arranged, autonomous sensing elements of a controller input is not requisite in a controller environment. Patterns of input from a controller input device, for example, may be translated to a custom, soft-button interface, such as a “power-meter” or “power-bar” system (refer to FIG. 6C for related discourse). As a controller input is manipulated or interpreted for manipulation by an integral processor in the series, it provides a platform for custom actuation in a control scenario.

According to an embodiment, FIG. 6C illustrates a soft-button “power-bar” or “power-meter” system of custom actuation; a robust system that may be introduced to a touchscreen-controller environment to empower users with added control-disposition and breadth. A soft-button “power-bar” or “power-meter” system is designed to measure and relate a varying degree of control input for a more precise and dimensional controller environment. Slapshots, for instance, can vary widely in speed profiles based on varying inputs such as the amount of exerted force, stick velocity and “sweet-spot” delivery (impact location of stick and puck), all of which can be potentially tracked and injected into a gaming environment, in the spirit and scope of this discourse. For example: upon input delivery of a high-speed slapshot, the shot will see registration in the upper “power-meter” ranges, which precise upper tier is assigned will depend on the value assigned to it by a processor computing an input variance. This value, when contrasted with a predetermined list, preciously narrows the tier down to one.

Translation of the assigned value to the touchscreen sees actuation of the precise soft-button tier in the digitally-rendered “power-meter” associated to the gesture, as allotted. In this way, “generic slapshots” or slapshots hemmed into a fixed metric regardless of disposition, may be “benched” for the layered-control disposition that this system brings to a gaming environment. Control of on-screen, actionable objects are premised by an accordant variable input, with gaming software and/or accordant hardware designed for controller interaction under “gradient-controller scenarios”.

Assuming a controller design that is built to detect and actuate a slapshot classified within a range of ten (10) possible power levels or classes, a soft-button “power-bar” 160 rendering (10-tiers) is illustrated; and accommodated by an intermediary-transceiver device 162 with a “power-bar” interface 161. For clarity in attachment delineation, position X1 on the “power-bar” interface 161 is attached, through any serviceable means, to the X1 position on the soft-button “power-bar” 160 rendering, then X2 is tethered in the same manner, and so forth, until each soft-button of the soft-button “power-bar” 160 is accounted for. The intermediary-transceiver device 162 receives controller input directives, wirelessly 164 according to an embodiment, and then leverages an innate capacitive source, capacitive manager and appendage interface to faithfully reproduce an input sequence for actuation by directly (and correlatively) engaging the respective tier or tier-plurality of a soft-button “power-bar” 160 rendering depicted on the touchscreen of a portable or stationary device 163. Completion of a conductive path ensues the transfer of a capacitive charge to the targeted tier.

The “power bar” or “power meter” is a highly customizable agent and any related discourse offered is merely exemplary and not suggestive of limitation. The “power bar” or “power meter” illustrated here can be leveraged by a concurrent plurality (that need not be identical) of custom-actuation themes serviceable to this discourse, discourse traversing well beyond this example of slapshot disposition.

Referring now to the present invention in more detail, FIG. 7 is a perspective view of a conductive, golf-club prop; capable of effecting a requisite conductive path upon the capacitive-clutch input and mat-based gesturing of a user and a plurality of orientation and gesture-input determinant mats—both a foot zone and a swing zone—in accordance with the input dynamics of a touchscreen application, this according to an embodiment. Akin to the methodology and system discussed in FIG. 6A, a user's feet orientation and shot “line” can be similarly gauged in a golf context. A general stance may be determined when the user places both feet on a specially-designed “foot zone” 70; which tracks a user's pedial input. The foot-zone 70 controller mat is comprised of densely-arranged, autonomous sensing elements 71—independent in nature, that is, insulated from competing elements—and situated at the face of a foot-zone 70 controller mat for facile pedial input.

As a plurality of the densely-arranged, autonomous sensing elements 71 are engaged by pedial manipulation (with the pedial input supplying a requisite capacitive “charge”), interpolating tracking software calculates the relative positioning and orientation of a user's feet (a foot stance) 73, thereby ascertaining an approximate stance that can be “plugged” into a gaming environment. Moreover, a lightweight, conductive, golf-club controller prop 72 (“charged” with the hand capacitance of a user's grip) can be correspondingly tracked as the head of the golf-club controller prop 72 comes into contact with, and transfers a conductive path to, a plurality of densely-arranged, autonomous-sensing elements 71 of the “swing zone” 74. Related soft-button actuation or engagement (stated in the singular expression for simplification) is initiated at a controller input and concludes “upstream” with the completion of a conductive path, upon actuation, at the touchscreen of a portable or stationary device.

The swing zone 74 controller mat represents a measured plurality of densely arranged, autonomous-sensing elements 71 and tracks a golf-club controller prop 72 input. Left and right-handed golf swings are easily accounted for as both the swing zone 74 and foot zone 70 may be made interchangeable with a simple software selection. Calculations as to how fast the golf-club controller prop 72 travels across the swing zone 74, for instance, can help determine a gesture's speed (and therefore, estimated drive distance) and the actuating path or pattern of actuation across the swing zone 74 (specifically, the pattern of densely-arranged, autonomous-sensing elements 71 engaged by the capacitance-bearing club head) may further yield a determination of club angle, direction and stroke “trajectory” (in a straight forward direction 77 or if the “ball” or lightweight, treated foam-ball prop 75 is “shanked” by an unintentionally-crooked swing, as possibly illustrated under 76, 78 in certain playing scenarios, exempli gratia).

As indicated in FIG. 7A, a golf-club controller prop 72 may contain an asymmetrical surface at the head's underside 79 that, depending on club angle, traverses across the plurality of densely-arranged, autonomous sensing elements 71 in a variable manner, subject to calculation. The club lie to the left suggests the head's underside 79 sees its base relatively flat as its is swung across the plurality of densely-arranged, autonomous sensing elements 71 of the controller mat. In contrast, the club lie to the right suggests an angled base at the head's underside 79 with only the basal tip (leftmost) contacting the plurality of densely-arranged, autonomous sensing elements 71 in the motion of swinging. The left may be considered to be more of a direct hit for a longer projection and the right having a higher-degree of ball loft and thus, less distance. The plurality of densely-arranged, autonomous sensing elements 71 can readily ascertain differences between the two stances based on the amount of surface space occupied by the traversal of the head's underside 79. Such traverse variation can be incorporated in a gaming environment to determine, without suggestion of limitation, club angle, as alluded to above.

While this description is based on the engagement and extension of conductive path based on a contained wiring scheme, rooted from the controller mat's underside, that is initialized and traversed by the innate capacitance of a user (making it a type of “human-powered controller”) without enlisting the engagement of an intermediary-transceiver device in the “conductive-path's chain”, an embodiment of the present invention may opt for using an intermediary-transceiver device, in the spirit and scope of this discourse. Wireless, hybrid representations and/or the direct interaction of an input device (controller mat) with a user device, among any of the serviceable communicative technologies, may be used.

A breadth and course of calculations are highly customizable and may vary based on the influence of game conditions and may be as specific as, for instance, contrasting a foot stance 73 with directional swings 76, 77, 78 to help determine if a lightweight, treated foam-ball prop 75 was “shanked” or a shot was simply directional. The golf-club controller prop 72 may comprise a head face that contains a plurality of conductive elements (each assigned independently with a differing actuation path relayed, exempli gratia, for contact with a central conductive-element range representing the “sweet spot”) for more precise measurement of “ball” contact, as a further method of determining if a lightweight, treated foam-ball prop 75 was hit cleanly or was “shanked”. To that purpose, any serviceable sensor can be used, well beyond the cited example.

Termed a variable-capacitance head (with sweet spot), for discussion purposes, although not illustrated, the golf-club controller prop 72 with variable-capacitance head is wirelessly equipped to relay directives to an intermediary-transceiver device (also not illustrated) for related actuation. Surfaces of the swing zone 74 may be flat or can be altered (through, for instance, an interchangeable-terrain accessory or stratum placed over the swing zone 74) for differing club selection and differing terrain—such as, but not limited to, the incorporation of conductively treated “actuating turf” that is comparable to “the rough”; turf fully capable of remaining faithful to a conductive path and transmitting user capacitance “upstream”. An optional lightweight, treated foam-ball prop 75 may, of course, be incorporated into a gaming environment for added tracking metrics and realism, if so desired.

The golf-club controller prop 72 may contain a separate gamepad controller for additional input ability, such as a premise whereby a user is prompted with an on-screen instruction on club selection (for example, a user may choose from a choice of: iron, wood, putter or a numerical club annotation), choice of difficulty level, course selection, adding a user name or electing a namesake from a list of professionals, et cetera. The swing zone 74 and foot zone 70 could also be used to respond to an onscreen prompt by, for example, dragging a foot or club prop in an upward or downward direction to scroll on the screen and then tapping a foot or club prop to make the desired selection.

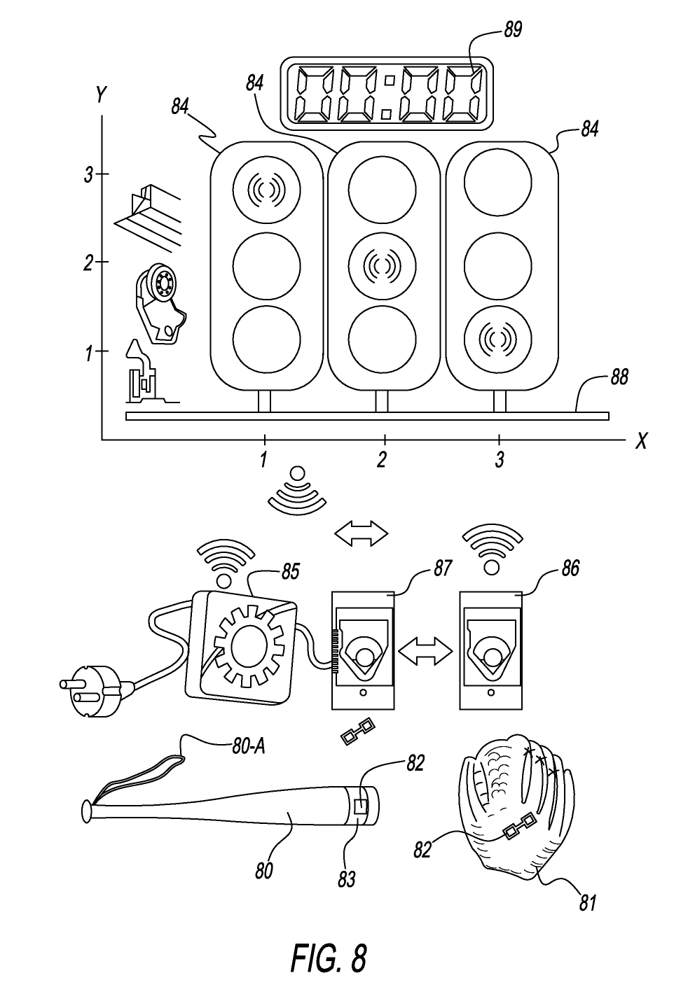

Referring now to the present invention in more detail, FIG. 8 is a perspective view of a baseball-bat and baseball-glove controller prop; designed to interact with a beam-casting tower and intermediary-transceiver device, in congruence with the input dynamics of a touchscreen application. The intermediary-transceiver device comprises a connected controller interface or interface plurality, this related discourse is according to an embodiment.

In preliminary discourse, an understanding as to how the beam-casting tower interacts with the touchscreen device is fundamental to the incarnation. A plurality of serviceable systems of interaction are proposed here, although this exemplary discourse is not suggestive of limitation. One such implementation is by turning the tablet, smart phone, or other user device in the “interactive series” into a remote control unit capable of interaction with the beam-casting tower. As a game is being rendered on the touchscreen, for instance, the tablet, smart phone, or other user device may concurrently broadcast (via remote control, in real time) directives to a compatibly equipped beam-casting tower for implementation of the received directives into a gaming environment. If, for example, a timer is set to start elapsing on a touchscreen, a rapidly broadcast directive to the beam-casting tower may occur just prior to its start in order to initialize and commence, synchronously, the tower countdown with the touchscreen countdown. This system may require use of a hardware dongle (an infrared emitter) to convert any electrical signals, broadcast by the user device, into infrared signals that can be understood by the beam-casting tower. A stand-alone hardware gateway could also be incorporated without use of a dongle, which is capable of receiving electrical control signals in wi-fi or Bluetooth format and then converting them into infrared before being broadcast remotely.

An alternate means would be syncing the user device and/or game app with the beam-casting hardware for potential two-way communication of directives via any serviceable form (such as Bluetooth or wi-fi) during game play. Furthermore, beam-casting hardware may be synced to a computer to work collaboratively with the component series in any administration of directives. Other such implementations may include integration of an intermediary-transceiver device in the “interactive series” (that may also perform such duties interchangeably) and/or synching, in a series plurality, a user device and computer or user device and computer plurality directly in a touchscreen environment for the administration of directives, where desired. A user device and computer in sync, for example, can be fodder for the introduction of a multi-player environment to the touchscreen. A user device such as a smart device may be synced with an additional user device or user device plurality in a proximate space or via remote location over the internet, in the spirit and scope of this discourse.

Designed to immerse users into a highly-interactive experience, both the baseball-bat controller prop 80 (effecting an input gesture) with strap and baseball-glove controller prop 81 (effecting an input gesture) play active controller roles for both sides of the “field”, respectively, during the course of game play. Unlike motion controllers discussed heretofore, the baseball-bat controller prop 80 and baseball-glove controller prop 81 rely on, as an example without suggestion of limitation, an imbedded, fully panoptic light sensor 82—amidst, at least from the baseball-bat controller prop 80 perspective, specially-designed, panoramic housing 83, or in the form of an internally-cast ring 83, situated in the upper half of the baseball-bat controller prop 80—for motion determination. Such strategic, panoptic light-sensor 82 placement helps minimize the risk of unintentional hand blockage upon prop grippage. In this way, the transfer of capacitance from the user to the baseball-bat controller prop is not integral to motion determination, by design (although hybrid implementations could be used, where desired).

Unlike the play scenario noted with the capacitance-governed, golf-club controller prop advancing a conductive path upon contact with elements of the “swing-zone” and the respective motion determinant abilities described, in this disclosure the imbedded, fully panoptic light sensor 82 is designed to sense or register a projected light beam from a remote casting tower 84. Upon an incidence of a light path directly “locked” between the two components, either the remote casting tower 84 or baseball-bat controller prop 80 (in a “minimalism” electronic footprint) relay directives to an intermediary-transceiver device 85, wirelessly, under certain operating scenarios. The intermediary-transceiver device 85 then, in a manner faithful to directives calculated from an active controller-input prop (or a remote casting tower 84, the discretion of which implementation is design dependent), relays any registered controller directives and motion determinants ascertained during the course of game play to a predetermined set of correlative soft-buttons located on the touchscreen of a portable or stationary device 86 for actuation, via a baseball-screen interface 87, in the spirit and scope of this discourse.

Under this exemplary operating scenario, a remote casting tower 84, as part of a tower plurality, contains a plurality of stacked lights vertically integrated into the tower and is transposably mounted on an adjustable floor track 88; permitting fluent horizontal motion of the tower plurality along the adjustable floor track 88. The stacked lights are designed to simulate a ball's “motion”. Using a tower with three-stacked lights (resembling a traffic light), for instance, when a simulated pitch is thrown, a line (or, illumination at the light source for invisible light paths) may appear in any of the three light paths. In exemplification, for a high fast ball, for description simplicity, a remote casting tower 84 projects a light at the top light bulb to distinguish and alert the user of the “balls'” “high” position currently, in its vertical orientation.

Accompanying a remote casting tower 84, as part of a tower plurality, is also a timer 89, that projects to a user the simulated “speed” of the ball in “flight”. Therefore, in continuance of the fast ball example, a timer of 2 seconds is set for this particular play. For the user to position himself or herself accordingly, he or she will be required to stand proximately to the correct remote casting tower 84 (the one under current illumination in the plurality) with the baseball-bat controller prop 80 (a controller input) clutched and prepare to align the imbedded, fully panoptic light sensor 82 of the baseball-bat controller prop 80 with the correct level of the illuminated light, in this case at the high (X1, Y3) position. The user will then swing the baseball-bat controller prop at approximately 2 seconds into the timer's countdown, once the counter starts, or at a reading of zero (with the processor allowing for a predetermined margin of error; such predetermination may be linked to skill-level selection or other variant criteria, as a non-limitative example). When a remote casting tower 84 communicates its light path with the tip of the bat containing the imbedded, fully panoptic light sensor 82 (subjected in the light's path), upon countdown to zero+/−a margin of error, it registers as a hit and the positioning and timing, amongst other potential variables, of the bat swing, will assist in determining the hit's efficacy upon articulated calculation. An agent that detects bat or swing speed could, for instance, also be incorporated in the collaborative series to determine and/or distinguish a swing metric; such as a bunt versus an aggressive swing.

The embedded, fully panoptic light sensor 82 may work in association with a plurality of like sensors in the baseball-bat controller prop 80; with a primary panoptic light sensor representing a bat's “sweet spot” and an engagement of others similarly situated above and below said sweet spot, detracting from the quality of a hit, as measured. This type of sensor-plurality distinction, may improve batting realism, under pitch scenarios that, for example, show a dramatic curve occurring. The batter may correctly line up the baseball-bat controller prop 80 with a light or serviceable beam broadcast in a vertical line, but not so horizontally, as a “ball” shifts, thus potentially engaging a lower or higher (relative to the sweet spot) fully panoptic light sensor 82 upon swinging. Alternatively, a fully panoptic light sensor 82 can be designed to substantiate a greater portion of the top half of the baseball-bat controller prop 80 without the need for a plurality, but such operating design may be inferior, as it does not account for “sweet-spot” validation that can serve to heighten a gaming experience. In a design tweak, a fully panoptic light sensor 82 can be designed to substantiate a greater portion of the top half of the baseball-bat with an embedded plurality or array of sensors scouting a positional lock. Broadcast agents are not limited to light, but by all agents serviceable to this discourse, in spirit and scope.

Of note, it is possible for the simulated ball flight to start high and then drop to a lower bulb before the timer expires. This flight course would simulate a sinker ball, for example. To add to “pitch” complexity, curve balls can be further simulated under remote casting tower 84 operating scenarios comprising both a tower plurality and a plurality of vertically-stacked lighting elements per tower; such as that depicted in this exemplary discourse. The middle light projection (X2, Y2), for instance, may represent a straight pitch and a shift to the rightmost (X3, Y1) remote casting tower 84 at its lowest bulb—before timer expiration—can simulate a curve ball. Extreme curves may be indicated both vertically, in a pitch that “dips”, and horizontally, in a pitch that traverses, with such shifts occurring between a pitch's origination and a timer 89 lapse. Users must adapt their hitting posture and swing accordingly, or risk a poor performance.

Conversely, for fielding postures, the “ball path” can also be simulated such that an upper light illuminated in a light stack is the start of its trajectory (peak height) and then, as time on the timer diminishes, the middle light of the same light stack (representing a constant vertical ball path) may illuminate—suggesting the ball is now on a downward path—and finally, in the last ball-flight stage, the lower light of the same light stack may illuminate to reflect completion of the flight of the ball path as it hits the “ground”. Light paths, in a fielding discipline, are also prone to horizontal movement. For added degree of difficulty in a gaming environment, the remote casting tower 84 may also transpose across an adjustable horizontal floor track 88 employing a fastened-wheel assembly (illustrated at the inset to the beam-casting light stack, although not annotated); with such transposition representing a horizontally-directional change in course of the “ball path”. To field the simulated ball, the user may simply be required to place the baseball-glove controller prop 81, with its imbedded, fully panoptic light sensor 82, directly into the correct light path at the point of timer expiration, according to one controller scenario, or else yield a fielding error.

Software governing a gaming title on a user device synched to a remote casting tower 84 can, of course, be programmed for fielding to “snag a fly ball” prior to timer expiration and/or other such controller nuances that may be employed in a gaming environment. One such deviceful implementation providing the ability to “snag a fly ball”, although not suggestive of limitation, is through the possible incorporation of a ball speed display system that pairs with a timer 89 device (that could equally operate in isolation without a need for pairing) to indicate a special fielding choice is present, though perhaps with a limited window of opportunity to simulate real-game situations where decisions are often served quickly. The baseball-glove controller prop 81 may come equipped with an interactive button or gamepad interface, wirelessly equipped, and motion-determinant capabilities. In an exemplary point, the baseball-glove controller prop 81 can further serve as an input device when, for instance, a user makes a certain prop gesture or gesture plurality, should the glove be configured for motion detection. In certain embodiments, the beam-casting elements can be part of a display device, such that appropriate background can be displayed in a field of vision (a baseball field, pitcher, etc.) and, for example, a projected baseball may be displayed around each light as it is illuminated, complete with a full complement of sounds (pitch as it slices through the air, a hit, a catch, et cetera), to add to the aura and gaming experience. The baseball-bat controller prop 80 may be comprised of a lightweight material, such as foam or plastic (a thin plastic shell to shape, that is hollow on the inside) to facilitate play safety and further includes a hand strap 80-A for additional grip security. Any such exemplary disclosure is not intended to suggest limitation, but merely act as an aid to facilitate understanding in accordance with an embodiment.

Although not the focus of illustration, miming metrics—such as tracking a “sprint” from third base to home plate—can be incorporated into the disclosed gaming environment with the development of, for instance, a specially-designed controller shoe that is both capacitance friendly and/or electronically equipped for related tracking. The body of the wearable-shoe controller may be comprised of an elastic material to account for varying foot dimensions of a potentially diverse user base or be manufactured in variant sizes, just as regular footwear is. Desired running metrics in a gaming environment may also be ascertained by borrowing from previously described controller scenarios utilizing such methodology as a pedial-input determinant controller mat, also not illustrated, in the spirit and scope of this discourse.

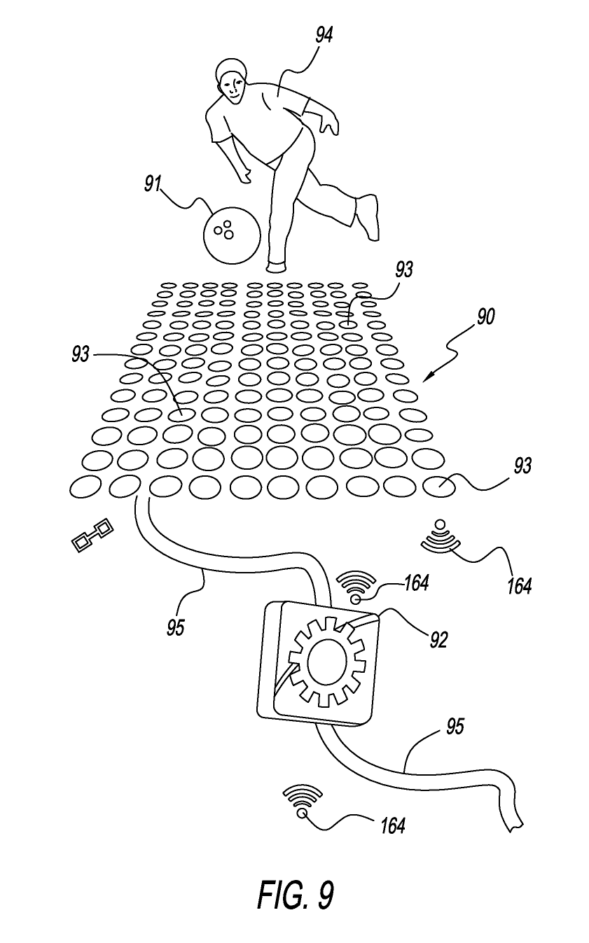

Referring now to the present invention in more detail, FIG. 9 is a perspective view of a bowling-ball controller mat, bowling-ball prop and intermediary-transceiver device comprising an attachable interface, in accordance with the input dynamics of a touchscreen application, this according to an embodiment. A bowling-ball controller mat 90 is designed to interact with a bowling-ball prop 91 upon launch and the interaction is determined and dutifully relayed, to reproduce an event, to a remote touchscreen for correlative actuation by an intermediary-transceiver device 92. The bowling-ball prop 91 contains an innate capacitive source that contactually engages a plurality of densely-arranged, autonomous sensing elements 93 located in the bowling-ball prop's 91 path upon a traditional play sequence, with said engagement ensuing the launch of a bowling-ball prop 91 by a game player 94 or participant. The bowling-ball controller mat 90 becomes “action ready” upon employing an intermediary-transceiver device 92 with interface, as the bowling-ball controller mat 90 comprises the plurality of densely-arranged, autonomous sensing elements 93, in the spirit and scope of this discourse. When the bowling-ball prop 91 is rolled across the plurality of densely-arranged, autonomous sensing elements 93, the bowling-ball prop's 91 orientation, speed, and directional flow or path, amongst other metrics, can be measured based on the distinct pattern and chronology of actuation occurring amongst said dense pattern of autonomous sensing elements 93. The more dense the pattern of densely-arranged, autonomous sensing elements 93, the more accurately the orientation can be determined based on actuation-borne calculations.

Use of an intermediary-transceiver device 92, as suggested above, is only exemplary. Such measured determinants can be injected into a gaming environment on a touchscreen through either the use of a wholly-wired, correlative attachable interface (through a series of wired conductive paths stemming from each conductive isolate in the plurality of densely-arranged, autonomous sensing elements 93 to the touchscreen by, for example, an attachable matrix disc), a wholly-wired interface 95 with an intermediary-transceiver device 92 complement, a hybrid wireless interface comprising an intermediary-transceiver device 92 with interface complement that wirelessly “pairs” with the bowling-ball controller mat 90 for transmitting an input or input plurality by a conductive interface and a system that is wholly wireless (not illustrated) where a user device and bowling-ball controller mat 90 are paired directly without a “ramifying-physical interface” associated in a wired assembly. The intermediary-transceiver device 92 can output customized actuation patterns and need not mirror a controller input. Custom interfaces, such as, but not limited to, a “power-meter” geared network of appendages that subject a capacitive input to interpretation and “shaping” prior to actuation of a capacitive output, demonstrate that not all soft-button configurations need to identically mirror a related controller input, in the spirit and scope of this discourse. An intermediary-transceiver device 92 and controller mat can act as principal agents in such interpretation and shaping, through an integration of apparatus to task, although such language is not intended as being limitative in nature.

The bowling-ball prop 91 sees its outer shell or lining comprised of a lightweight material such as, but not limited to, treated foam, plastic and/or any serviceable material or material composition, either manipulated or implemented in a natural state, that is “capacitance friendly” or capable of transmitting a capacitive charge. The bowling-ball prop 91 may remain primarily hollow. The bowling-ball prop 91 contains a plurality of finger holes for user grip of the prop. The innate capacitive source, being minimalistic in design, is securely nested in the prop to withstand both the throwing impact and the rolling process as it is repetitively thrown across the bowling-ball controller mat 90 in a game environment. The innate capacitive source outputs a level of stored capacitance to its conductive shell, that keeps the bowling ball “always on” for intended actuation, as it is tossed.

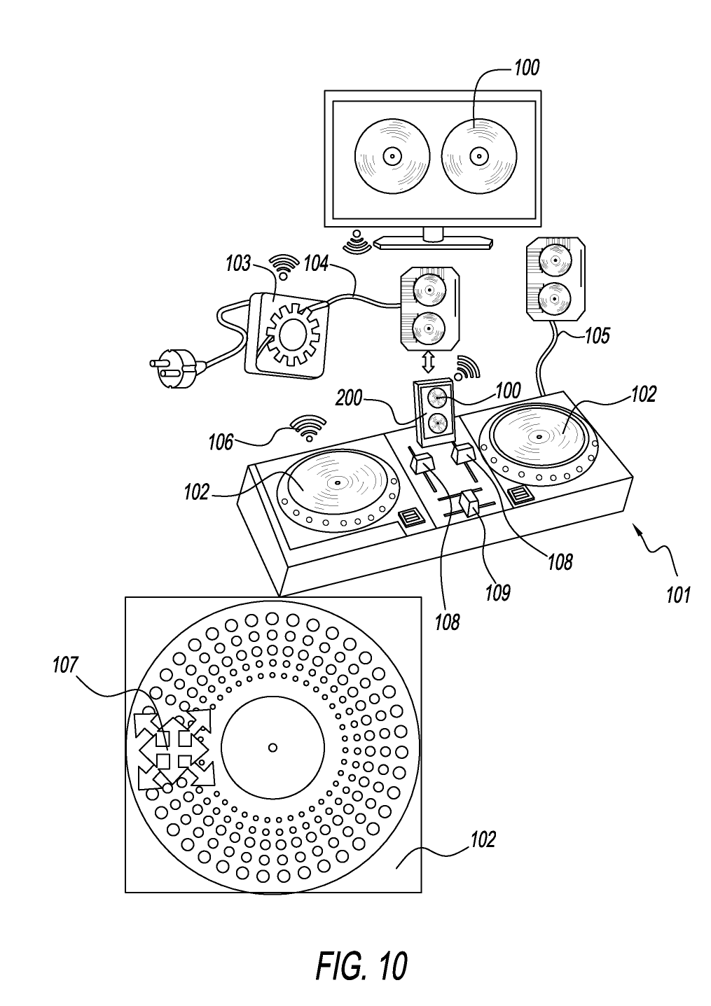

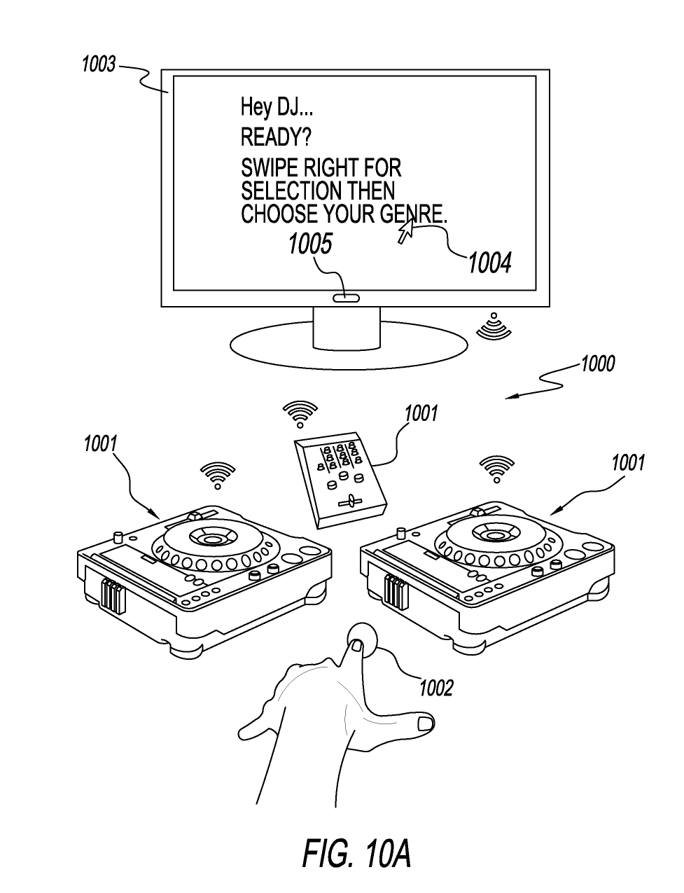

Referring now to the present invention in more detail, FIG. 10 is a perspective view of a DJ-station input controller and intermediary-transceiver device with interface and, at its inset, a system for translating a finger swipe or other such directional user motion, is shown, in accordance with the input dynamics of a touchscreen application, this according to an embodiment. Borrowing from the manner of tracking and determining the orientation of a user's feet (such as a golf stance in the “foot zone”) and from the assay and engagement process of a contactual swing (a club input in the “swing zone”), both discussed in FIG. 7, a user may “become the DJ” by using the control input of a finger, fingers and/or hands to remotely control a “soft-disc”100 and/or soft-disc plurality 100 from a DJ-station input controller 101. Specifically, from the turntable element matrix 102 of the DJ-station input controller 101.

The turntable element matrix 102 is comprised of a plurality of densely-arranged, autonomous sensing elements (acting as a control input) designed to track an incidence of capacitance from the finger input of a user and relay each incidence of capacitance to a touchscreen, faithfully, through either a wholly wired network between the turntable element matrix 102 (a control input) and a correlative attachment interface 105 or under a wireless 106 hybrid system via an intermediary-transceiver device 103 with an attachable correlative wired interface 104. Innate to the intermediary-transceiver device 103 is a processor, capacitance purveyor (self-generating) and capacitive manager, ensuring faithful transmission of a controller input without the need for direct engagement of a touchscreen by a user.

For added controller realism, a DJ-station input controller 101 may borrow from both the physical appearance and controller “feel” of the authentic hardware it is designed to mimic. While the turntable element matrix 102 is a fixed structure in this exemplary discourse and, therefore, does not “spin” a musical compact disc (or record variant), as authentic hardware may, a capacitance-friendly, CD-shaped, thin-film membrane may be placed in the area where a typical CD is mounted. A measure, thus allowing a user to slide or “spin” the thin-film overlay across the turntable element matrix 102 face while still actuating the plurality of fixed, densely-arranged, autonomous sensing elements (each serving as a control input) below it. A pitch slider 108 (used to adjust an on-screen BPM count for mixing purposes) and mix slider 109 are components specific to this rather “component-simplistic” exemplary discourse. The potential for increased functionality and complexity in a controller embodiment, in the spirit and scope of this discourse, clearly exists and any such discussions here are not suggestive of limitation. A pitch slider 108 or mix slider 109 may employ a similar system to the gas-pedal controller with scroll bar for engagement purposes, amongst other serviceable means.

Drawing upon the turntable element matrix 102 at inset, a finger swipe is reproduced to the touchscreen of a portable or stationary device 200 remotely. As opposed to a controller scenario where an actionable object 100 is remotely controlled, in the spirit and scope of this discourse, by simply hitting a singular (left, right, up or down) control input—with a respective soft-button counterpart(s) fixed or tethered to a touchscreen geography to output a capacitive charge, accordingly, a swipe offers the ability for “fluidity of touch” or “fluent-touch motion” when taken in a series. The inventor, whom is also the primary author, refers to the first control scenario as “one-dimensional”, whereas a turntable element matrix 102 offers a robust finger-tracking system (“fluid-dimension”) that catapults control dynamics (in contrast to its one-dimensional counterpart) by reproducing a finger swipe, remotely. By drawing on the actuating sequence of the plurality of densely-arranged, autonomous sensing elements and relaying said sequence, faithfully, to a soft-button controller on a touchscreen of a portable or stationary device 200, remote-engagement of a “finger swipe” is actualized, and thus, made possible, just as if the user were touching the touchscreen of a portable or stationary device 200 directly.

Illustrating a directional plurality of autonomous sensing elements engaged in a “finger swipe” is a directional pointer 107 (as an illustrative aid, it is not a physical pointer manifestation). As a finger is tracked across a turntable element matrix 102 in an upward motion, as a possibility suggested by the directional pointer 107, a plurality of densely-arranged, autonomous-sensing elements are actuated in the path or course of the directional pointer 107 gesture (in this reference, an upward motion). When actuation is taken in a series, akin to how drawings are animated in a flip book or flick book, a pattern of “motion” is introduced and reproduced on a touchscreen of the portable or stationary device 200 upon successive actuation (a succession of a capacitive-charge input transferred to a touchscreen) in the series, in the spirit and scope of this discourse.

FIG. 10A illustrates a physical/virtual hybrid input-controller system (a DJ-controller system) utilizing both a physical-input controller mode and a gesture-seeking mapping component (an input mode based on the digital tracking of a user's gesture(s) by virtue of an integrated camera, such as those found on a touchscreen-user device) designed for bi-modal integration of a user input into a virtual environment being rendered on a remote touchscreen user device or device plurality. A hybrid tactile and gesture-based input-controller system 1000 utilizing both a physical-input controller 1001 and a gesture-sensing input controller 1002 interface is thus introduced for purposes of manipulating touchscreen-based actionable objects. The gesture-sensing input controller 1002 operates under the influence of a user's gesture input (generally without a tactile, physical reference afforded to the user), the gesturing being mapped to a soft input of a touchscreen user device by an integrated camera 1005 and any associative software that may be present translating the mapped input (the gesture) to the mapped output (translating a divined mapped input to a soft input by virtue of the corresponding manipulation or “actualization” of an actionable object associated with the gesture) of a touchscreen user-device 1003 remote from the user, this according to an embodiment. Exemplifying a case of gesture input in the spirit and scope of this discourse—while acknowledging that many serviceable replacements of divergent systems tracking a gesture input are possible from that suggested in this embodiment—leads to the disclosure of a hybrid tactile and gesture-based input-controller system 1000 or DJ-input controller system 1000, as transitioned for operability in a touchscreen environment.

Under this operating scenario, upon the launching of a DJ-related software application, a user may, for instance, be given a selection of songs from which to choose from using hand-based gesturing as a method of controller input, this process of song selection being repeated for both DJ turntables 1001 in a mixing environment. Leveraging a virtual pointer 1004 shown on the touchscreen user-device 1003, in accordance with an embodiment, a user is afforded an orientation point from which to commence and map an ensuing gesture for targeted virtual actuation. In this way, a user may manipulate the virtual pointer 1004 to a specific location on the touchscreen of a touchscreen user-device 1003 (as the virtual pointer 1004 is directionally refreshed in real-time on the touchscreen). Movement can, for instance, be dynamically interpreted in “freestyle mode” by an integrated camera 1005 to actionable commands through an associated software-based filter or by virtue of framing using the torso of the user as a “mousepad” and/or, in further instance, potentially using the frame of the large touchscreen's 1003 video output display as a visual reference aid in, and the “digital framing of”, the tracking of a user's finger or finger plurality for a related controller input and/or input plurality. The physical footprint of a specialty controller may also be used in this concept of framing. A system of pointer re-centering, where necessary, may also be applied to the disposition of a virtual pointer 1004.

Therefore, in expanding on the example above regarding a process of song selection, a user may proficiently guide the virtual pointer 1004 over the song of choice for official selection and then may proceed to tap the finger down (not suggestive of limitation, as gesture mapping can be electronically calibrated and/or written in a highly-diverse footprint), a gesture understood by the tracking system to indicate virtual actuation of the selected choice. Well beyond the simple menu of song selection referred to in this example, the virtual display may also include a digital “dashboard” that affords the user miscellaneous selective material to chose from to compliment the user experience, such as, but not limited to, selecting a venue, DJ style, music-type or genre, entering a DJ's name, or any akin actionable disposition prompting and/or responsive to a remote input (all potentially actionable at the coordinates of the gesture-based (camera-tracked) virtual pointer 1004). Hand gestures, such as an articulated left swipe, may readily be recognized (and/or be readily assigned under a system relying on calibration) by the described gesture-sensor system (the integrated camera 1005 with associated software according to this exemplary discourse) to effect the changing of a digital “page” in a directionally corresponding manner to the gesture produced, exempli gratia. Furthermore, effects such as, but not limited to, video sampling, interjecting sound and video bites reflecting appreciation from an enthusiastic crowd, camera pans, light shows, dance-offs, and the like, may also be added to a DJ-themed touchscreen-gaming environment to heighten the user experience. Of course, in a progressively gesture-based input-controller environment variant, even the DJ turntables 1001 could be activated and engaged remotely by processing selective hand gestures in mapped mode, if so coveted, although for the embodiment under primary discussion, the turntables are controlled by a physical-controller interface in an effort to inject a greater sense of tactile realism to the game play.

The tactile component of the hybrid tactile and gesture-based input-controller system 1000 or DJ-controller system 1000 is designed for more “hands-on” enthusiasts, connecting and integrating, virtually, with a touchscreen user device 1003 by virtue of a wireless capacity. The DJ-controller system 1000 further contains a CPU and responsive controller system for the management and exchange of control-based directives between it and a communicable touchscreen user device 1003, promoting seamless, real-time integration between said physical or tactile input controller and the associated software application running on said touchscreen user-device 1003. Thus, such deejay fundamentals as scratching, mixing, engaging a slider, etceteras performed on the physical controller can instantly translate into a reflex virtual rendering of the same. The act of scratching, in adding colour by example, may be readily tracked by any serviceable means, including the incorporation of sensors in the turntable element of the DJ-controller system 1000, capable of readily ascertaining direction, range of motion and the like. In this way, the stylish tactile or physical-input controller assembly 1001 (of the DJ-controller system 1000) complements the gesture-based input-controller system system 1002 in a rather bold design stroke.

For possible attachment interjection in accordance with an ancillary (kindred) DJ-controller environment, the reader may refer to FIG. 10 detailing a serviceable tactile-input interface, operating under the ascendancy of an internal capacitive management and distribution system (and/or under the ascendancy of user-supplied capacitance under the manipulation of a controller input for purposes of manipulating onscreen actionable objects in the spirit and scope of this discourse). For band-themed games, a DJ-controller environment may also be complemented with similarly spirited specialty-input controllers and/or controller environments such as, but not limited to, drums, keyboard and dance pad (the bi-modal integration of motion-based gesture recognition input with an element of tactile input being optional) by virtue of either an established wired and/or wireless connection with a touchscreen user device. Some operating embodiments may, of course, witness uni-modal input support, as opposed to bi-modal input support that may be borne by a hybrid-controller scenario such as the one described herein.

And in building on the excerpt above that refers to the use of a physical footprint of a specialty controller as a positional-framing tool in a virtual environment, for instance, using similar methods of controller disposition, a camera may be reconciled to detect where on a dance-pad a user is stepping and then have those germane directives transmitted to a serviceable mapping interface, such as one found governing a touchscreen-user device during active game play, for related processing in order to map the tapped dance-pad area (that is, the physical area being stepped on) to a corresponding virtual soft-button input (that is, the virtual area on a touchscreen associated with said physical area) for related virtual actuation. Citing now an example of bi-modal integration in building from a dance-pad theme, a specialty-input controller may be used in conjunction with a camera-based system tracking user input, whereas a specialty dance-pad controller may be used specifically for the purposes of pedial mapping, a camera-based system may be integrated to concurrently detect a user's finger, hand and miscellaneous body gestures in accordance with mapping to a soft-input interface (e.g. combining a plurality of user-based input—such as in the determination of hand and foot movements—metrics that may prove germane for a dance-themed game). Although a camera-based tracking system may be capable of autonomously and concurrently tracking both modal inputs (pedial and non-pedial) without use of a specialty-input controller, many gamers would show preference for a tactile-input interface.

FIG. 11 is a perspective view of an intermediary-transceiver device according to an embodiment. An intermediary-transceiver device is designed to leverage an innate-capacitive source and capacitive manager to correlatively engage—through a network of wired appendages (an interface) seeking attachment to a touchscreen—a plurality of actionable objects, in this case the perspective letters “A” and “B”, on the touchscreen of a portable or stationary device. Designed in accordance with the input dynamics of a touchscreen application, this device can displace user capacitance, or put another way, removes user-supplied capacitance as a requisite component in a conductive path, in the spirit and scope of this discourse.

In a rather rudimentary literal-brush stroke, the intermediary-transceiver device 110, either in a wired or wireless environment, acts to mediate a control input. As the diagram inset 111 shows, an elementary conductive path in the spirit and scope of this discourse, may comprise a control input A,B, remotely situated, as it is correlatively paired with a control output A,B (that is, a physical interface that outputs capacitance to the respective A,B soft-buttons on a touchscreen). A conductive path may be prone to influence by a wired or wireless tether. The intermediary-transceiver device 110 may be engaged to “mediate” an elementary conductive path, in the spirit and scope of this discourse.

The intermediary-transceiver device 110 contains an innate capacitive source 112 and capacitive manager 113. As a plurality of control inputs are engaged or manipulated remotely, such as with the letters A 114 and B 115 in respective order, this string of sequential input directives is directed—either wired or wirelessly—to an intermediary-transceiver device 110 for related processing. The capacitive manager 113, faithful to input chronology and an origination source, leverages an innate capacitive source 112 to inject an incidence of capacitance, where necessary, to each wire A 118 and wire B 119, acting as a control output (or capacitive output) transmitting a capacitive charge to a respective soft-button 116 that responds to this capacitive input or capacitive charge, upon correlative attachment. A capacitive charge is relayed, respectively, to the soft-buttons 116 of the touchscreen of a portable or stationary device 117 through a wired network or network of attached appendages (attachments not depicted, but understood from previous applications incorporated by reference herein).

Building on the example set forth, this wired network sees the control input A 114 relayed to the correlative soft-button 116 by wire A 118, in a manner faithful to which it originated. Similarly, the control input B 115 sees the intermediary-transceiver device 110 relay an instance of capacitance to the correlative soft-button 116 by wire B 119; the wire of which is correlatively attached, through any serviceable means, to the “b” soft button 116.

An intermediary-transceiver device 110 may come equipped with a built-in camera or camera plurality that may facilitate motion determination or manage the sharing of images or a live feed across a network (for instance, to an online community and/or gaming portal) and be fully functional as an internet-enabled device with hub disposition, ideally suited for engaging in online gaming and social-gaming scenarios involving multiple-players. An intermediary-transceiver device 110 may also be equipped with devices such as, but not limited to, a headphone jack, microphone jack (and/or a built in hardware complement), speaker jack (and/or a built in hardware complement) and to offer two-way communicative capabilities, providing for potential user interaction with online gamers during the course of gameplay, the input of a voice command and/or for voip telecommunication, as examples.

Referring now to an unillustrated embodiment, a divergent approach to relaying a motion gesture to the touchscreen of a portable or stationary device uses a thin-film membrane, this according to an embodiment. A thin-film membrane—designed to be affixed to a touchscreen of a portable or stationary device—is comprised, treated and/or coated with an actuating catalyst or agent, such as, but not limited to, an electrostatic material. When a casting device (specially designed for its projection to interact with the properties of the thin-film membrane at, and upon, point-of-contact) such as, but not limited to, an eye friendly laser pointer or infrared-projection tool (or any projection tool serviceable to this embodiment), projects its beam unto the surface of the thin-film membrane, a reaction occurs at the point of contact causing a capacitive instance to be registered on the touchscreen of a portable or stationary device, at the precise location. While citing such examples as use of an electrostatic material in this exemplary discourse, such language is not intended as being limitative in nature and any material and/or properties conducive to using a broadcast agent to channel a controller input and/or cause an instance of capacitance (or gentle pressure in the case of non-capacitive environments) to be registered, to a touchscreen by said remote projection, in the full breadth, scope and spirit of this discourse, is wholly inherent to the application. Furthermore, all broadcasting tools or agents serviceable to this application are to be considered inherent to this application. Use of a thin-film membrane is not limited to a touchscreen-defined sheet and can be constructed in all shapes and sizes, as desired. Further still, broadcast or projection tools may be designed for use where the broadcast agent is projected directly on the surface of a touchscreen of a portable or stationary device with equal (actuation efficacy) results, without the need for an intermediary actuating catalyst—such as a thin-film membrane—in order to engage control of an actionable object and/or register a capacitive instance with a touchscreen.

In a potential offspring to the unillustrated thin-film membrane embodiment noted above, the thin-film membrane can be designed to work independently, that is, without being manipulated by a casting device described above. Under this operational environment, a transparent (thus, permitting for fluent viewing of the display rendering) thin-film membrane may be designed to be superimposed by static, suction, removable adhesion or any other means serviceable, onto the surface of the touchscreen; and may be manufactured in accordance to varying touchscreen display sizes, operating-control scenarios of the soft-buttons and/or available framing adjacent to the touchscreen, as so coveted, as merely an example in point. The thin-film membrane is highly customizable in its native environment and may lead to, for instance, remote operating scenarios, whereas, a thin channel capable of holding small quantities of water—acting as a transparent conductor designed to purposely channel a quantity of capacitive input (such as that via a finger input) and further permitting for fluent viewing of the display rendering upon superimposition due to this inherent transparency—may be molded into the thin-film membrane or skin and be subjected to fluid injection completed by a sealing process.

According to an embodiment, a molded and water-filled channel can be designed to conductively contact a respective soft-button by any means serviceable, and sees its respective water-filled channel extended onto the border, that is, the area on the portable device adjacent to the touchscreen, by an interconnected, interchangeable, conductive bridging-button or plurality attached in the spirit and scope of this discourse. An independent button need not be used for capacitive bridging and instead the water-filled channel or channels comprising the thin-film membrane can each lead to a remote “touch button” as part of a single assembly and/or molded assembly. Under one design rendering, without suggestion of limitation, the conductive button can assume the form of a finger-sized, collapsible, air-filled bubble or bubble plurality, that is filled partially with a conductive liquid, such as water. The collapsible, air-filled bubble sees its upper region, notably, collapsible, as it is subjected to the depression by the finger input of a user. The act of depressing the collapsible air-filled bubble to a point that transfers the finger capacitance of a user through the air to the point of contact with the water present in the collapsible bubble, and then onto the interconnected, fluid-filled channel of the membrane for respective soft-button activation in the spirit and scope of this discourse. Further, these collapsible, air-filled bubbles, partially filled with water (with the water residing below the air and the upper collapsible surface) can be made independently to be removable and re-attachable to any area of the touchscreen serviceable under the present invention.

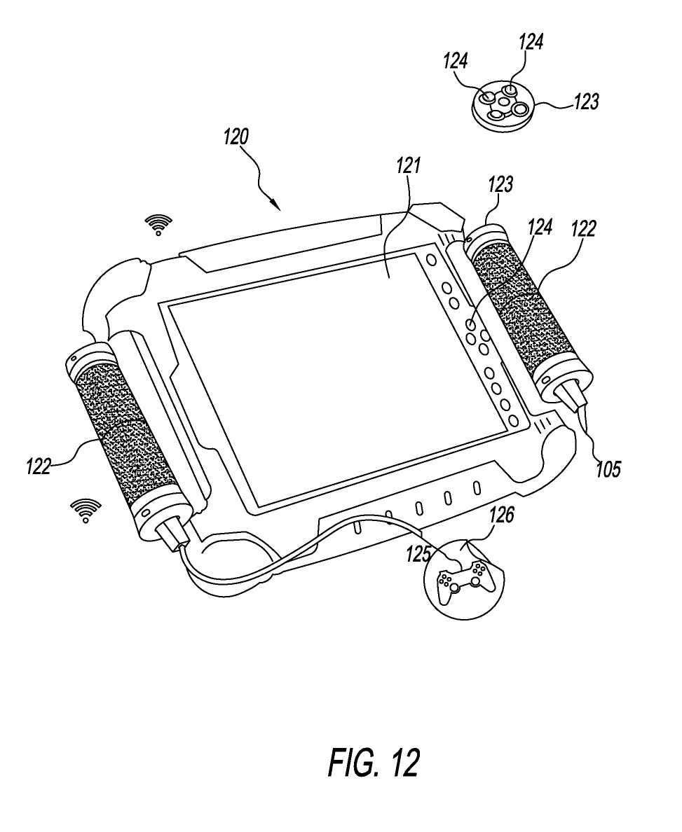

FIG. 12 is an illustration of a touchscreen-suspension device equipped with comfort grips and remote-control operability stemming from a tactile input controller (operating on the capacitive input of a user's finger) and a respectively conjoined attachable soft-button output interface or interface plurality (serving to strategically discharge the capacitive input or charge of a finger to, for instance, an associated or a targeted soft-button or soft-button plurality upon congruous attachment to a touchscreen). In accordance with an embodiment, FIG. 12 depicts a touchscreen-suspension device 120 equipped with grippable-handle members 122 and an associated tactile controller or controller plurality 123 as shown (with compressible or non-compressible conductive buttons 124). An independently channeled and insulated wire 125 (or any serviceable conductor in its place) may form the requisite tether relationship in a wired embodiment between each respective button member 124 of the tactile input controller 123 and each respective soft-button counterpart by means of an attachable (output) interface 126 or interface plurality at the tether end 125 (a subject well versed under the common-ownership teachings of the inventor and not the subject of detailed illustration as per this figure).

A suspension device 120 comprises a receptive frame 127—designed to securely station a mountable touchscreen user device 121—and a single hand-grip (support) structure 122 constructed at each end of the receptive frame. Each grippable-handle member of the grippable-handle member plurality 122 may comprise a tactile input interface 123 delineated by a capacitance-transmitting button and/or button member plurality 124 and/or any serviceable capacitance-transmitting manipulable member 124 and/or manipulable-member plurality 124, the arrangement and positioning of which may vary widely from this illustration. The capacitive-bearing (input) button members 124 of the tactile input interface 123, adhering to the teachings of previous inventive discourse and permitting the fluent introduction of a “green-controller” environment by serviceable interconnection (since the controller may be solely powered by the innate capacitance of a user), see a tethered coupling by any serviceable conductive medium such as, but not limited to, a flexible wire 125 that capacitively pairs each (input) button member 124 with its respective soft-button counterpart (by virtue of an attachable and serviceable output interface represented by annotation 126, although, as suggested, an attachable interface 126 is not shown in intricate and attached to a touchscreen in the accompanying figure).

Or stated differently for purposes of facilitating reader understanding, with more of a literal emphasis to the two opposing wire tips of a tether, on one end of a wire tip is a capacitive-bearing button member 124 capable of engagement upon manipulation by the control input of a finger supplying a capacitive charge, and on the opposing wire end is an affixed (preserving a conductive path), corresponding element (of an attachable output interface 126) capable of a targeted capacitive discharge. The length of wire 125 servicing the tether, of course, faithfully honours a capacitive path between the control input and control output interfaces to an actuating conclusion. The attachable output interface 126 is befittingly superimposed to respective capacitive alignment over a soft-button interface such that each button member 124 is communicably assigned, by any means serviceable, to a respective soft-button member for purposes of controlling an actionable object or object plurality (remotely from the touchscreen), in the spirit and scope of this discourse.

The tactile input controller 123 assembly may also be part of a suspension device comprising an electronic assembly that wirelessly pairs a tactile-input controller 123 with a touchscreen-user device directly for purposes of controlling, respectively, an actionable object and/or actionable-object plurality (without the use of an attachable interface) by virtue of a serviceable mapping interface, for a kindred state of remote operation. Alternately, a snap-on apparatus plurality comprising a wired and/or wireless physical-controller interface and designed to affix to both borders (in reference to both landscape and portrait page-orientation modes) of a touchscreen user device for communicable and remote operation therein, is, of course, serviceable to the spirit and scope of this discourse.

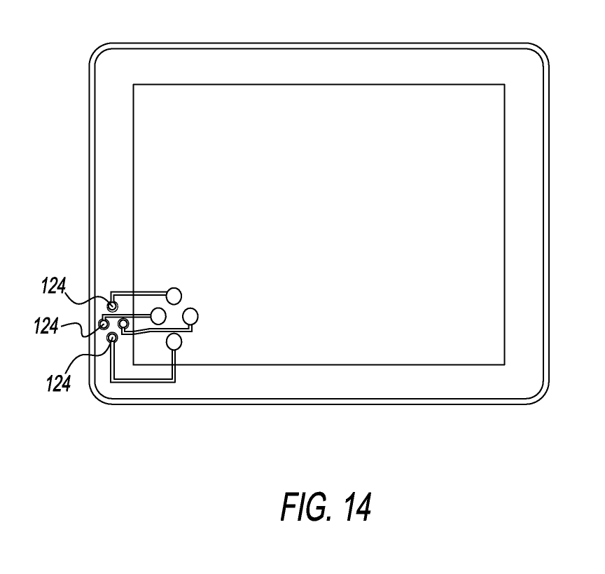

To wit, the controller design described in the present embodiment may afford the user with an exceptionally more precise, convenient and empowering way to control an actionable (on-screen) object or object plurality, while still permitting fluent access to the mounted touchscreen device 121 for finger swiping gestures (if, for instance, it is deemed integral to the game being rendered) and/or fluent user influence on the integrated sensors of a touchscreen user device, such as, but not limited to, the gyroscope, accelerometer, proximity, GPS (Location Services measuring positioning) and/or digital compass, to name a few, where available and/or where integral to the engaged gaming dynamics. In alternate iterations, a tactile-input interface 123 comprising a capacitance-transmitting button member 124 or member plurality, may, of course, also be serviceably attached to the borders (e.g. an attachable interface not directly affixed to the glass itself) adjacent to the touchscreen of a touchscreen user device 121 (with any serviceable conductive medium serving in respective tether to the soft-button members of a soft-button controller); without use of a suspension device, as indicated in FIG. 14.

A prefabricated overlay, comprising a plurality of serviceable transparent conductive coatings forming the requisite tethering channels between a soft-input interface and a remote, manipulable (a tactile input) member interface for a particular controller environment (which may, as an exemplary case in point and without suggestion of limitation, include physical buttons, joysticks, gamepads, manipulable combinations of a tactile input plurality and any serviceable touchscreen-centric input that may be, placed adjacent to a touchscreen display), can be used for offspring embodiments. Prefabricated overlays will vary, of course, based on the particular soft-controller structure of the host device unto which the overlay seeks serviceable attachment and may be manufactured to correspond to the soft-button controller environments of the most popular games and sized for the most popular touchscreen gaming devices. A serviceable overlay may further comprise a tactile-input interface designed for direct contactual alignment (e.g. a controller is not affixed adjacently to a touchscreen display or not operated remotely, if so coveted) of the tactile-input interface with the corresponding surface of the touchscreen resulting in the respective alignment of the tactile interface with the soft interface upon positional overlay, in accordance with the spirit and scope of this discourse.

While attachment-themed exemplary discourse may suggest a practicable application of an attachment interface, it is not intended to suggest limitation in any regard and/or does not necessarily imply a specific method and/or system of preferred operability. Further, where applicable by virtue of attachment-themes, any deviceful controller assembly described in the specification's dissertation, may operate directly, in wireless mode under an established duplexing system, with its linked partner (e.g., a touchscreen user device by virtue of a serviceable digital mapping system), thereby potentially displacing the requirement for an attachable physical interface under the disposition of remote operation.

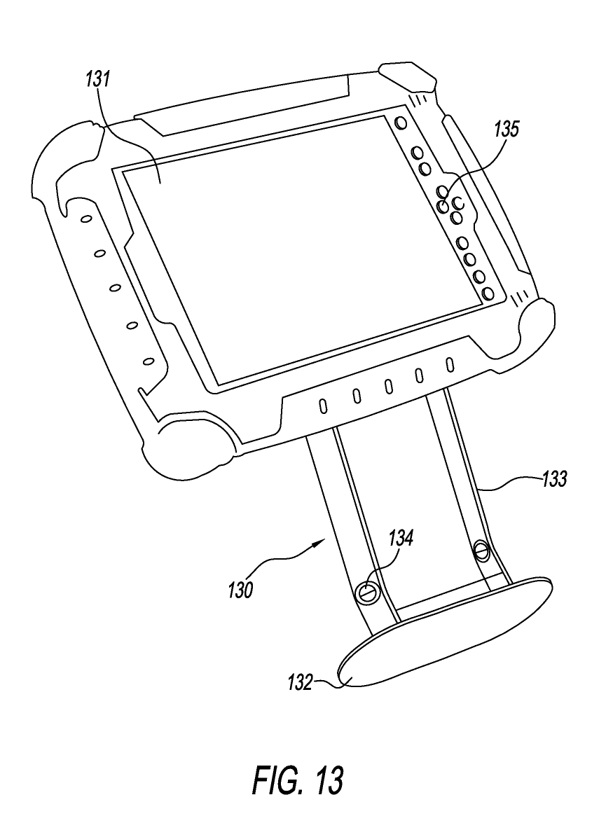

FIG. 13 is an illustration serving to broaden the embodiment of FIG. 12—complete with remote-control operability—whereas the comfort grips give way to a user-mounted support apparatus acting to suspend a touchscreen user device automatically; that is, without the need for the user to actually clutch the touchscreen user device to establish operable suspension. Particularly, in accordance with a kindred embodiment, the grippable-handle members of the suspension device described in FIG. 12 are replaced by a ready-mount 130 system of underpinning that firmly supports the touchscreen device 131 positionally, such that fluent touchscreen access by a user's hands is permitted. As a user's hands would routinely be occupied by the concurrent grasping of a touchscreen device 131 during typical use, this embodiment serves to appreciably liberate a user's hands for a variety of requisite task administration. Examples of a ready-mount 130 system may include, but are not limited to, a user-mounted apparatus, for instance, an illustrated anchor mechanism 132 permitting secure attachment to a buckle clip or belt's lining, a lap-mounted variant designed to sit securely on the lap of user during engagement of a touchscreen device 131 (e.g. in the form of a foldable and pliant rubberized case that locks into position) and/or a system designed to rest atop and/or be suspended from (e.g using a pliant suspension mechanism, such as a mountable arm with memory return to securely anchor a touchscreen user device) an underlying infrastructure. As this is mere exemplary discourse, however, it in no way is intended to suggest limitation.

Expanding further on a buckle-clip system in illustrative fodder, the ready-mount 130 system may comprise a rigid, yet adjustable suspension arm 133 with an annexed swivel apparatus (not the subject of illustration) situated at its apex. The suspension device's receptacle 136 (the frame structure) for a touchscreen user device 131 is hinged on a sliding omni-directional “ball-joint” swivel (the swivel apparatus) at its underside and sees construction of said “ball-joint” encased in a flexible rubber membrane or rubber sheathing to fluently permit the functional influence of a user's hand gestures on such input sensors as, for instance, a gyroscope and/or accelerometer, by allowing an angular (e.g. twisting and tilting) and somewhat undulating influence of the suspension device, and by association, the mounted or suspended touchscreen user device 131. Left-and-right and top-and-bottom tilting and a degree range of rotational freedom and positional influence influenced by the ball-joint mechanism, as a case in point, are readily permitted by the rubberized ball-joint mechanism. The omni-directional, “ball-joint” swivel assembly may, if so coveted, embody rubberized and mechanical design tweaks (including, for instance, the boot and the potential inclusion of any motion-control ball joints retained by an internal spring) that permit for broader movement fluency under a user's hand influence and a “memory-return system” that returns a touchscreen user device 131 to a position of rest automatically upon release of a user's hands. The field of rubberized ball joints is well versed and can be readily adapted to this context. The adjustable suspension arm 133 may contain a lockable-pivot mechanism 134 (that may use a fastening device, without suggestion of limitation, to lock a touchscreen user device securely in place upon selected positioning and/or exhibit properties of inertia serving to steady a device at rest, yet permit for added positional fluency under hand influence) for added positioning versatility. A capacitive-bearing button member 135 or member plurality may be communicably linked—by any means serviceable to the spirit and scope of the application—in accordance with a soft-button controller present in an operational environment.

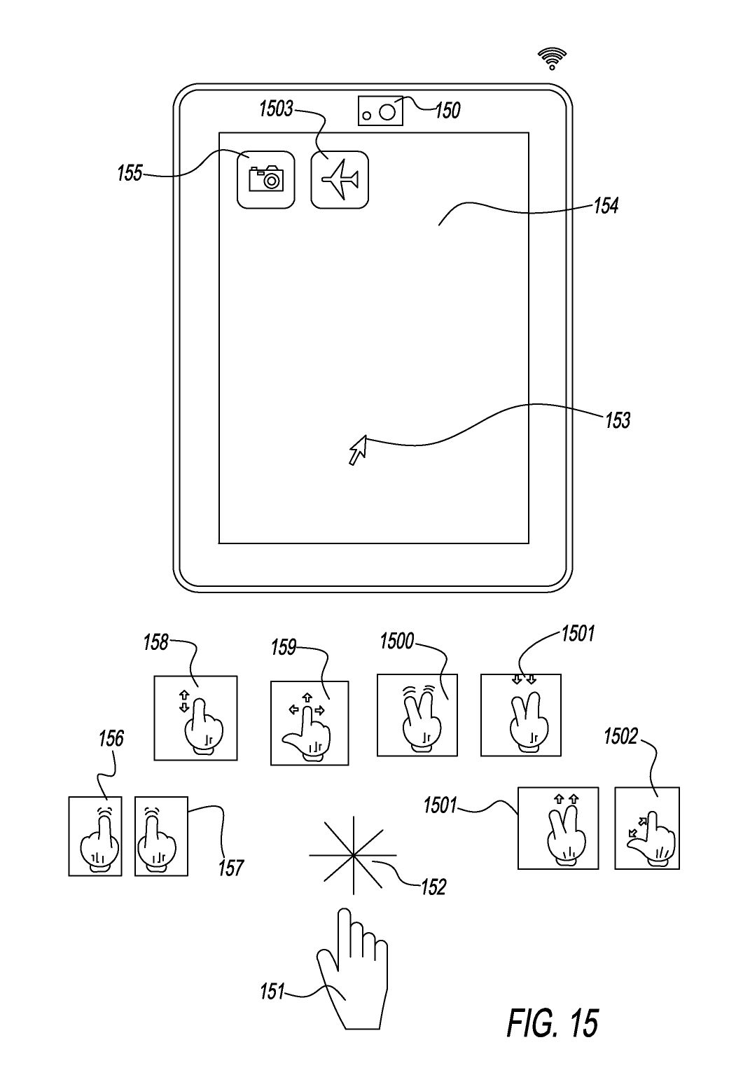

FIG. 15 illustrates a mouse-type input system that leverages an associated camera (or camera-plurality in related iterations) to track a user's finger and/or finger plurality and integrative gestures under the administration of hand articulations and/or a similarly serviceable recognized input gesture or gesture plurality, assuming and manipulating the position of “mouse” pointer, in accordance with this exemplary discourse. A mouse-type input system is thus designed for transitional modal integration into a touchscreen environment. In a method of operation under the described embodiment, exempli gratia, a finger and gesture-tracking app 155 is designed to launch (and attune with) an associated camera 150 for purposes of capably tracking a user's 151 accredited finger path 152, hand articulations and an aggregation of associative gestures. The finger and gesture-tracking app 155 may comprise a distinguished inventory of gestures and finger derivations under its recognition umbrella, with said inventory available to the user for purposes of, for example, engaging a mouse pointer 153 on the touchscreen 154 of a touchscreen user device, and/or may comprise a feature capable of learning new input commands entered and then saved to the software's repository by a user. New input commands may consist of a single gesture or a series of gestures, perhaps prompted by a camera pose and/or pose series, and the user may choose what actions the new commands will be associated with. The gesture-tracking app 155 may run concurrently with other active software, thus affording real-time and concomitant gesture integration with the software into its rendering environment (by virtue of both the software and CPU-based processing of an integrative input such as a tracked finger path 152 and/or recognized set of associative gestures). The finger and gesture-tracking app 155 may not be requisite, of course, in a controller environment where the primary software is programmed to autonomously decipher and incorporate camera-based gesture recognition into a gaming environment.

For instances of assuming mouse-like behaviour in tune with this embodiment, a mouse pointer 153 may be dragged across the touchscreen 154 to a targeted icon 1503 for related actuation via the influence of an integrative input associated with a finger path 152, accredited hand and/or finger articulations and/or an aggregation of associative gesturing potentially beyond that of hand-based input for the intended manipulation of actionable soft elements of a primary software application currently running. Said another way, a user may control a primary software application and/or program—such as one that allows control of a user desktop PC—by using nothing more than, exempli gratia, an associated finger input performed remotely from the touchscreen 154. Under the watchful lens of an associated camera 150, control-input gestures, such as the tracking and reproduction of right-click and left-click functionality, are readily spirited into the execution of a software program for virtual mapping translation.

Mapping hand/finger articulations and/or accredited gestures for corresponding soft-button actuation remains fluent in accordance with the present embodiment. Accredited finger articulations such as, but not limited to, a user 151 tapping a finger of the left hand downward 156 at a point of mouse pointer 153 orientation (with the left hand potentially representing the left-mouse button in continuance with the theme of desktop control cited previously and the downward motion of an articulated finger input representing an intent of actuation) and, conversely, the tapping of a finger on the right hand downward 157 in similar articulation (representing the right-mouse button) may be readily discernible and integrated into a touchscreen 154 environment (in a form of digital or electronic “actuation” replacing the need for a state of capacitive actuation by the control input of a finger) by the tracking and/or mapping software associated with the camera 150 of a touchscreen user device 154. Up-and-down motions 158, omnidirectional motions 159, double taps 1500, two-finger directional swipes 1501 and pinching motion 1502 may, for instance, comprise a partial list of recognizable input-driven commands in a given tracking inventory. Tracking markers, such as specially-designed thimbles and/or the use of motion-activated controllers (e.g. motion-input or gesture-sensing controllers clutched by hand) for precision tracking purposes, could also be added to modal finger/hand and/or gesture-based input, according to an example set forth, for improved discernment in (where, for instance, tracking discernment in a given environment may prove difficult and/or require greater precision), and a broadening of, tracking ability.

In further stead of an exemplary broadening of tracking ability, it should be noted that motion-sensors such as, but not limited to, gyroscopes and accelerometers found in graspable motion-input controllers, with or without use of a gesture-sensing camera, may allow for translation of natural athletic motions to gameplay input with great fidelity and may, exempli gratia, further eliminate the need for ground/surface controller pads for golf-club, hockey-stick, bowling and tennis-racquet controllers since the graspable motion-input controller (readily inserted into a likened physical prop) may be readily capable of ascertaining the requisite game metrics for the homologous supply of directives to a touchscreen user device for serviceable virtual mapping.

In a modified form of the present embodiment, suggesting a possible commutative brush stroke of camera-based fodder, this operating scenario, amongst other serviceable iterations, may, of course, also be transitioned to a controller environment comprising an intermediary-transceiver device with an engaged motion-seeking and/or gesture-tracking camera (discoursed in detail above, the reader may further refer to such articulations as FIG. 10A, FIG. 11) or akin camera plurality in lieu of a touchscreen user device's camera and/or may be concomitantly applied (employing both the camera of the touchscreen user device and intermediary-transceiver device concurrently), without suggestion of limitation. An intermediary-transceiver device may, of course, also operate in a wholly wireless state and thus, have the potential to remain wholly attachmentless. Furthermore, the operating scenario may be transitioned away from a mouse-type input system to any input-means serviceable to a congruous controller environment, including, as but one example, accredited body mechanics and/or gestures performed in a sports-or-dance themed game for the intended manipulation of an actionable soft interface (such as a soft-button and/or soft-button controller) and/or actionable object tethered electronically (in mapping). Said another way, an electronic tether may occur between a serviceable touchscreen specialty input controller and an engageable soft-based interface, although, exempli gratia, in the case of accredited body mechanics and/or gestures performed in a sports-or-dance themed game under the governance of a camera-based system, a physical specialty controller or tactile interface may not be requisite for game play. That is, with advanced image processing capabilities potentially inherent in a controller embodiment, a camera alone may be capable of serviceably processing input-based gestures.

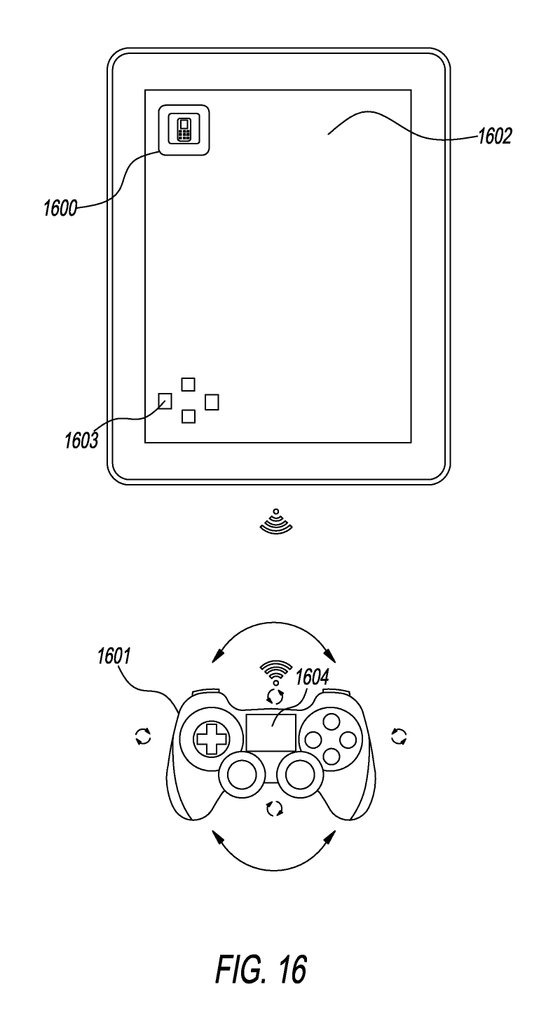

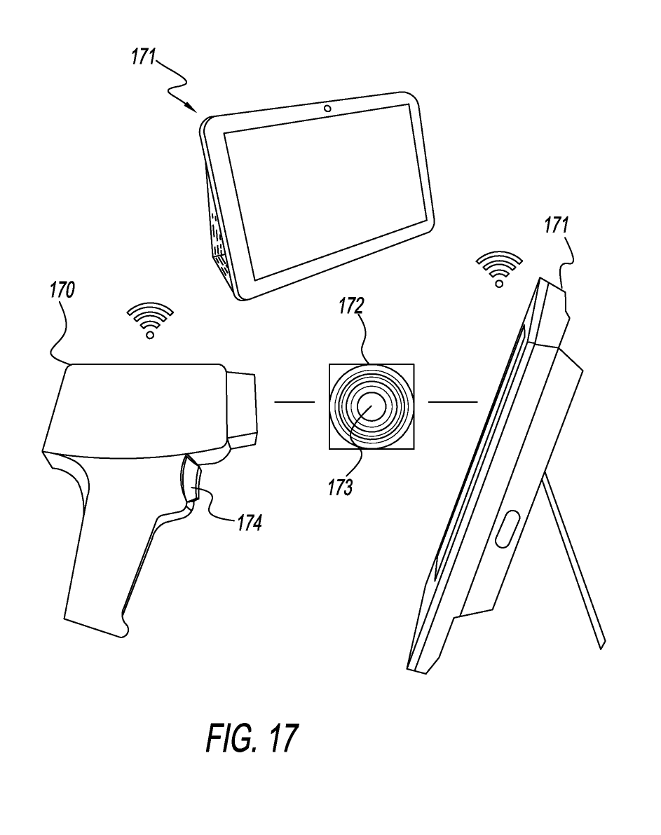

Falling under the breadth and scope of the previous mapping-based discourse, FIG. 16 illustrates a rechargeable or battery-powered wireless controller 1601 and associated pairing app 1600 (control-bearing) integral to the control mechanics of an attachmentless-controller environment described herein and in accordance with a touchscreen 1602 embodiment. As a prelude to controlling actionable objects during the course of game play, a user may be required to download and/or preload an app or software-based, input/output mapping interface 1600 (or any serviceable software) associated with the transitional operability of a wireless controller 1601 in a touchscreen environment. Upon installation, a user may then proceed to launch a third-party app that he or she wishes to engage control of with said wireless controller 1601 and the input/output mapping interface app 1600, running concurrently, may proceed to walk a user through, step-by-step, the congruous configuring/pairing of the wireless controller 1601 with the respective soft interface(s) for purposes of control or manipulation of an actionable on-screen object or object plurality and/or an actionable soft input deemed fundamental to a controller environment. Pairing, exempli gratia, occurs by virtue of mapped electronic actuation at a targeted soft coordinate by virtue of an input controller influence, by any means serviceable, in the broad context of the inventive discourse. Any serviceable means, as a case in point, may include, but is not limited to, a screen-capture method disclosed herein where a given screen in a controller environment is scanned for soft-buttons so that wireless controller inputs can be mapped to congruous actionable soft-buttons.

The app-based, input/output mapping interface 1600, as noted, may run co-dependently with a third-party app, such as an action game or RPG, and upon launch is acclimated for wireless integrative control by initially proceeding to do a screen capture of the current soft-button controller 1603 layout and/or environment required for operational use (certain gaming titles may also be programmed with mapping code that an input/output mapping interface 1600 may interpolate to simplify this task without requiring facilitative methods such as the screen-capture method). Under the described screen-capture method, in accordance to this exemplary discourse, all graphics displayed on a touchscreen 1602 may be subjected to, for example, a “line-drawing filter” (not under illustration) being applied—thus, clearly rendering the respective shape of all touchscreen graphics including a soft-button controller system 1603 for manual selection in the configuration process—to facilitate mapping entries for soft-button engagement. Since each soft-button of a soft-button controller 1603 interface may be readily delineated by this form of capture—for example, through the presentation of a plurality of four-line (or “empty”) squares parsed by the filter and representing the touchscreen's 1602 soft-button controller 1603—it may serve to facilitate fluency in electronic mapping.

Furthermore, under certain iterations, said parsed squares may also repeatedly shrink and expand in size or assume an appearance of “flashing” in their fixed position (perhaps upon user selection as a soft-button mapping component) to indicate they are registered as actionable and are awaiting formal pairing to an associated wireless controller 1601. Upon an indication of flashing, the user may, in further exemplary discourse, then proceed to tap each of the respective flashing squares of the soft-buttons 1603 assigned for control, one at a time, and as each is tapped the user is instructed to press the correspondent button on the wireless controller 1601 to where a wireless signal is then instantly sent from the wireless controller 1601 to the touchscreen user device 1602 for respective soft-button “locking”. Controller directives may be subjected to processing by a central control unit (of the touchscreen user device 1602, the wireless controller 1601 or both) and the app-based, input/output mapping interface 1600 software in the process of “locking” controller directives between the wireless controller 1601 disposition and the application's soft-button disposition (for controller influence of an actionable object or object plurality on a touchscreen). In yet another serviceable embodiment, serving to suggest breadth and scope to task, a software-based input/output mapping interface 1600 may also compartmentalize the touchscreen into a comprehensive array of tiled squares (a uniform pattern of disposition [a form of “virtual matrix”] that may assume, for instance, a tile size proximal to the width of a finger tip or the size of a traditional soft-icon or the icon of an app in a traditional virtual arrangement) to facilitate comprehensive coverage of all salient screen domain of an associated touchscreen user device for mapping delivery (for the intent and purpose of remotely manipulating an onscreen actionable object, with all nodules, in their entirety, providing for a comprehensive screen-mapping interface). In this way, as a virtual grid is established, a facilitative environment for mapping and virtual actuation by precise coordinate (representing a manually-selected tile addressed to a soft-button and matching controller input, for instance) is established, in the spirit and scope of this discourse. Furthermore, for games requiring limited soft-button functionality, exempli gratia, an input/output mapping interface 1600 may replace the traditional soft-button interface and/layout, with its own custom interface, so for games involving commands such as jumping, any place on the touchscreen may be mobilized to act as the jump command in place of the standard soft-button.

Moreover, beyond the suggested influence of an actionable on-screen object by electronic pairing and “actuation”, the wireless input controller 1601 may also comprise its own electronic sensors, including, but not limited to: proximity, accelerometer, magnetometer and device-positioning and motion sensors, such as a gyroscope, under the management of an integrated circuit. In this way, a much more comprehensive mapping system may be possible. Sensor-derived directives may, for example, be relayed to an associated microcontroller assembly for the transmission of a comprehensive derivation of input directives to an equipped touchscreen user device 1602 and its associated input/output mapping interface 1600 (a software iteration) for related processing. A physical controller embodiment is thus able to advance a “reflex” response, termed by the inventor as “comprehensive-gesture mimicking”, for the faithful translation of a detailed physical gesture into a virtual environment for touchscreens. Thus, sensor responses (e.g. the influencing of a sensor input) of a wireless controller 1601 can be virtually mapped to corresponding sensor responses (e.g. the reciprocal influencing of a sensor input) of a touchscreen user device, such that, for example, rotational acceleration of the wireless controller 1601 is mapped to and interpreted as rotational acceleration of the touchscreen user device (without suggestion of limitation in sensor mapping). Accelerometer controls for a racing-themed app, for instance, and without suggestion of limitation, can be influenced remotely by pairing an equipped wireless input controller 1601 with accelerometer and an app-based, input/output mapping interface 1600, or directly to the race-themed app itself in divergent iterations, for virtual accelerometer mapping in real-time. The result is remote and ground-breaking wireless controller 1601 influence of, or interaction with, a touchscreen user device 1602 and each of its responsive control sensors, such as, but not limited to, the accelerometer, gyroscope, magnetometer, proximity, orientation and/or any serviceable touchscreen-based sensor capable of being virtually mapped in the spirit and scope of this discourse. Divergent embodiments may suggest a method and assembly of “X” virtual mapping, where wireless controller-based sensor “X” of a wireless controller 1601 device (suggesting divergence and breadth beyond the accelerometer-based sensor theme according to this exemplary discourse) is virtually mapped to a touchscreen-based sensor “X”, a wireless input controller's 1601 remote, “twin” sensor, for additional remote touchscreen-controller empowerment.

The wireless input controller 1601 may further comprise its own touchscreen and/or touchpad interface 1604, each being fully fluent in touch/tap gesture recognition, as an additional type of remote modal influence of a soft-input or soft-interface on a touchscreen user device 1602 (for example, in the manipulation of a soft-button interface and/or pointer by virtue of manipulation of a wireless input controller 1601). Once all active soft-buttons 1603 and germane configurations are associatively paired, in accordance with an embodiment, a user may commence game play for more precise control under an operational controller. Furthermore, under certain operating scenarios, a system may be introduced where visual and tactical mapping occurs instantly since a wireless input controller's 1601 touchscreen, in exemplary discourse, may see the verbatim output of a remote touchscreen user device and since all germane inputs (including soft and hardware-based sensors) may be communicably tethered, in a mirror-like mapping footprint shared between the paired devices, it may promote the one-to-one influence of all germane input requirements of a game, remotely, by virtue of respective manipulation of a wireless input controller 1601. And considering the actionable soft-buttons of a touchscreen user device may be correlatively present in a mirror-like rendering on the individual touchscreen of the wireless input controller 1601, a user may thus control an actionable object from both a physical button interface and by targeted touchscreen association. Users may appreciate the convenience and level of control robustness in a specialty touchscreen controller that combines a touchscreen interface with, for instance, the physical control elements associated with a traditional gaming console's input controller in a complement of mapping harmony.

Introducing a kindred embodiment that moreover describes a wireless input controller 1601 with its own touchscreen and/or touchpad 1604 surface, the inventor describes a two-ring system of remote finger and/or finger plurality input, such as a system designed for the remote reproduction of a finger swipe and/or tactical actuation of a targeted screen coordinate (e.g. a particular soft-button). In accordance with a disposition of such a controller environment, a two-ring graphical iteration may be injected into a touchscreen's virtual rendering—exempli gratia, a singular graphical ring may be inserted into both corners (hence the expression of a two-ring system, with each ring potentially associated with a left and right hand, respectively, as an example, without suggestion of limitation) of a graphical display and each ring being prone to manipulable influence by a respective finger across both a touchscreen and touchpad surface in analogous fashion. Therefore, in building further still by example, if a user was targeting a soft-button on the left-hand side of a touchscreen, a user may simply place a finger of his left-hand (most proximal) on the left-hand side of the touchscreen or touchpad interface associated with the wireless input controller 1601, thus controllably engaging the left virtual ring respectively. Upon initial ring engagement, the user may then proceed to manipulate the virtual ring until it is superimposed over a touchscreen area a user intends to actuate with his fingers (remotely). Once the intended superimposition is achieved, without suggestion of limitation, a user may simply lift and then quickly retouch his or her finger in a proximal area of a touchpad or touchscreen to indicate intended actuation at the presence of the ring. The two-rings may be virtually tethered to a memory-return system according to a timer, if so coveted, that sees each ring return to a position of rest at the corners once a user has completed actuation and/or may see rings remain in position and be “teleported” to a new location upon new finger placement (or have the ring digitally be removed temporarily until re-activation by the control input of a finger), although such examples in no way intend to suggest limitation and any serviceable system, in the spirit and scope of this discourse, may serve as descriptive fodder to a touchscreen controller embodiment. For attachment-based interfaces injected in an akin controller environment, an innate capacitive source and capacitive manager may be employed where influence of a wireless input controller's 1601 independent touchscreen, for instance, influences the capacitive manger to replicate a “mirrored” capacitive discharge at a targeted point of actuation in the spirit and scope of the inventive discourse.

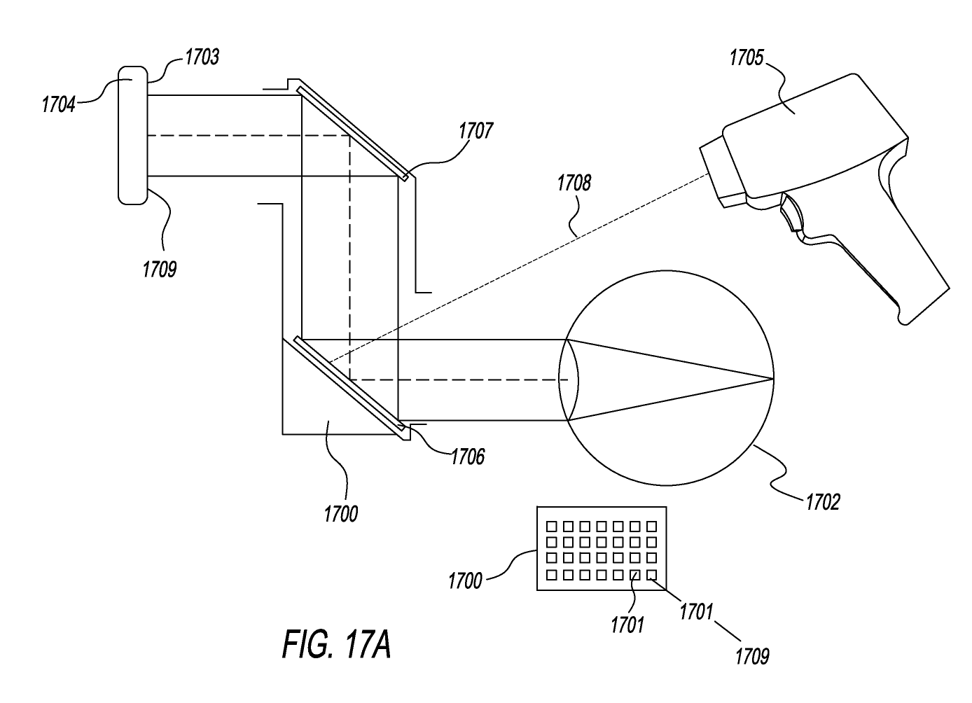

FIGS. 17 and 17A illustrate a plurality of light-gun and/or akin specialty input controllers transitionally designed for touchscreen operation, including a “micro-capture” or (finite) screen-capturing device. A linked (“line-of-sight”) specialty-input controller may be designed primarily for the manipulation of actionable on-screen objects in a touchscreen environment. The “micro-capture” or (finite) screen-capturing device, exempli gratia, serves as a specialty input controller and is used for articulated touchscreen registration of a communicable directive or directive plurality (by remote influence) upon broadcast engagement. An aimer-controller assembly for actionable-objects 170 is shown interposed into a touchscreen 171 environment, in accordance with an embodiment. An aimer controller for actionable-objects 170, serving as a touchscreen-input device or controller input, may represent a lightweight plastic controller comprising a processor, wireless transmitter and an image-capture device 172 such as a digital camera 172 equipped with an extremely narrow viewfinder frame. By design, the viewfinder frame may only be capable of capturing a very limited image (for instance, a small section of the active touchscreen display of a touchscreen user device 171 to which it is pointedly cast), with said viewfinder image positionally influenced by directing the focal point 173 or lens of the aimer controller for actionable-objects 170 in a prelude to screen capture, as per this exemplary discourse. As an aimer controller for actionable-objects 170, for instance, is wirelessly paired to a touchscreen user device 171 featuring a compatible game title (and/or under the autonomous ascendency of virtual mapping software, thus extensively broadening game compatibility of the aimer controller assembly for actionable-objects 170), upon user engagement of a projecting tongue or trigger 174 at the handle top of an aimer controller for actionable-objects 170, a wireless directive is instantly transmitted to the touchscreen user device causing the display image on the touchscreen to rapidly flash an alphanumeric rendering (without suggestion of limitation) uniquely identifiable to a specific touchscreen location. In further description, upon application of a trigger 174, the rendered output of a touchscreen sees an alphanumeric rendering instantly flashed by either the engaged game and/or mapping software (at a fraction of a second, an interval not even discerned by the user) across an entire touchscreen for related processing. To better facilitate reader understanding, without suggestion of limitation, an example rendering may comprise the following: “a1a2a3a4a5a6a7a8a9a10b1b2b3b4b5b6b7b8b9b10 . . . z1z2z3z4z5z6z7z8z9z10” for parsing. An encompassing flash rendering such as this is immediately classified into screen coordinates for related processing and, in conjunction with the simultaneously captured snippet image of a limited geographically-identifiable alphanumeric rendering by an aimer controller for actionable-objects 170, a process of cross-referencing occurs instantly to determine an exact location captured on a touchscreen 171, thereby allowing any mapping software program present on the touchscreen user device 171, exempli gratia, to manipulate and/or engage an actionable-object at a highly precise captured location (that “photographed” or captured by the limited viewfinder of the aimer-controller device 170) on the touchscreen 171, accordingly, during the course of game play.

To expand on this discourse further, if an aimer controller for actionable-objects 170 pointed at a touchscreen user device 171 captures, as an example, the flashed (again, injected at a rate imperceptible to the human eye) digital-image snippet 7a or z7 of the alphanumeric rendering noted in the embodiment herein (reiteratively, the image captured within the limited range of the viewfinder, the determination of which will serve as precise coordinates of a touchscreen 171 capture) upon trigger 174 application, the aimer controller for actionable-objects 170 will then wirelessly transmit these captured coordinates instantly to the touchscreen user device 171 for related processing and respective electronic “actuation” or actionable touchscreen-coordinate engagement at point of capture. The premise of electronic “actuation” may be precisely managed, without suggestion of limitation, under the collaborative virtual mapping software being run on the touchscreen user device 171. Furthermore, an aimer controller for actionable-objects 170's driver software and/or mapping software (that may be present in either of the paired hardware devices and/or both, in the case of an input controller, more particularly still the input mapping software) may be, for example, programmed to consider screen-size determination and distance between the input device (an aimer controller for actionable-objects 170) and touchscreen user device 171 to best assess the pattern of pixilation produced by the image capture results (of the flashed rendering) upon trigger activation. OCR software may also be incorporated into the aimer controller for actionable-objects 170, touchscreen user device 171 and/or both devices, amongst other means serviceable, to assist with parsing the screen capture (digital image) into precise coordinates for the accurate wireless relay of mapping directives to a touchscreen user device 171.

For those gamers seeking potentially greater compatibility and breadth across a variety of platforms and operating systems with less of an onus on software compatibility and/or calibration requirements, the inventor discloses a further iteration—the subject of FIG. 17A—in an effort to address greater controller independence and freedom of operation. According to an aimer controller for actionable-objects' variant to that disclosed above, as additionally transitioned to a video-game environment for touchscreen interfaces, a receiving device and related disposition assembly for touchscreens is introduced comprising an infrared-sensor plurality (such as a plurality of photodiodes) designed to collaborate with an infrared emitter comprising a touchscreen-input device, such as a light gun designed for casting against the surface of a receiving device that is capable of coordinate detection of a projected light beam.

A receiving device 1700 and related assembly comprising an infrared-sensor 1701 plurality, in accordance with this exemplary discourse, is preferably sized in a way that conspicuous remote viewing 1702—such as that occurring from across the living room floor—by a user is possible. The infrared-sensors 1701 of the sensor plurality 1701 may be divided in a pattern of even distribution across the entire receiving device's 1700 surface area, in a manner that may, for example, departmentalize each sensor 1701 to proximate a “finger-span” size in order to effectively manage (and prepare for associative touchscreen mapping) the entire surface area of the receiving device 1700 for correlative touchscreen 1703 actuation by electronic association. A serviceable communicable system of coordinate mapping between the receiving device 1700 and the touchscreen user device 1704, in response to a manipulated controller input of a light gun 1705, may comprise a system of software-driven electronic association or electronic “actuation”. Across the face of the entire receiving device 1700, in a proximal manner, an acrylic (break-resistant) mirror 1706—capable of transmitting, or traversing through the mirror depth in its entirety, controller-born input 1705 communications such as an aimed light projection beam or light-beam casting by a light gun 1705—may be securely positioned. The broadcast image of the touchscreen user device 1704 is positionally manipulated such that it reflects first onto an intermediary relay mirror 1707, prone to angular manipulation, in such a manner that the relay mirror then reflects the broadcast image back (represented by the lines) onto said acrylic mirror 1706 encasing the face of the receiving device 1700 in a vantage that is shown right-side up to the user. In this way, a user will see the exact rendering—overcoming the properties of reflection according to its design—of the touchscreen's 1703 broadcast on the acrylic mirror's 1706 surface, and thus, be able to cast an infrared beam “directly” onto a game's broadcast-image rendering at its reflection point on the acrylic mirror 1706 surface (which of course, for repeated emphasis, permits a cast infrared-light beam to traverse through the mirror depth to the respective infrared sensors 1701 immediately below the acrylic mirror's 1706 surface, thereby permitting sensing of a coordinate input for the related manipulation of an actionable object accordingly).

Management of a coordinate input under a microcontroller influence of the functional receiving device 1700, in the spirit and scope of this discourse, permits identical coordinate actuation directives (e.g. a precise touchscreen 1703 mapping point) to be relayed to a touchscreen user device 1704 for appropriate response to an input controller 1705 signal for purposes of manipulating an onscreen actionable object. A carnival game, for instance, with a plurality of tin cans strewn across a line on its display screen 1703, may see a can knocked off its mooring if its position represents the coordinate point captured by the receiving device 1700 (and transmitted for action—that is, virtual actuation—to a touchscreen user device 1704). Identical touchscreen mapping, according to this broadening iteration, is premised on the communicability (for example, in a wholly wireless disposition) between the various hardware components present and any engaged software component(s) responsible for faithful input-gesture 1708 translation to a touchscreen user device 1704 from the initial cast 1708 (a form of input) to an electronic actionable-mapping or virtual “discharge” (virtual actuation at a respective soft-button coordinate input 1709, for instance) for the intended manipulation of an actionable object.

According to an analogous iteration describing transitional adaptation to a touchscreen, an infrared-light emitter station (placed proximal to a touchscreen user device, contrasting its kindred embodiment) comprising an infrared light emitter plurality is used. The infrared-light emitter station, upon broadcast, may collaboratively engage one or more remote infrared sensor(s)—such as a photodiode—and a distribution of one or more angle sensor(s) contained in the muzzle of a specialty controller (a touchscreen-input device), such as a light gun described. As a trigger is depressed on the light gun, for instance, the intensity of an incoming IR beam projection, exempli gratia, may be detected by the engaged infrared (e.g. photodiode) and angle sensor(s) in the light gun muzzle responsible for surveying a coordinate origination. Since intensity is based on factors such as angulation and distance from the infrared-light emitter station, the present method and assembly described leverages a solved trigonometric-equation system for calculating light-gun positioning relative to an infrared-light emitter station. Once respective angles of a broadcast agent (the infrared light projection) are determined by the angle sensors, as an infrared sensor receives an incidence of projection from the infrared light-emitter station, for example, a point of impact of an applied beam projecting from the infrared-light emitter station is electronically calculated and transmitted wirelessly for correlative touchscreen actuation, virtually, in the spirit and scope of this discourse.

Light-gun muzzles comprising one or more photodiodes may also be injected into a touchscreen gaming environment such that upon depression of a light gun trigger, for example, the touchscreen may be instantly blanked out (also occurring at a rate imperceptible to a touchscreen user) to a black base wherein the diode then begins detection of an engaged rolling or digitally “painted” line of white that begins systematically traversing the entirety of the touchscreen and, thus, triggering the diode at a registration point in the course of traversal of said digitally painted “white scroll” (a registered point when the diode detects light subjected to it by the presence of this “white scroll”), the exact timing of this detection which is processed for related touchscreen orientation and virtual actuation of an actionable on-screen object at the point of mapping. A method deploying ultrasonic sensors, for instance, in place of IR emitters, may also be serviceable to this discourse and those skilled in the art will appreciate the broader implications of this embodiment in its transitionary discourse to a touchscreen environment. Where impact-point precision is of less importance, designs may be adopted where angle detectors are instead replaced by, for instance, a quantity of 4 IR sensors for related integration. Furthermore, 3 or more IR emitters, each with varying wavelengths and paired with the same quantity of sensors, are variants to this discourse that allow for angle determination relative to the 3 or more emitters (with 3 emitters, 3 angles are processed) upon calibration and can be further adapted for integration into a touchscreen environment, although such articulation in this paragraph is not accompanied by illustration.

And in a further suggestion of breadth and scope to the associated discourse in transitioning a gun input controller to a touchscreen environment, a light gun may be further transitioned to a touchscreen environment such that the tip or muzzle of a light-gun controller may be subjected to camera-based tracking by an equipped touchscreen user device and its associated mapping software; such that as a communicative signal is received upon trigger depression by the user, the orientation of a light-gun pointer on the touchscreen (subject to said camera-based tracking) is calculated and a virtual “actuation” signal is applied at the coordinate of calculated orientation by the mapping-software component. Parenting the aim of an equipped tracking camera (or the camera itself) to an object (such as the tip of the light gun or muzzle), and/or by engaging a camera-lock on feature, may also prove useful for tracking and integrative-mapping purposes under certain operating conditions. Furthermore, a camera equipped with any serviceable camera-tracking and motion-tracking ability for objects, including a system that attaches a set of tracking markers to an object, such as the muzzle of a light gun, prime for optical tracking (and a trigonometric equation system capable of geometric positioning and orientation of a trackable object if germane to a gaming environment) is within the spirit and scope of this discourse. Such a method and assembly of course, is fodder for a system equally adept at fully tracking a user (in his or her entirety) and/or a user's fingers and/or hands for purposes of gesture-based mapping, motion-based mapping and/or virtual or electronic “actuation” of an actionable object at a mapped point—as manipulated by a respective gesture or gesture plurality of a user—present in a touchscreen controller environment.

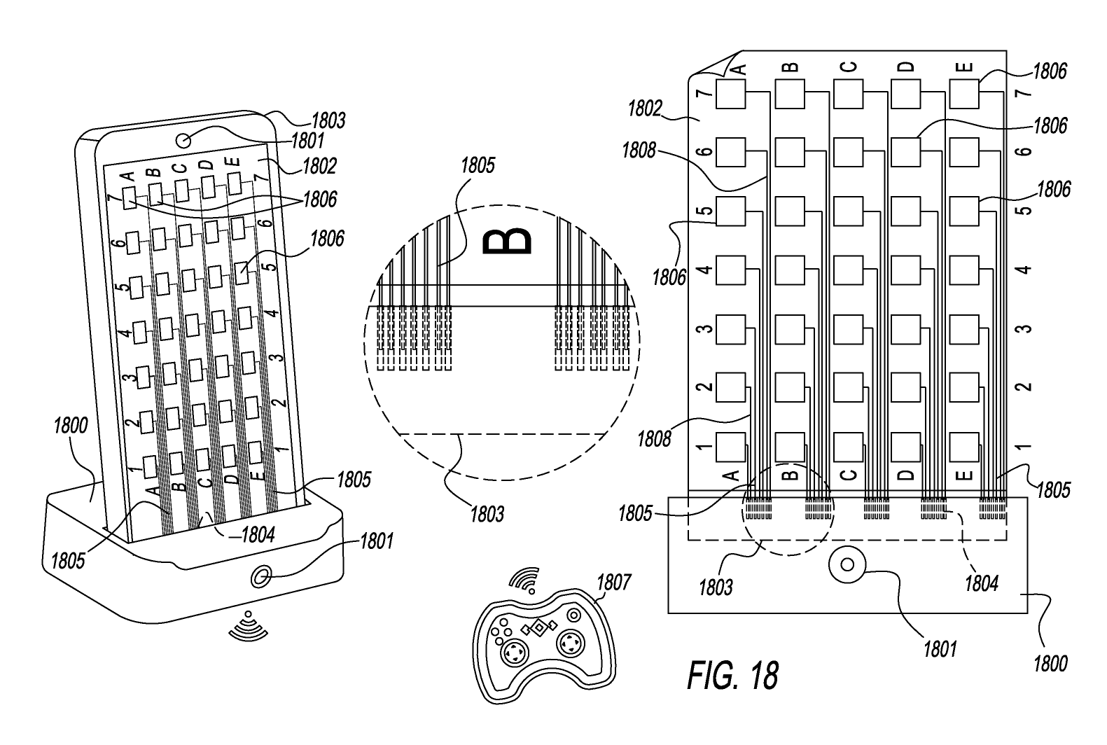

For more detailed information concerning the integral subject matter of ITO deployment in the spirit and scope of the following variant mapping system, the reader may refer to FIG. 18 and the discussion set forth therein. Disposition of a variant mapping system that does not rely on virtual “actuation” of an actionable touchscreen object and instead relies on a physical capacitive source is also complementarily added to the thematic discourse herein. Although respective actuation may occur by any means serviceable in the spirit and scope of this discourse, such embodiments fluently honour a conductive path with the introduction of a capacitive-discharge overlay and related assembly, where a thin, transparent overlay (that may be subjected to verbatim layering) sees an initial application of a transparent Indium-tin oxide coating on both its face and rear surface (to ensure conductivity throughout the overlay in only the areas coated with ITO at a matching or duplicate top-and-bottom point) in an arrangement that equally departmentalizes (an assembly of equal parts with the adjacent borders serving as insulation) the capacitive-discharge overlay for fluent touchscreen assimilation across all salient screen domain. Communicably bordering, from a coated tether maintained throughout, the initial application of transparent Indium-tin oxide coatings (the assembly of squares or “tiles” responsible for capacitive discharge) are a separate subset of conductive coatings or channels conjoinedly applied to each ITO deployment on the upper surface of the overlay only (to safeguard against unintended transmission, that is, transmission of a capacitive charge through the capacitive-discharge overlay and onto a touchscreen, along an entire (engaged) conductive path traversing the touchscreen). By design then, only the areas intended for transmission of a capacitive charge, such as an Indium-tin oxide (ITO) coating or element tile associated with a coordinate on the touchscreen area being targeted for capacitive discharge, are engaged as a conductive path traverses intently along the subset conductive coating or channel (of a capacitive-discharge overlay) of the enlisted capacitive network at its coated surface (said differently, the subset represents the transmission path prior to conclusion and occurs adjacent to a touchscreen upon overlay attachment) to a targeted touchscreen conclusion at the respective tile intersection. In short, the only point of realized actuation (by capacitive discharge) that occurs as an engaged conductive path traverses the entire conductive channel of a capacitive-discharge overlay is at a targeted “tile” member or associative element. The reader notes tile visibility in the associated figures is for illustrative purposes only and is intended to serve in the promotion of understanding; said tiles (and channeling) are imperceptible in practice due to their coated transparent nature.

A small intermediary-transceiver device, in adding colour by example, is embedded in a receiving device present in a controller environment and exists communicably paired, by any serviceable means, with an aimer controller for actionable-objects 170, in a preferred supplement to the thematic discourse above. The small intermediary-transceiver device, in concert with its coupled capacitive-discharge overlay, is able to fluently honour a conductive path from an ITO origin (or tile) up to and including an exit point at the bottom of the capacitive-discharge overlay since the capacitive-discharge overlay sits communicably nested in a homologous capacitive-distribution centre (e.g. an exemplary sleeve comprising a conductive pin assembly) found at its base. Once an input directive, for example, from an aimer controller for actionable-objects 170, is registered by one or more receptive sensors of the receiving device with embedded intermediary-transceiver device (along with one or more associated microcontroller unit[s]), a capacitive charge may be supplied or relayed to a pin's “exit” point (now serving as the engagement point at the capacitive-discharge overlay's base, particularly comprising the respective conductive coating or channel conjoinedly enlisted for targeted ITO deployment by said pin) for the intended manipulation of an actionable soft-object in a touchscreen-controller environment. The small intermediary-transceiver device comprises a capacitive manager and is capable of recurrently furnishing an innate capacitive supply in the spirit and scope of this discourse. The related teachings of this speciality-controller impetus, also lend well to a potential wired light-gun variant with attachment, under a prescribed method and assembly, that falls within the breadth and scope of this discourse. And while any physical-interface attachment assembly within the limits of the intellectual property footprint put forth by the inventor, where coveted and serviceable, may be interchanged with a kindred wireless variant that remains wholly attachmentless, the breadth and scope of all controller assemblies and associated physical and/or virtual mapping interfaces remain material to a discussion. Further, any controller assembly within the limits of the inventive disclosure, where coveted, may be modified for integration by virtue of a dock-connector pin system of the dock-connector assembly of a touchscreen user device in a manner that is directly attachable, engaged by wire or cable extension and/or wirelessly by a serviceable and/or paired coupler.

FIG. 18 illustrates, in accordance with an embodiment, a small intermediary-transceiver device 1800 assembly with camera 1801, male-dock connector and capacitive-discharge overlay socket 1804 for the housing of an attachable capacitive-discharge overlay 1802. The small intermediary-transceiver device 1800, primarily functioning, in the aggregate, for the dual purpose of docking a touchscreen user device 1803 to be used as a modal power source and in the controlling of an actionable object rendered on the touchscreen of a touchscreen user device 1803, remotely, by substantive virtue of: a serviceable male dock-connector assembly (not illustrated) to which a touchscreen user device 1803 sits securely attached; a capacitive-discharge overlay socket 1804 to which a capacitive-discharge overlay 1802 is received for relay of a targeted capacitive discharge both governed and furnished by said small intermediary-transceiver device 1800; and a communicable input device or device plurality 1801, 1807 with associated mapping software. The small intermediary-transceiver device 1800 with camera 1801 and male-dock connector interface is designed to receive controller input directives, wirelessly from a communicable input device or device plurality 1801, 1807, and then leverage an innate capacitive source, capacitive manager and mounted communicable appendage (the attachable capacitive-discharge overlay 1802) to faithfully reproduce an input sequence for serviceable actuation.

The small intermediary-transceiver device 1800 with camera 1801 and the capacitive-discharge overlay socket 1804 may be integrated, by a wiring scheme, to the dock-connector pin system of the male-dock connector assembly for sourcing power from a voltage source (e.g. a seated touchscreen user device 1803) or a current source (furnished by an optional electrical socket-based corded assembly). The male dock-connector assembly receiving the touchscreen user device 1803, for instance, comprises a dock-connector pinout assembly and is wired in a manner, such that, the ground and voltage pins—along with an appropriate resistor—may be engaged in a circuit upon the docking of a touchscreen user device 1803. Thus, the associative wiring scheme is designed with the primary objective of a docked touchscreen user device 1803 powering the small intermediary-transceiver device 1800 with camera 1801. In alternate iterations, of course, the pinout assembly responsible for providing power, under this embodiment, may be subject to change and/or replacement by an alternate power supply.

The associated camera 1801 of the small intermediary-transceiver device 1800 (or, in variant embodiments, tracking by an associated camera 1801 may be limited to those associated camera's 1801 embodying a touchscreen user device 1803 with a system of mapping in place) is capable of fluently tracking, for instance, an accredited finger, hand-based and/or body gesture and may remain under the management of a microcontroller central to the small intermediary-transceiver device 1800. The associated camera 1801, may, for instance, amongst an expansive list of other accredited input-gestures, be capable of tracking a finger swipe, an articulated finger input or input plurality, directional gesture and/or a targeted engagement of touch (to actuate a soft-button, for instance) motioned within a “capture zone”, to name a few possible implementations. A “capture zone” refers to the given range of the viewfinder associated with a camera-tracking system responsible for the objective of motion-input determination. Advancing the discussion further, upon the tracking of accredited input directives based on camera-discerned motion input, the capacitive manager of the small intermediary-transceiver device 1800 with camera 1801 enlists an innately-supplied capacitive charge for relay to a correlative exit point 1805 tether of the capacitive-discharge overlay 1802. The relay of an innately-supplied capacitive charge serviceable to this embodiment, of course, occurs by virtue of the capacitive-discharge overlay 1802 being contactually inserted into the integrated capacitive-discharge overlay socket 1804 with pin configuration—with each pin being capable of distributing a capacitive charge.

The capacitive-discharge overlay 1802 is designed whereas a thin, transparent overlay sees an initial application of an Indium-tin oxide (ITO) coating 1806 on both its face and rear surface (to ensure element conductivity throughout the overlay upon layering only in the areas treated or coated with the ITO) in an arrangement that may equally departmentalize (an assembly of equal parts or “tiles”, with adjacent borders serving as insulation) the capacitive-discharge overlay 1802 for fluent touchscreen assimilation across all salient screen domain. Communicably bordering, from a coated tether maintained throughout, the initial application or set of ITO coatings 1806 (the assembly of squares or “tiles” responsible for capacitive discharge) are a separate subset of conductive coatings or channels 1808 conjoinedly applied to each ITO deployment 1806 on the upper surface of the overlay only (to safeguard against unintended transmission, that is, transmission of a capacitive charge through the capacitive-discharge overlay 1802 and onto a touchscreen, along an entire engaged conductive path traversing the touchscreen). By design, only the areas intended for transmission of a capacitive charge, such as an Indium-tin oxide (ITO) coated 1806 tile or element associated with a coordinate on the touchscreen area being targeted for capacitive discharge, will be engaged as the conductive path is traversed intently along the network's 1808 surface (by virtue of channeled routing along the upper surface of the overlay 1802) of a capacitive-discharge overlay 1802, attached to a touchscreen, to a targeted touchscreen conclusion. Said differently, the only point of realized actuation (by capacitive discharge) that occurs as a conductive charge traverses the entire summoned conductive channel or path 1808 of a capacitive-discharge overlay 1802 is at a targeted “tile” member or associative element. Targeting determination may be based on, for instance, the manipulation of a wireless input controller 1807 or accredited camera gesture, this according to the present embodiment and not being suggestive of limitation. Said differently, the processing of input directives of an associated wireless input controller 1807 may be replaced and/or supplemented with the processing of input directives associated with an associated camera 1801.

Upon actuation of a prescribed conductive channel 1808 with a targeted capacitive-charge distribution by associative pin disposition (reiteratively, by virtue of the conductive alignment between the exit points 1805—serviceably comprised of a tethered conductive coating—of a capacitive-discharge overlay 1802 and the distribution pins of a capacitive-discharge overlay socket 1804), a targeted domain on the touchscreen of a touchscreen user device 1803 is thereby actuated. The precise targeted domain being dependent on the particular routed network 1805 of the capacitive-discharge overlay 1802 (an overlay actings as a physical output interface to a soft input) that was summoned in reference to its communicable tile 1806 association. A distribution element or “tile” 1806 enlisted for engagement of a targeted domain, resides amongst a comprehensive disposition array of tiled elements 1806 comprising the capacitive-discharge overlay 1802 and has its entire network (from path to tile initially engaged at an exit point) skillfully managed by the microprocessor and coupled capacitive manager of the small intermediary-transceiver device 1800, without suggestion of limitation. The targeted domain (or strategic points of capacitive distribution) may be, for instance, points associated with finger-based input tracking such as a swipe, tap or akin accredited gesture processed through the camera lens of an associated camera 1801, to name a few. The potential of commanding controller liberation by virtue of an independent state of remote controller use avails under such an embodiment, even potentially displacing the need for a virtual mapping component (e.g. the described ITO-based system of physical-capacitance delivery originating from use of a small intermediary-transceiver device 1800 in conjunction with a wireless input controller 1601 of FIG. 16 with its own touchscreen and/or touchpad 1604 interface), regardless of the manner of controller disposition. Mindful of that, actionable-object mapping based on the conductive network of a capacitive-discharge overlay 1802, may, of course, be replaced with electronic or virtual mapping supplied by an associated software program running, exempli gratia, on a touchscreen user device 1803, if so demanded in a controller environment. Mapping-based software, for instance, may inject a digital orientation point, such as a cross-hair or on-screen pointer that may be manipulated by a wireless input controller 1807, or conversely, the potential jettisoning of the need for an orientation point by virtue of pre-assigned mapping of all necessary soft-buttons in synchronized relation to the input buttons of a wireless input controller 1807. Orientation points could, of course, also be influenced by accredited camera gestures in a related controller environment and/or direct touchscreen-to-touchscreen mapping influence. This embodiment, or any stipulated in this application, for that matter, is not in any propensity suggestive of limitation.

The small intermediary-transceiver device 1800, in concert with its coupled capacitive-discharge overlay 1802, are able to fluently honour a conductive path from the ITO origin 1806 up to and including an exit point 1805 at the bottom of the capacitive-discharge overlay 1802. Once input directives of a wireless input controller 1807 are determined by the microcontroller unit of the small intermediary-transceiver device 1800, for instance, a capacitive charge may be supplied or relayed to an exit point 1805 (with the “exit” point actually serving as the engagement point of a quantity of relayed capacitance or capacitive charge furnished by a small intermediary-transceiver device 1800) of the capacitive-discharge overlay 1802—also referred to previously as a thin, transparent overlay—communicably networked 1808 or linked 1808 to an Indium-tin oxide (ITO) tile coating 1806 element. A method and assembly thus permitting an induced conductive path to be strategically honoured and manipulated from a position of remote operation. A small intermediary-transceiver device 1800 with camera 1801 and attachable capacitive-discharge overlay 1802 may further be embedded into a display device, such as a HDTV, for direct touchscreen engagement of the touchscreen TV (and/or associated touchscreen user device 1803 linked by Component AV cables).

Under this exemplary operating scenario, without suggestion of limitation and prescribed input mechanics, whereas if a swipe gesture in an input cycle is determined by camera 1801 to occur at the bottom, right-hand corner of a framed capture range, for example, a capacitive charge may then be deployed (for related actuation) by the small intermediary-transceiver device 1800 along a designated conductive path to an ITO-coating tile 1806 or conclusion element (the targeted square or square plurality in a series) associated with the bottom, right-hand corner of the touchscreen. An HDTV may serve, in a further instance of operability breadth and scope, as “a trackpad” of sorts, where the camera's viewfinder maps an omnidirectional range in proximity to the location in which a user is standing that is associated with “framing a gesture”, which in this exemplary discourse may rely on remotely using the actual HDTV screen as the frame or “canvas” in which a user may conduct gestures for associative mapping. Directional inclination may be mapped based on proximate gesture and then translated to, for instance, an HDTV in real-time either by wire and/or wirelessly or, in the case of operating scenarios involving both a mobile touchscreen device, such as smart phone or tablet, and an HDTV, where a touchscreen user device's output may then be updated to the associated HDTV in real-time. Of course, a similar method of tracking and engagement could be transitioned for use without the use of an intermediary-transceiver device 1800 where the associated camera 1801 of a user device is instead engaged (or in addition to a transceiver device) and a serviceable introduction of co-ordinate tracking and mapping software on the user device is introduced for purposes of manipulating an on-screen actionable object. An infrared video camera, in another example suggesting both breadth and scope, can also be integrated into a system of gesture input where a plurality of stretchable finger caps or thimbles, for example, are introduced; where said caps may be designed to radiate a quantity of serviceable heat emission for a progressive means of tagging a finger-based gesture input.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface such as a capacitive-discharge overlay 1802.

Embodiments herein are directed to systems, devices and methods for liberating the input function of soft-button controllers (graphical representations that are engaged by—or respond to—the control input of a finger in order to carry out a function) and/or any respective soft key or keys and/or graphical representations situated on a capacitive touchscreen, particularly; in both stationary and portable devices. The disclosures herein are provided to lend instance to the operation and methodology of the various embodiments and are neither intended to suggest limitation in breadth or scope, nor to suggest limitation to the claims appended hereto. Furthermore, such exemplary embodiments may be applicable to all suitable touchscreen-hardware platforms (tablets, smart phones, monitors, televisions, point-of-display, etceteras) and can also include all suitable touchscreen technologies, beyond capacitive and capacitance governed, such as those inclined with resistive touchscreens that, too, respond to touch input, albeit with its own peculiarities related to the technology. Those skilled in the art will understand and appreciate the actuality of variations, combinations and equivalents of the specific embodiments, methods and examples listed herein.

The embodiment(s) described, and any references in the specification to “one embodiment”, “an embodiment”, “an example embodiment”, et cetera, indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such a feature, structure, or characteristic in connection with other embodiments whether or not explicitly described. A particular feature, structure, or characteristic described in an embodiment may be removed; whilst still preserving the serviceability of an embodiment.

While a functional element may be illustrated as being located within a particular structure, other locations of the functional element are possible. Further, the description of an embodiment and the orientation and layout of an element in a drawing are for illustrative purposes only and are not suggestive of limitation. The embodiments described, and their detailed construction and elements, are merely provided to assist in a comprehensive understanding of the invention. Any description is not to be taken in a limiting sense, but is made merely for the purpose of illustrating the general principles of the invention.

While embodiments may be illustrated using portable devices, the particularity of these embodiments are not limited to application of portable devices and may instead be applied to stationary devices. For purposes of the discussion that follows, the term “user device” can encompass both portable and stationary devices.

While the noted embodiments and accompanying discourse and illustrations of the invention disclosed herein can enable a person skilled in the art (PSITA) to make and use the invention in its detailed exemplary embodiments, a skilled artisan will understand and appreciate the actuality of variations, modifications, combinations, atypical implementations, improvements and equivalents of any of the specific embodiments, methods, illustrations and examples listed herein.

While the present invention has been described with reference to such noted embodiments, methods, illustrations and examples, it is understood by a skilled artisan that the invention is not limited to any of the disclosed embodiments, methods, illustrations and examples, but by all embodiments, methods, illustrations and examples within the spirit and scope of the invention. The scope of the following claims, and the principles and novel features, amongst the discourse herein, is to be accorded the broadest interpretation so as to encompass all modifications, combinations, improvements and equivalent structures and functions.

Any particular terminology describing certain features or aspects of the invention is not suggestive of language restricted to any specific characteristics, features, or aspects of the invention with which that terminology is associated. Furthermore, any reference to claim elements in the singular, for example, using the articles “a,” “an,” or “the,” is not to be construed as limiting the element to the singular.

1. A touchscreen specialty controller apparatus, comprising:
a specialty controller input device comprising one or more inputs and configured to communicate remotely with a touchscreen user device using at least one of wires and wireless signals;
wherein each of the one or more inputs is tethered to a corresponding touchscreen user device input, such that actuation of one of the one or more inputs is consistently translated to actuation of a corresponding touchscreen user device input to control an actionable object displayed on the touchscreen user device.

2. The apparatus of claim 1, wherein the specialty controller input device communicates with the touchscreen user device through an actuating agent, and wherein the actuating agent translates the actuation of the one or more inputs into actuation of corresponding touchscreen user device inputs.

3. The apparatus of claim 1, further comprising a pairing software module running on the touchscreen device, wherein the software module is configured to run concurrently with a software application, determine the location of soft-buttons displayed by the software application, and virtually tie the one or more inputs to the determined soft-buttons.

4. The apparatus of claim 3, wherein the pairing software module is further configured to take screen captures of images displayed by the software application and to use those screen captures to make the soft-button location determination.

5. The apparatus of claim 1, further comprising a gesture-mapping software module configured to communicate with a control input of a camera, track and capture the movements of a user with the camera, analyze captured movements of the user and map them to touchscreen user device inputs.

6. The apparatus of claim 5, wherein the software is further configured to tether captured movements of the user to touchscreen user device inputs.

7. The apparatus of claim 1, wherein the specialty controller input device further comprises one or more independent inputs that are not tethered to a corresponding touchscreen input on the touchscreen user device, but rather offer additional functionality in controlling the actionable object displayed on the touchscreen user device beyond what can be achieved by direct manipulation of the touchscreen.

8. The apparatus of claim 1, wherein the specialty controller input device further comprises one or more input device motion sensors, wherein each of the input device motion sensors is tethered to a corresponding touchscreen user device motion sensor, such that input to the input device motion sensors is processed at the touchscreen user device as input from the corresponding touchscreen user device motion sensors.

9. The apparatus of claim 1, wherein the remote input device comprises a suspension apparatus that suspends the touchscreen user device and an adjustable mount connected to the suspension apparatus to support it in a given position with respect to a surface.

10. The apparatus of claim 9, further comprising a ball joint connecting the suspension apparatus to the mount, wherein the ball joint permits twisting and tilting of the suspension apparatus and suspended touchscreen user device and is biased to automatically return to a neutral position when the touchscreen user device is released from a twisted or tilted position.

11. The apparatus of claim 1, wherein the specialty controller input device is a pointing device and one of the one or more inputs is a trigger, further comprising a software module configured to detect an area on a display of the touchscreen user device that the pointing device is pointed towards when the trigger is actuated, instantaneously tying the trigger input to a touchscreen soft input on the area detected, and mapping the trigger input to the touchscreen soft input on the area detected.

12. The apparatus of claim 11, wherein the software module is further configured to flash a pattern on the touchscreen for a duration undetectable by a human eye when the trigger is actuated, wherein the pointing device comprises a camera that takes an image of the touchscreen with the pattern when the trigger is actuated, and wherein the software module uses the captured image to detect the area on the display of the touchscreen user device that the pointing device is pointed towards.

13. The apparatus of claim 11, further comprising a mirror positioned to receive a reflection of the touchscreen user device and a receiving device positioned behind the mirror and configured to detect infrared light contacting the receiving device, wherein the mirror permits infrared light to pass through it without reflection, wherein the pointing device comprises an infrared light emitter that is activated when the trigger is actuated, wherein the software module uses a response from the receiving device to the infrared light emitted to detect the area on the display of the touchscreen user device that the pointing device is pointed towards.

14. The apparatus of claim 11, further comprising an infrared light emitter station positioned near the touchscreen and configured to emit infrared light when the trigger is actuated, wherein the pointing device comprises a light sensor and angle sensors, wherein the software module uses a response from the light sensor and angle sensors to the infrared light emitted to detect the area on the display of the touchscreen user device that the pointing device is pointed towards.

15. The apparatus of claim 11, wherein the pointing device comprises a light sensor and the software module is further configured to flash a black screen with a white line scrolling across it on the touchscreen for a duration undetectable by a human eye when the trigger is actuated, wherein the software module uses a response from the light sensor to the white line to detect the area on the display of the touchscreen user device that the pointing device is pointed towards.

16. The apparatus of claim 11, wherein the software module is further configured to activate a camera and capture an image of the pointing device when the trigger is actuated, wherein the software module uses the captured image and a position of the camera to detect the area on the display of the touchscreen user device that the pointing device is pointed towards.

17. The apparatus of claim 1, further comprising an additional touchscreen user device and a software module configured to display distinct output of a single graphic rendering to each touchscreen device simultaneously.

18. The apparatus of claim 17, wherein the graphic rendering portion displayed on one of the touchscreen user devices is a rear-view window view for a racing game, and the distinct graphic rendering portion displayed on the other touchscreen user device is a windshield view for the racing game.

19. The apparatus of claim 1, wherein the specialty controller input device is a racing wheel controller assembly.

20. The apparatus of claim 1, wherein the specialty controller input device is a guitar controller, golf club or hockey stick controller, or tennis racket or baseball bat controller.

21. The apparatus of claim 1, wherein the specialty controller input device is a dance pad controller and the one or more inputs comprise areas of the dance pad surface configured for activation by a user's feet.

22. The apparatus of claim 1, wherein the specialty controller input device is a piano interface and the one or more inputs comprise keys of the piano.

23. The apparatus of claim 1, wherein the specialty controller input device is a drum controller and the one or more inputs comprise drum inputs.

24. The apparatus of claim 1, wherein the specialty controller input device is a bowling ball controller.

25. The apparatus of claim 1, wherein the specialty controller input device is a DJ station controller and the one or more inputs comprise at least one of turntable and slider inputs.

26-30. (canceled)

31. The apparatus of claim 1, wherein the corresponding touchscreen user device inputs to which a plurality of the one or more inputs are tethered are each a different soft button displayed on the touchscreen user device.

32. The apparatus of claim 1, wherein the corresponding touchscreen user device inputs and actionable object displayed on the touchscreen user device are implemented by a software application, and wherein the tethering is performed independently of the software application.

33. The apparatus of claim 1, wherein the corresponding touchscreen user device inputs to which a plurality of the one or more inputs are tethered are each a different sensor input displayed on the touchscreen user device.

34. The apparatus of claim 1, wherein at least one of the one or more inputs is tethered to the corresponding touchscreen user device input by a conductive path completed between a user and the touchscreen.

35. The apparatus of claim 1, wherein at least one of the one or more input is tethered to the corresponding touchscreen user device input using wireless signals.
